(19) United States
(12) Patent Application Publication
(10) Pub. No.: US 2015/0178846 A1
(43) Pub. Date: Jun. 25, 2015

(54) Deferred Income Annuity Structure Planning Tool Apparatuses, Methods and Systems

(71) Applicant: FMR LLC, Boston, MA (US)

(72) Inventors: Steven Andrew Feinschreiber, Attleboro, MA (US); Andrey Lyalko, Natick, MA (US); Prasenjit Dey Mazumdar, Karnataka (IN)

(21) Appl. No.: 14/493,194

(22) Filed: Sep. 22, 2014

Related U.S. Application Data
(60) Provisional application No. 61/906,386, filed on Nov. 19, 2013.

(51) Int. Cl. G06Q 40/06

(52) U.S. Cl. CPC G06Q 40/06

(57) ABSTRACT

The Deferred Income Annuity Structure Planning Tool Apparatuses, Methods and Systems (“DIA-PT”) transforms individual profile input (e.g., see 206 in FIG. 2, etc.) and user annuity expectation input (e.g., see 207 in FIG. 2, etc.) inputs via DIA-PT components into DIA purchasing records (e.g., see 212 in FIG. 2, etc.) outputs. The disclosed deferred income annuity generation and management matching apparatus, includes: a memory; and a component collection in the memory, including: a historical data collector component, an individual parameter collector component, an income replacement assessment component, a deferred income annuity purchasing component, a deferred income annuity portfolio rebalancing component; and a deferred income annuity pricing component; a processor disposed in communication with the memory, and configured to issue a plurality of processing instructions from the component collection stored in the memory, to: receive individual profile inputs, receive user expectation inputs from a user, determine a target annuity pay-out amount based on the obtained individual parameters, determine a deferred income annuity purchasing plan based on the obtained individual parameters and the determined target annuity pay-out amount, determine a purchasing price for the deferred income annuity purchasing plan, periodically execute a purchase transaction of deferred income annuity instrument based on the determined deferred income annuity purchasing plan and the determined purchasing price, rebalance an asset allocation of the participant's portfolio upon the purchase transaction of deferred income annuity instrument, obtain an indication that the participant has reached a retirement age, and generate a pay-out amount to the participant based on the deferred income annuity instrument.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### PRIORITY CLAIM

Applicant hereby claims benefit to priority under 35 USC 5119 as a non-provisional conversion of: U.S. provisional patent application Ser. No. 61/906,386, filed 19 Nov. 2013, entitled “DEFERRED INCOME ANNUITY STRUCTURE PLANNING TOOL APPARATUSES, METHODS AND SYSTEMS,” (attorney docket no. FIDE-006/0005270718-2009).

The entire contents of the aforementioned applications are herein expressly incorporated by reference.

### FIELD

The present innovations generally address investment information technology management, and more particularly, include Deferred Income Annuity Structure Planning Tool Apparatuses, Methods and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Individual investors set up retirement saving account such as 401K to plan for financial support for their future retirement life. Retirement saving contributions are deducted from an individual's paycheck and added to the individual's retirement savings account. Such retirement savings contribution is qualified for tax deferral benefits, which is deducted from the individual's income before taxation and thus tax-deferred until withdrawal during retirement. Funds in the retirement saving accounts are managed by an investment manager for the individual investor to invest in various financial vehicles, such as a pension fund.

### BRIEF DESCRIPTION OF THE DRAWINGS

Appendices and/or drawings illustrating various, non-limiting, example, innovative aspects of the Deferred Income Annuity Structure Planning Tool Apparatuses, Methods and Systems (hereinafter “DIA-PT”) disclosure, include:

The accompanying appendices, drawings, figures, images, etc. illustrate various example, non-limiting, inventive aspects, embodiments, and features (“e.g.,” or “example(s)”) in accordance with the present disclosure:

FIG. 1A provides an example diagram illustrating aspects of individual deferred income structure for retirement within embodiments of the DIA-PT;

FIG. 1B provides an example diagram illustrating aspects of creating post-retirement income within embodiments of the DIA-PT;

FIG. 1C provides another example illustrating aspects of systematic DIA purchases and lump sum annuity purchasing within embodiments of the DIA-PT;

FIG. 2 provides an example datagraph diagram illustrating aspects of interactive data flows between the DIA-PT server and its affiliated entities for DIA-purchasing and management within embodiments of the DIA-PT;

FIGS. 3A-3B provide a logic flow diagram illustrating interactive process flows between a user/participant and the DIA-PT server for DIA planning and purchasing within embodiments of the DIA-PT;

FIG. 3C provides an exemplary logic flow illustrating DIA income replacement procedure components within embodiments of the DIA-PT;

FIG. 3D provides an example DIA process flow diagram illustrating aspects of DIA income generation through different time stages (e.g., accumulation 532a, transition (55+) to retirement 332b, through retirement 332c, at retirement 332d) within embodiments of the DIA-PT;

FIGS. 4A-4B provide a logic flow diagram illustrating aspects of income replacement assessment based on historical back-tests within embodiments of the DIA-PT;

FIG. 4C provides a diagram illustrating DIA configuration within embodiments of the DIA-PT;

FIG. 4D provides example charts illustrating aspects of target equity exposure within embodiments of the DIA-PT;

FIG. 5A provides a logic flow diagram illustrating aspects of portfolio rebalancing of DIA within embodiments of the DIA-PT;

FIG. 5B provides example data charts illustrating aspects of portfolio asset allocation evolution within embodiments of the DIA-PT;

FIG. 6 provides a logic flow diagram illustrating aspects of generating DIA purchasing strategy within embodiments of the DIA-PT;

FIGS. 7A-7B provide a logic flow diagram illustrating aspects of DIA pricing within embodiments of the DIA-PT;

FIG. 7C provides an exemplary pricing curve within embodiments of the DIA-PT;

FIGS. 8A-8E provide exemplary UI diagrams illustrating aspects of individual participant's configuration of DIA portfolio within embodiments of the DIA-PT;

FIGS. 9A-9B provide data charts illustrating a hypothetical example of 55-year old entering a DIA purchasing program investing over a 10-year period within embodiments of the DIA-PT;

FIGS. 9C-9D provide hypothetical example data analytics illustrating the DIA investment amounts and the monthly income purchased for these same examples within embodiments of the DIA-PT;

FIGS. 10A-10B provide hypothetical example data tables showing the percentage of rolling historical periods (rolling each month) in which the specified income replacement rate could be attained within embodiments of the DIA-PT;

FIGS. 10C-10D provide hypothetical example data tables illustrating the remaining assets, as a multiple of ending salary, for a participant attempting to replace 20% of his or her pre-retirement income within embodiments of the DIA-PT;

FIGS. 10E and 10F provide hypothetical example data tables showing the percentage income replacement that historically could be attained within embodiments of the DIA-PT;

FIG. 11A provides hypothetical example data charts illustrating reducing volatility of purchasing cost within embodiments of the DIA-PT;

FIG. 11B provides a data plot of historical annuity income payouts (quotes) across several annuity providers from 2006 through 2012 within embodiments of the DIA-PT;

FIG. 12 provides hypothetical exemplary data charts illustrating participants elections of DIA versus lump-sum payment within embodiments of the DIA-PT;

FIGS. 13A-13B provide a hypothetical example data plot illustrating percent of total portfolio of each asset class within embodiments of the DIA-PT;

FIG. 13C provides a hypothetical example data plot illustrating value by asset class over time within embodiments of the DIA-PT;

FIGS. 14A-14C show a hypothetical example data plot illustrating DIA strategy advantage by wealth at retirement within embodiments of the DIA-PT;

FIGS. 14D-14F show additional exemplary illustrations of retirement life cycle income generation, guidance in providing strategy planning and a sample statement; and

FIG. 15 shows a block diagram illustrating example aspects of a DIA-PT controller.

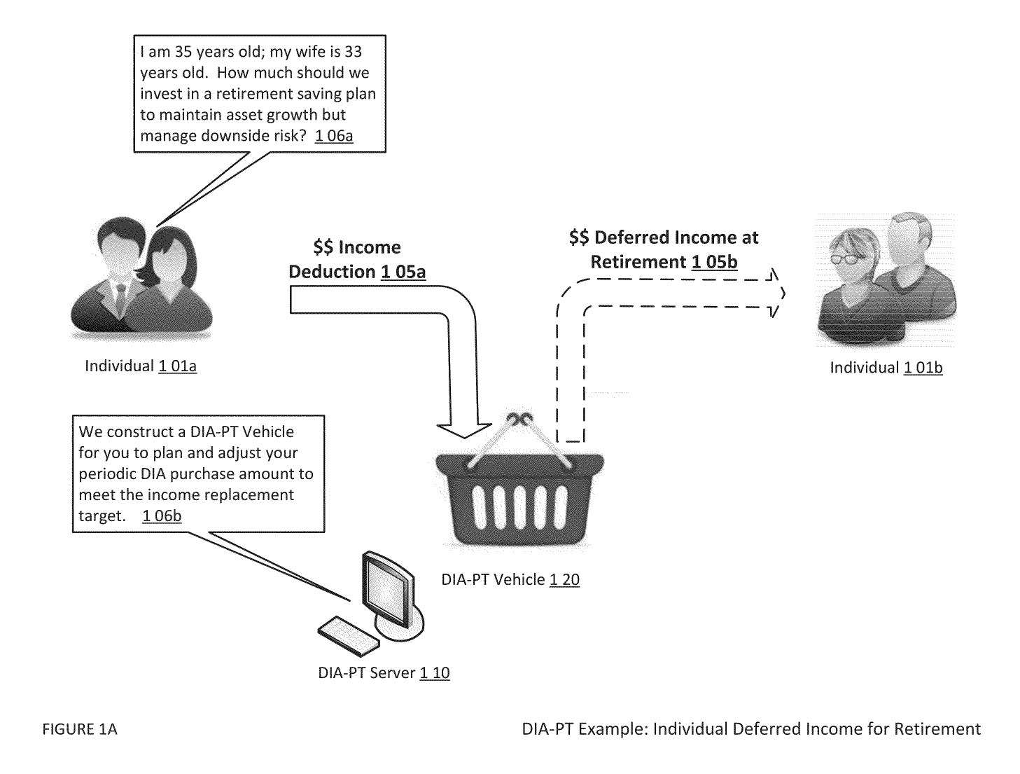

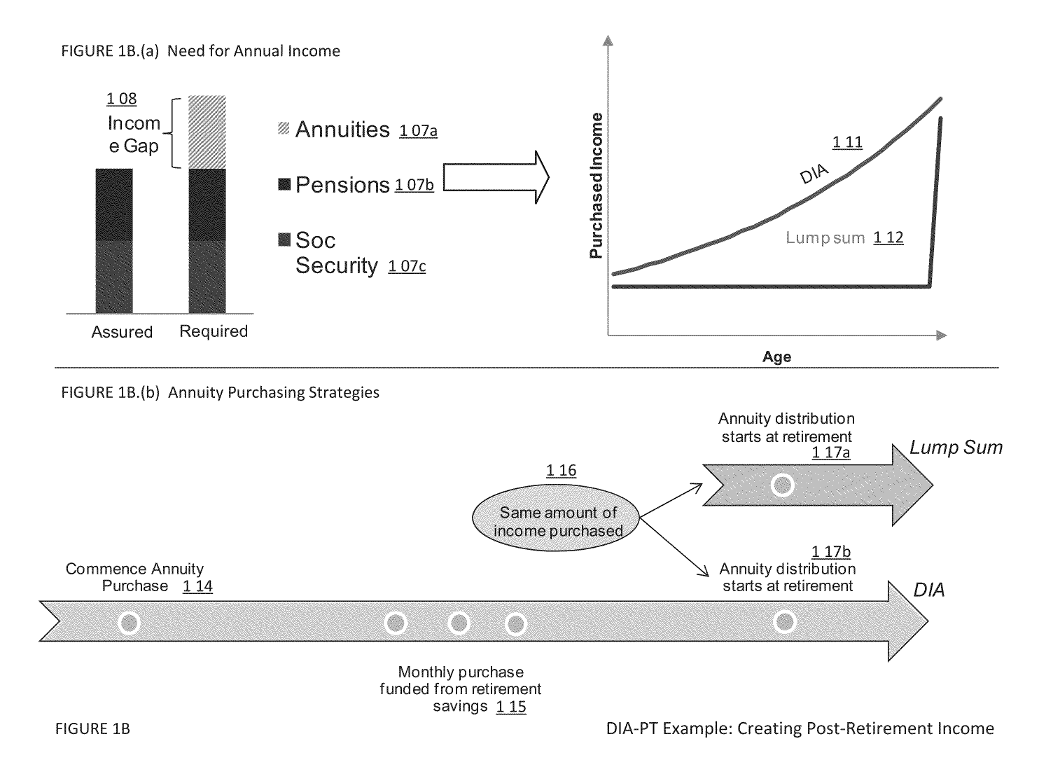

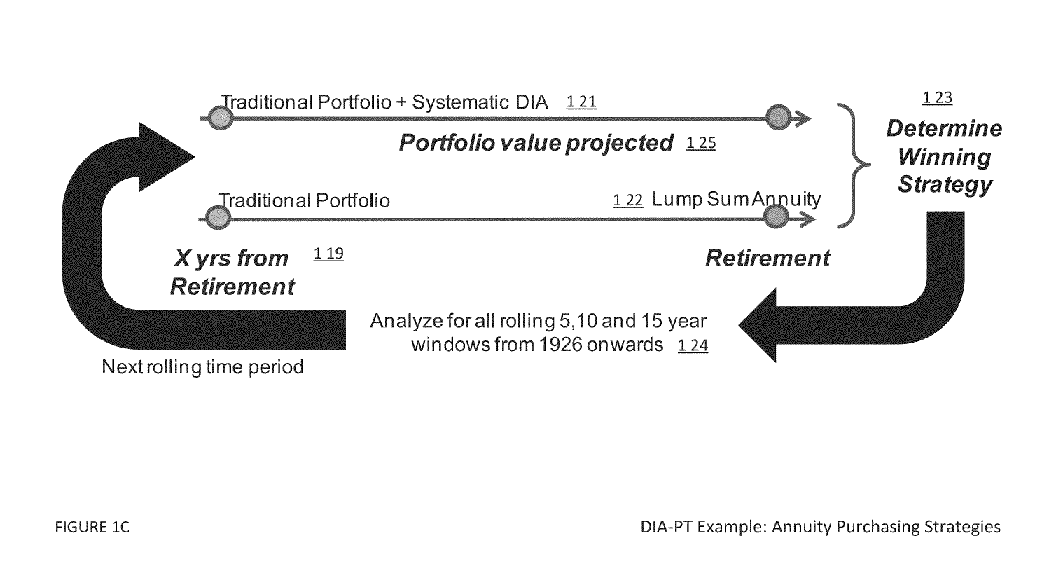

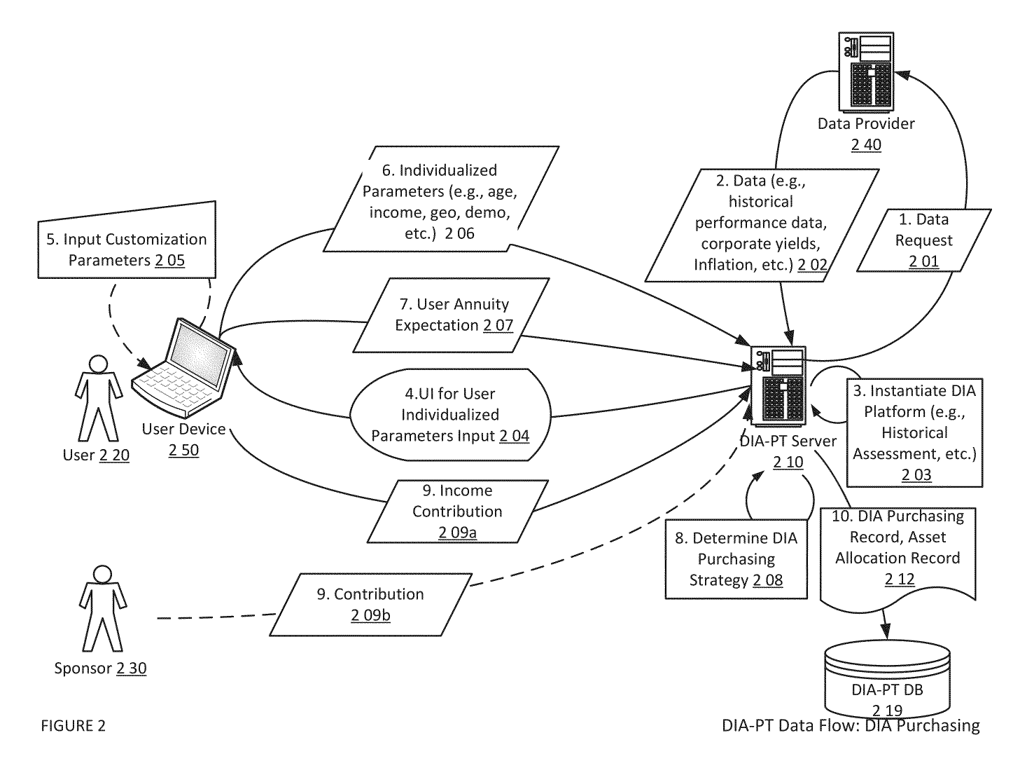

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citation and/or reference numbers are not necessarily sequences but rather just example orders that may be rearranged and other orders are contemplated.

### DETAILED DESCRIPTION

The Deferred Income Annuity Structure Planning Tool Apparatuses, Methods and Systems (hereinafter “DIA-PT”) transforms individual profile input (e.g., see 206 in FIG. 2, etc.) and user annuity expectation input (e.g., see 207 in FIG. 2, etc.) inputs, via DIA-PT components (e.g., Historical Data Collector 1542, Individual Parameter Collector 1543, Income Replacement Assessment 1544, DIA Purchasing 1545, DIA Portfolio rebalancing 1546, DIA pricing 1547, etc.), into DIA purchasing records (e.g., see in FIG. 2, etc.) outputs. The DIA-PT components, in various embodiments, implement advantageous features as set forth below.

### INTRODUCTION

The DIA-PT provides a retirement savings account management tool that generates and/or adjusts a deferred income annuity contribution plan for an individual investor based on the individual investor's retirement objective, annual income and/or various economic indicators.

For example, the DIA-PT may construct a Deferred income annuities (DIAs) investment structure, which are income annuities that are paid for today and provide income that starts at a later time. DIAs may defer income for a short time (1 or 2 years) or for a long period (10 or 20 years). The deferred income annuities may comprise fixed DIAs, e.g., an amount of money is paid now for a specific amount of money each month in the future. These future payments may not vary with market performance.

### DIA-PT

FIG. 1A provides an example diagram illustrating aspects of individual deferred income structure for retirement within embodiments of the DIA-PT. For example, in one implementation, employees (e.g., an individual investor 101a-b, etc.) may have been given the responsibility of providing for their retirement. For example, in one implementation, the individual investors 101a may contribute a portion of their paycheck 105a to a DIA-PT vehicle 120, which may pay back the deferred income 105b to investors 101b at the retirement. Employers, who once provided life-long income in retirement, may prefer to provide access to tax efficient savings vehicles often with employer matching contributions and/or profit sharing contributions. The risks associated with generating sustainable retirement income for life may have shifted to individual investors. Investors now may face the questions that pension plans have in the past and still do, e.g., how should an investor allocate assets appropriately to maintain growth in the portfolios but manage downside risk, e.g., 106a?

In one implementation, individual investors may take a mean-variance approach to managing risk until they reach retirement. At the point of retirement investors may have hopefully built up a portfolio to generate the appropriate amount of income from those assets to sustain their lifestyle. While the risks have shifted from employers to employees, the investment objectives have remained the same. Investors may need to generate an income stream in retirement.

In one implementation, pension plans may have managed risk by investing part of their portfolio for growth while attempting to “lock-in” the other part of their portfolio. Allocation to each part would be governed by the amount of risk the plan was comfortable with taking. In one implementation, the DIA-PT server 110 may structure the deferred income annuities (DIA) vehicle to secure a pension-like benefit within a defined contribution qualified plan framework, e.g., the individual 101a may make periodic purchase of DIA to met the income replacement target 106b. Such periodic purchase amount may be adjusted over time. In one implementation, investors may use this framework to “lock-in” income in retirement with part of the portfolio, while investing in traditional assets with the other part for growth, during the years leading up to retirement. Investors may do this by targeting an income replacement, as a percent of their final ending salary, that provides them with an appropriate level of risk and using periodic purchases of DIA to reach that target.

In one implementation, the DIA-PT server 110 may track the benefit of this risk reduction approach over time, relative to a single purchase at retirement, to illustrate the benefit of diversifying purchases over a long interest rate environment. Additionally the DIA-PT may develop an approach to inform the asset allocation of the traditional assets by the market value of income already purchased. In further implementations, the DIA-PT may periodically rebalance the portfolio to maintain an overall risk level.

For example, Table 1 provides an example of DIA purchasing frame:

TABLE 1
Example DIA Purchasing Plan
DIA Purchasing Timeframe

| | 5 Years | 10 Years | 15 Years |
|---|---|---|---|
| Current age (years) | 60 | 55 | 50 |
| Gender | Male | Male | Male |
| Starting balance | $400,000 | $300,000 | $225,000 |
| Starting salary | $65,000 | $60,000 | $55,000 |
| Salary growth rate | 1.50% | 1.50% | 1.50% |
| Contribution rate | 12% | 12% | 12% |
| Retirement age | 65 | 65 | 65 |
| Account Type | Tax-deferred | Tax-deferred | Tax-deferred |
| Monthly DIA Purchase | 1.00% | 0.50% | 0.33% |

FIG. 1B provides an example diagram illustrating aspects of creating post-retirement income within embodiments of the DIA-PT. In one embodiment, FIG. 1B.(a) illustrates an example of the need for annuity income. For example, individual consumers/investors may require at least some additional annuity income in retirement to fund their income gap 108, e.g., the gap between existing guaranteed income such as social security 107c and pensions 107b and the amount they need for essential expenses.

In one implementation, such income gap 108 may be bridged by purchased annuity income, e.g., deferred income annuities (DIA) 111 purchased over time and/or lump sum 112 purchase of annuity. For example, the DIA investment structure may be periodically deducted from an individual's income periodically (e.g., monthly, quarterly, per 6 month, or per paycheck, etc.) and may provide income that starts at a later retirement age, e.g., see 111. For another example, the lump sum payment 112 may require an individual to make a one-time payment to purchase the DIA, which may return a pay-back amount at the retirement age, e.g., see 112.

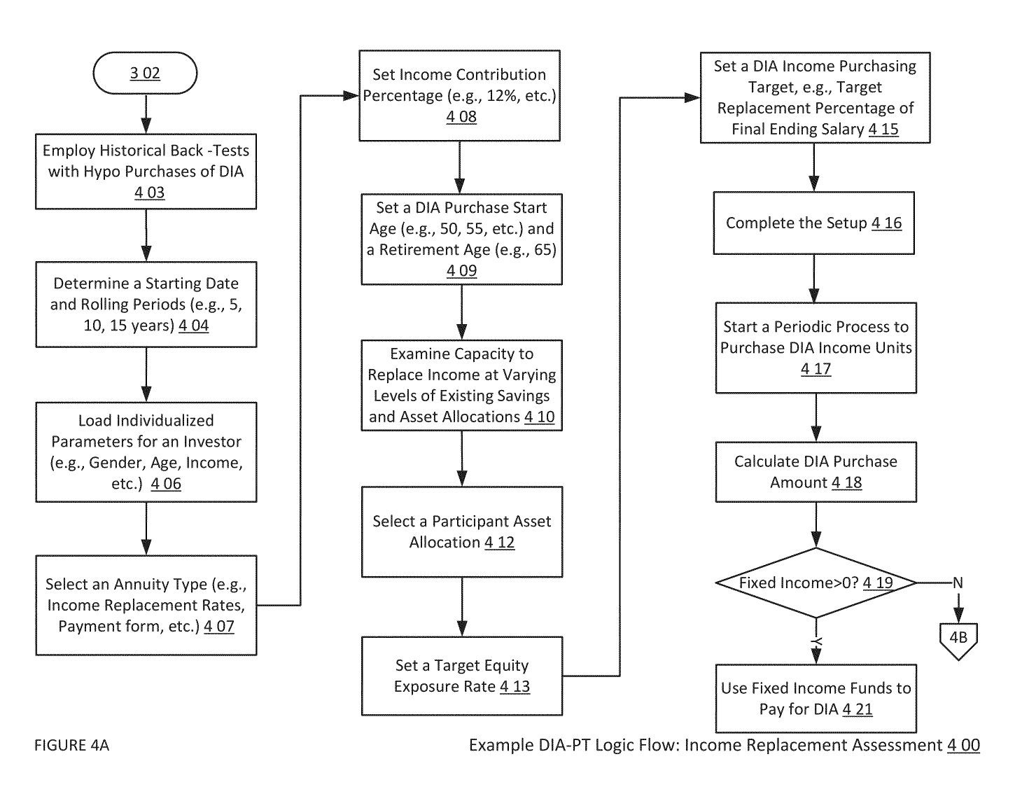

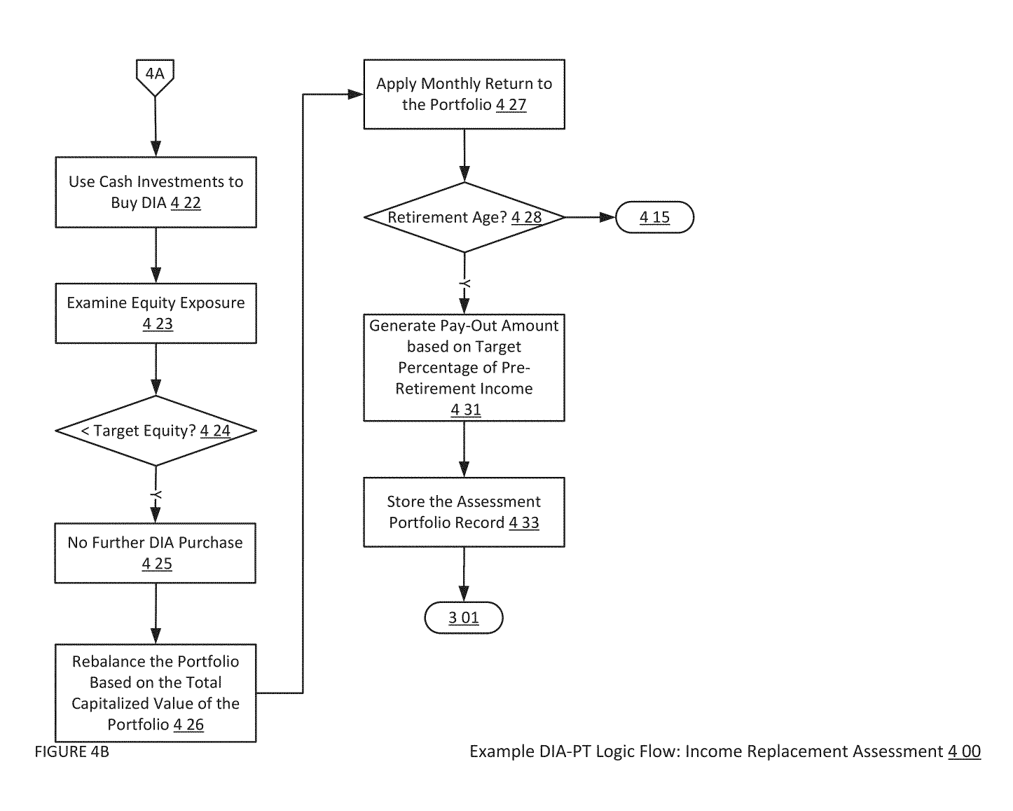

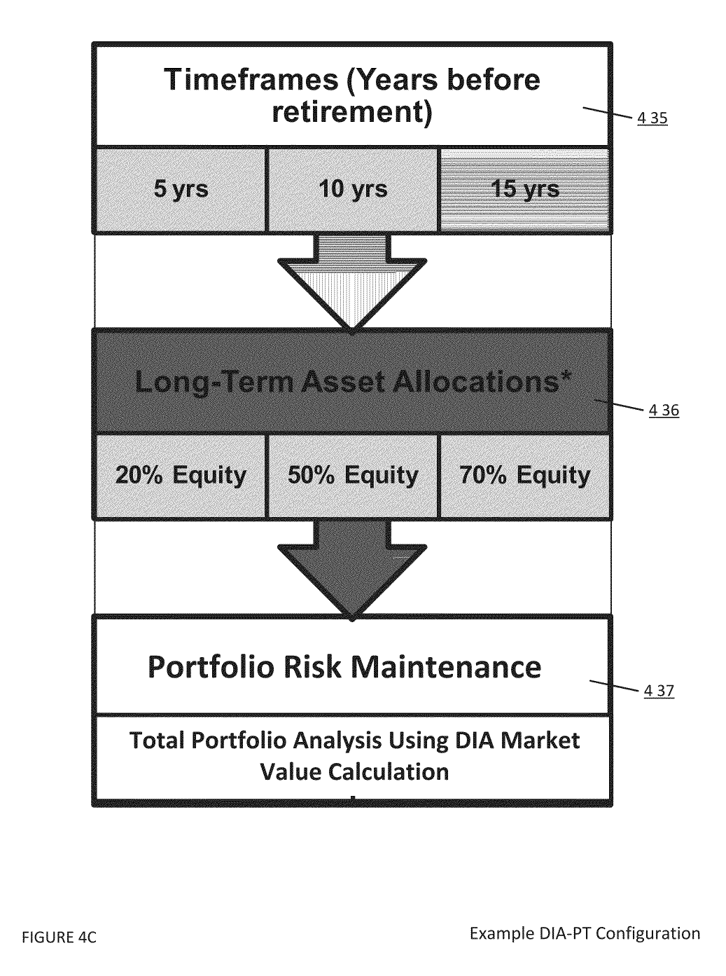

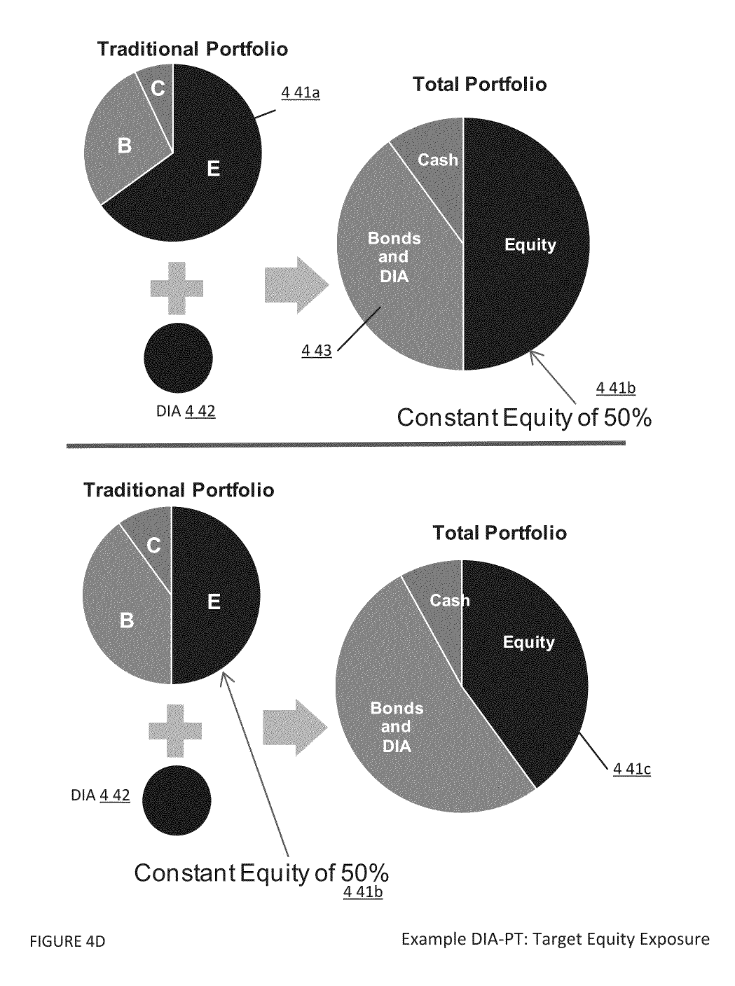

FIG. 1B.(b) further illustrates the annuity purchasing strategies in different implementations. For example, in order to achieve annuity payment after retirement 117a, an individual may purchase income with a lump sum 116 at the date of retirement, using funds from retirement savings balances that may grow up to date of retirement and a single income annuity purchase may be made. Alternatively, the individual may adopt a DIA strategy, e.g., units of retirement income may be purchased over time starting at 5, 10 or 15 years before retirement (e.g., 114); and make withdrawals from retirement savings balances to purchase deferred income annuity 115; such income purchased each period may start at retirement 117b. In one implementation, the DIA-PT may provide analytics for an individual to determine a percentage of the monthly purchase of DIA in order to achieve a retirement annuity payment objective, as further discussed in FIGS. 4A-4B.

FIG. 1C provides another example illustrating aspects of systematic DIA purchases and lump sum annuity purchasing within embodiments of the DIA-PT. For example, the DIA-PT may apply historical analysis to evaluate the DIA and lump-sum annuity purchasing strategies, e.g., 123. For example, in one implementation, starting from a number of years prior to retirement 119, the DIA-PT may evaluate each strategy over rolling 5, 10, and 15 year time periods starting in January, 1926. In one implementation, at the end of each period, a single lump sum annuity purchase is made such that the annuity income is identical to that in the DIA strategy 121.

In one implementation, the DIA-PT may then compare each strategy's total portfolio value 125 and a winner for the period determined. In this way, the DIA-PT may obtain and calculate the DIA advantage as: (DIA portfolio value at retirement—Lump sum portfolio value at retirement)/Lump sum portfolio value at retirement.

FIG. 2 provides an example datagraph diagram illustrating aspects of interactive data flows between the DIA-PT server and its affiliated entities for DIA-purchasing and management within embodiments of the DIA-PT. Within embodiments, a DIA-PT server 220, a user 220 (e.g., an individual investor, a portfolio manager, a broker, etc.), a user device 250, a data provider 240 (e.g., (e.g., Bloomberg, Moody's, Standard Poor, Bank of America, and/or other financial institutions, rating agencies, and/or the like), a plan sponsor (e.g., an employer, etc.) 240, a DIA-PT database 219, and/or the like, may interact and exchange data messages via a communication network with regard to DIA purchasing and management within embodiments of the DIA-PT.

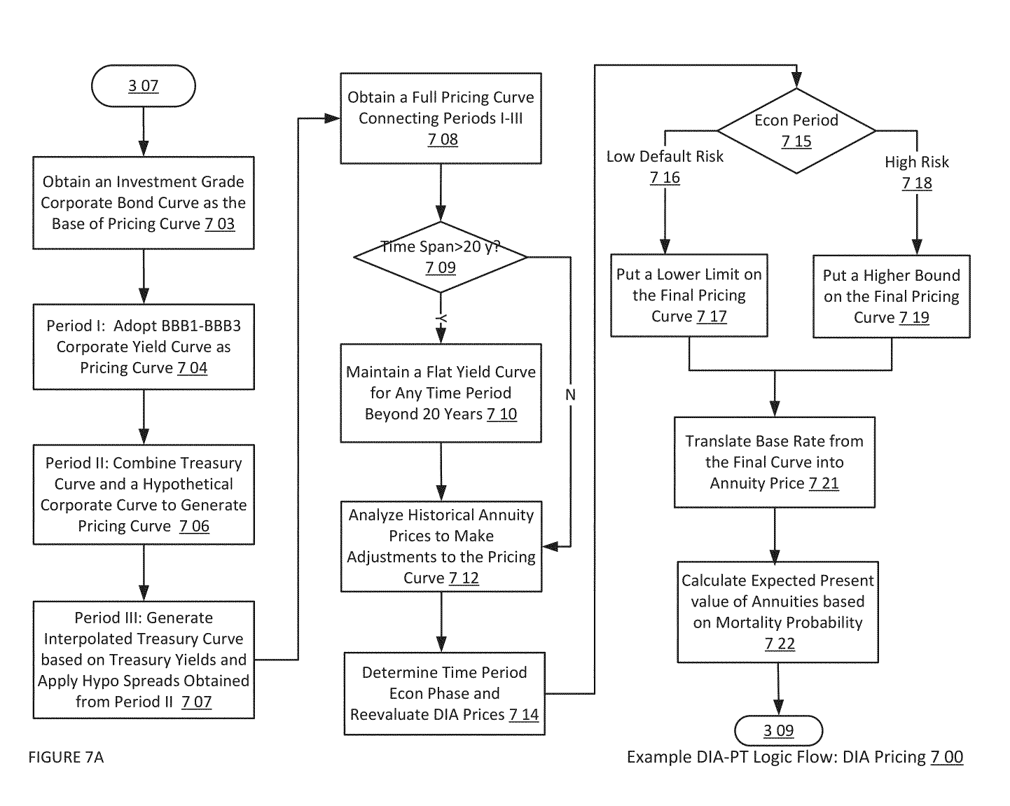

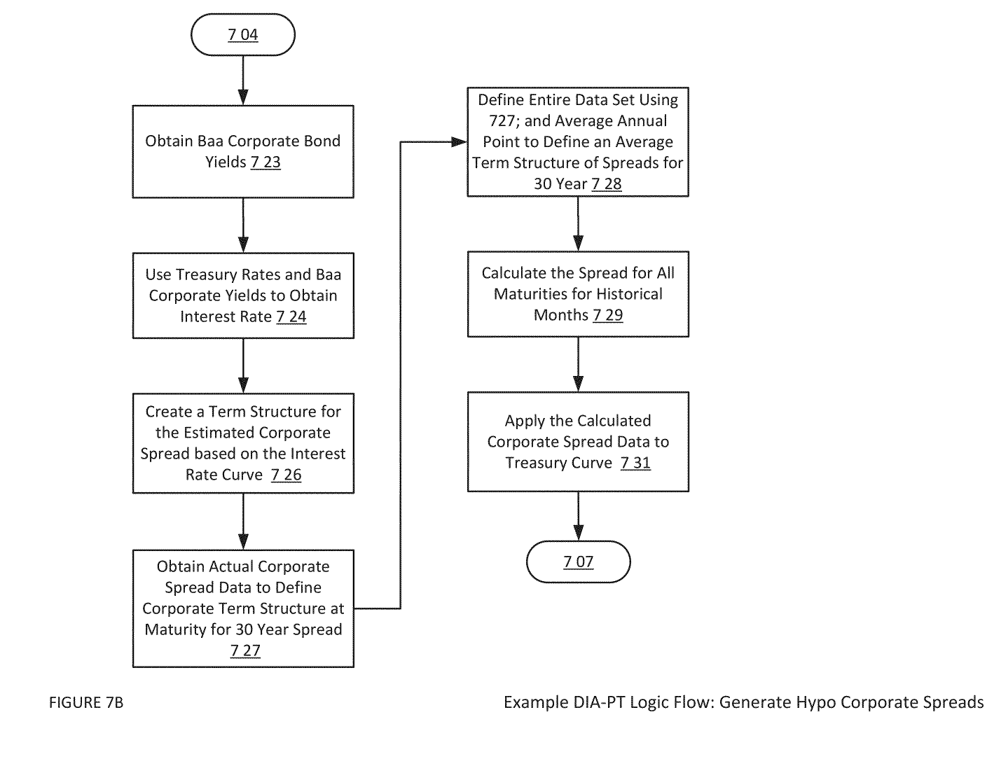

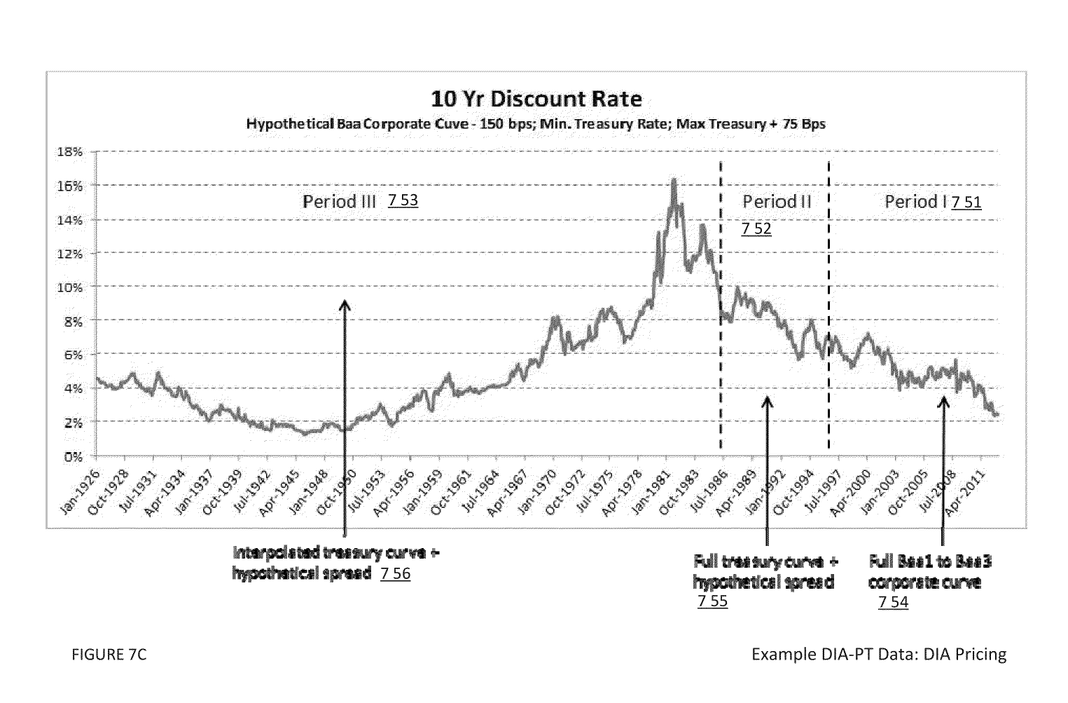

In one embodiment, the DIA-PT server 210 may constantly, intermittently, periodically, and/or on an on-demand basis, requesting data from a data provider 240. Such data provider 240 may provide historical market data, investment performance data, historical inflation data, and/or the like, for income replacement assessment (e.g., see FIGS. 4A-4B, etc.). In another example, the data provider 240 may provide corporate yields (e.g., Moody's Seasoned Baa Corporate Bond Yields, U.S. treasury yields, etc.) for DIA pricing generation (e.g., see FIGS. 7A-7B, etc.).

In one implementation, the DIA-PT server 210 may send a data request 201 to the Data provider 240, and obtain the data listing 202 (e.g., historical inflation, historical market performance, historical portfolio performance, corporate/treasury yields, etc.). For example, in one implementation, the returned data 202 may include a variety of different data formats, including, but not limited to xml, csv, excel, txt, and/or the like. In further implementations, such data 202 may be generated as data reports in a graphical presentation including data plots, curves, charts, and/or the like.

In one implementation, upon obtaining historical return data associated with various investors, the DIA-PT may instantiate a DIA platform tool, e.g., to generate income replacement assessment based on historical data 203 (e.g., see FIGS. 4A-4B). The income replacement assessment may provide analytics on DIA parameters and performance, e.g., target asset allocation, target income replacement percentage, etc.

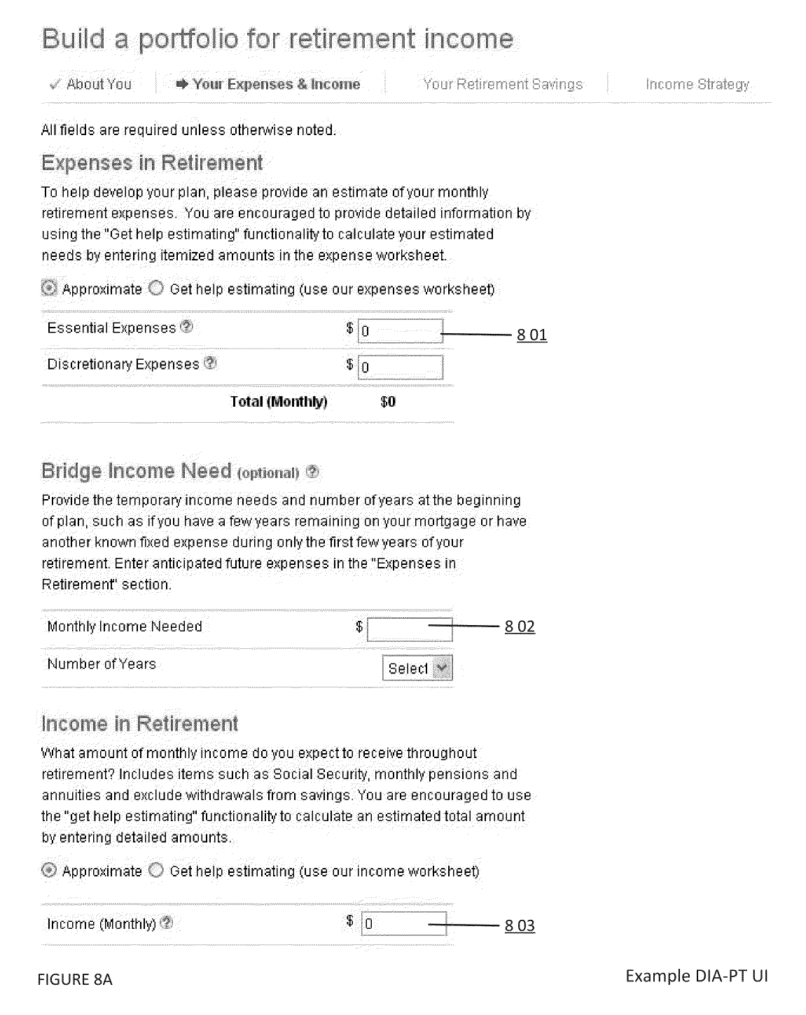

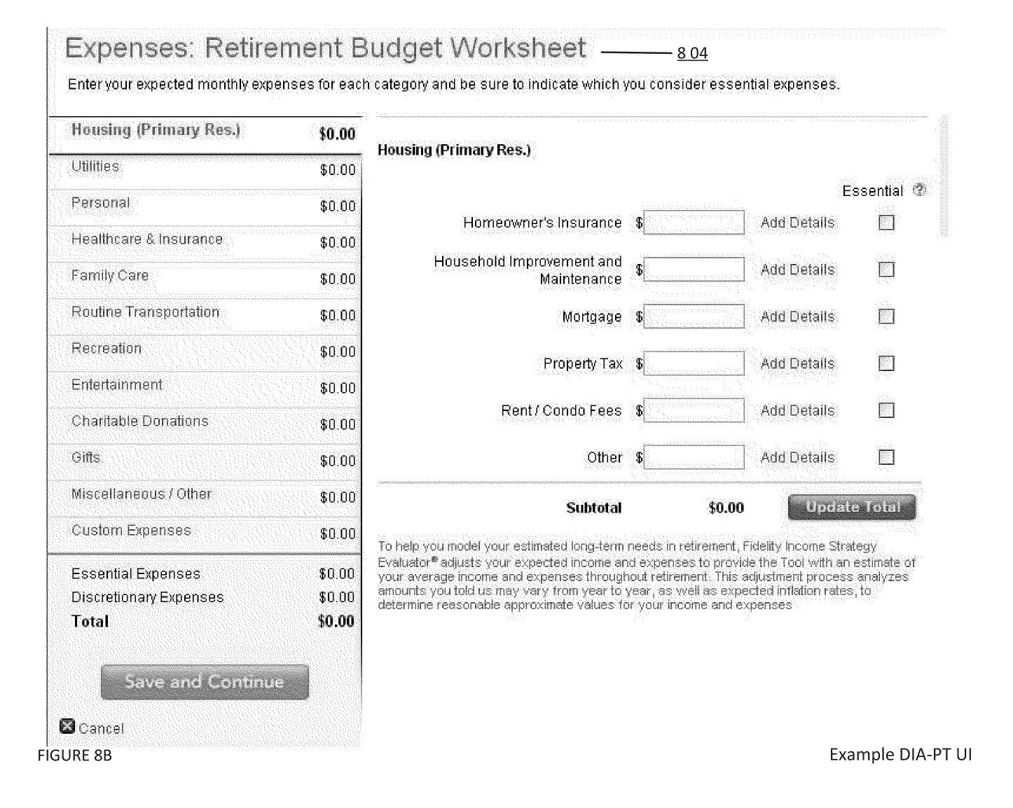

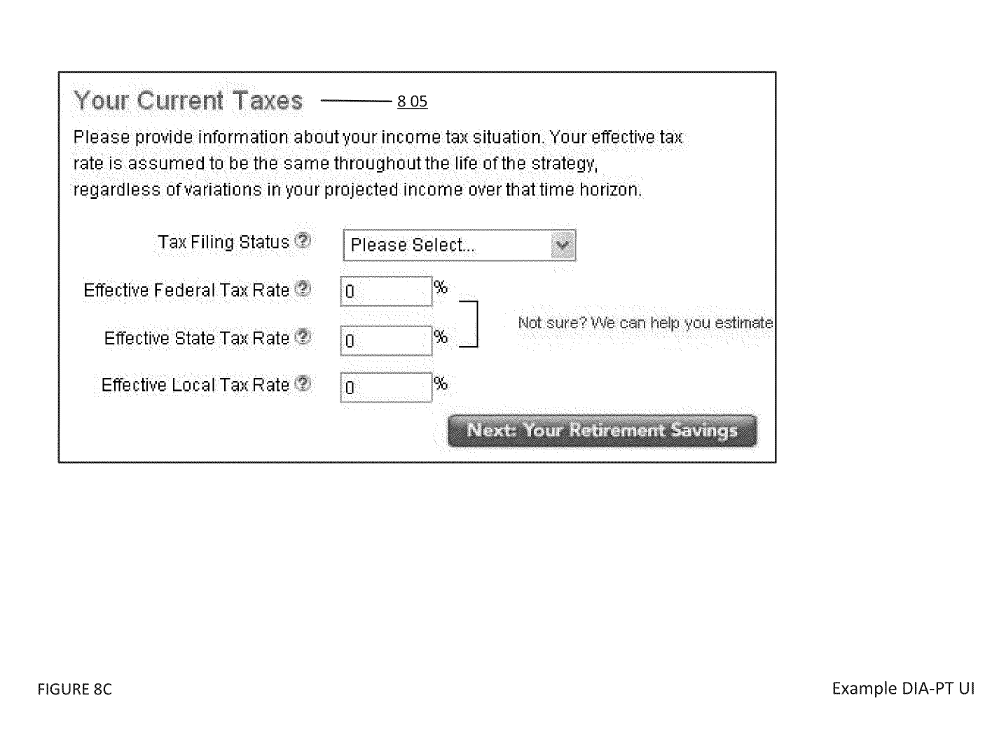

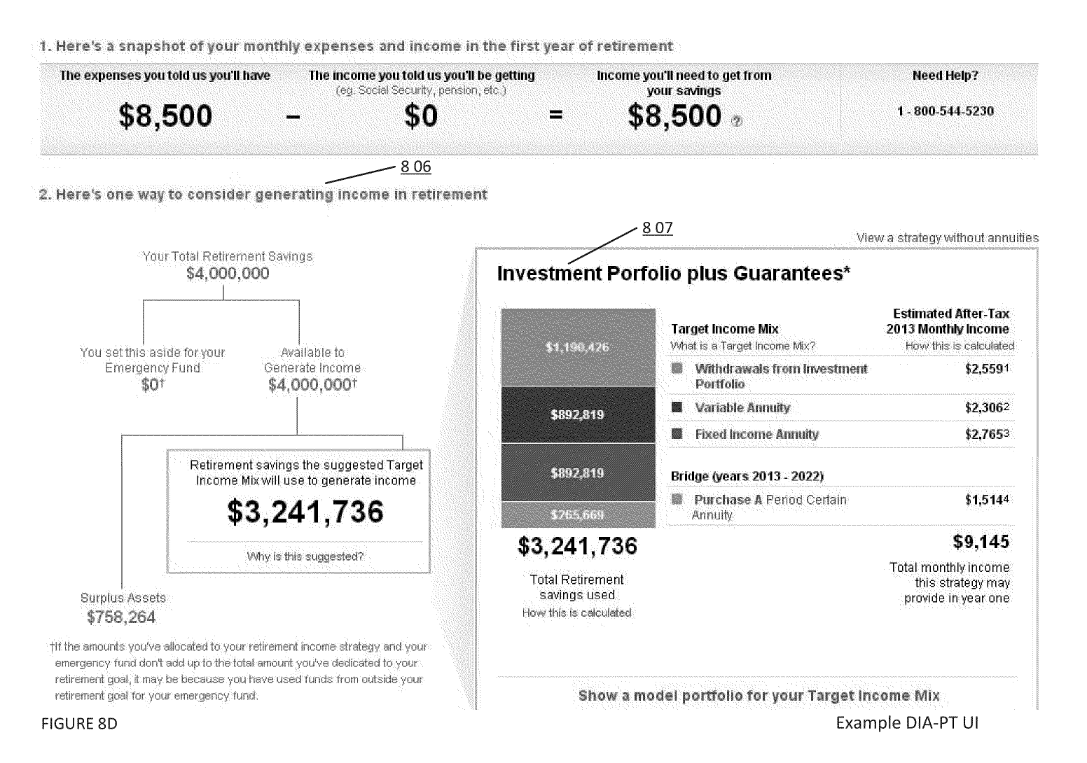

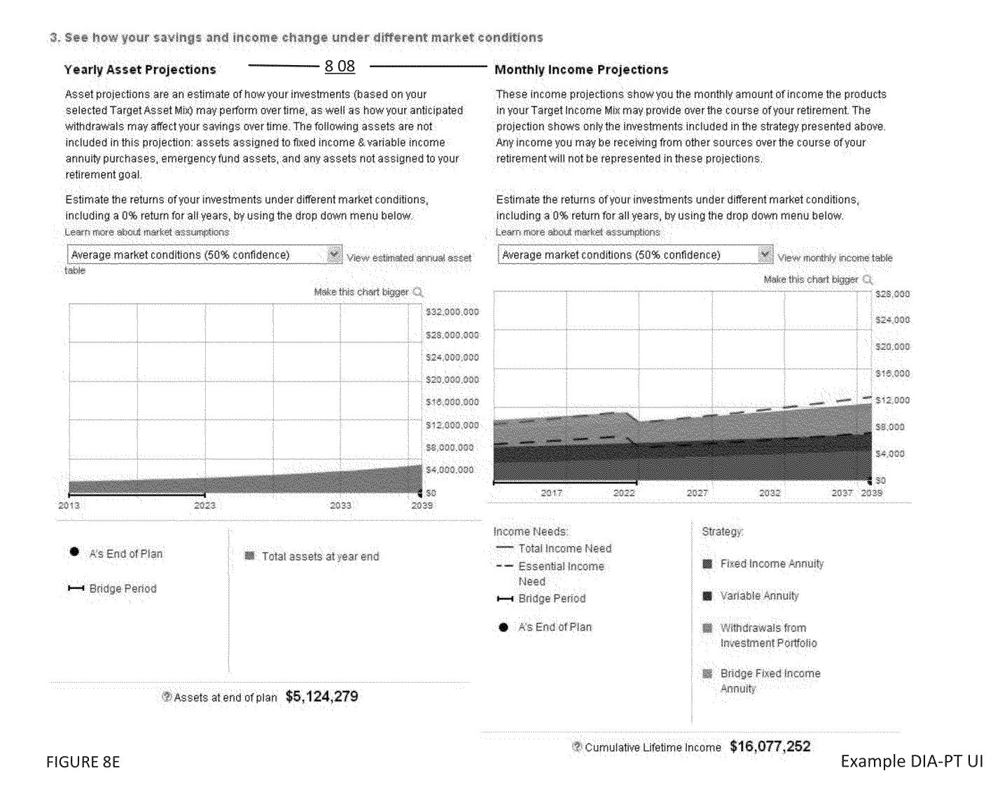

In one implementation, the DIA-PT server 210 may provide a user interface (UI) for user individualized parameters input 204. For example, the DIA-PT server 210 may prompt the user 220 to enter individualized parameters 206 such as but not limited to the user's age, income, income history, employment, employment history, educational background, family status, geo-location, tax status, housing condition, and/or the like. In further implementations, the DIA-PT server may prompt the user to input user annuity expectation parameters 207 such as but not limited to target income replacement percentage, target retirement pay-out, and/or the like. In one implementation, exemplary UI 204 may be provided in FIGS. 8A-8C.

In one embodiment, the user 220 may operate a user device 230, which may include any of a desktop computer, a laptop computer, a tablet computer, a Smartphone (e.g., a BlackBerry, an Apple iPhone, a Google Android, a HTC, a Samsung Galaxy, etc.), and/or the like. In one implementation, the user 220 may input customization parameters 205 via a UI at the user device 250, which may in turn provide the user configured parameters 206-207 to the DIA-PT server 210.

For example, the user device 230 may generate a (Secure) Hypertext Transfer Protocol (“HTTP(S)”) message including user individualized parameters 206 in the form of data formatted according to the eXtensible Markup Language (XML). An example listing of a user individualized parameters input message 206, substantially in the form of a HTTP(S) message including XML-formatted data, is provided below:

```
POST /user_parameter.php HTTP/1.1
Host: 192.168.23.126
Content-Type: Application/XML
Content-Length: 867
<?XML version = ″1.0″ encoding = ″UTF-8″?>
<user-parameter>
  <session_id> HUUUSDWE </session_id>
  <timestamp> 2014-02-22 15:22:43</timestamp>
  <user_id> JS001 </user_id>
  <client_details>
    <client_IP>192.168.23.126</client_Ip>
    <client_type>smartphone</client_type>
    <client_model>HTC Hero</client_model>
    <device_id> HTC_JS_001 </device_id>
    ...
  <client_details>
    <user>
      <name> John Smith </name>
      <DOB> 1970-10-21 </DOB>
      <gender> m </gender>
      <address>
        <street> 111 Palm Street </street>
        <city> Palm Beach </city>
        <state> CA </state>
        <zipcode> 00000 </zipcode>
        ...
      </address>
      ...
    <age> 43 </age>
    <demo> Caucasian </demo>
    <employment>
      <employment_1>
        <employer> ABC Software </employer>
        <title> project manager </title>
        <start_date> 01-2013 </start_date>
        <end_date> present </end_date>
        ...
      </employment_1>
      ...
    </employment>
    <education>
      <college>
        <school-name> ABC university </school-name>
        <start_date> 09-2000 </start_date>
        <end_date> 07-2006 </end_date>
        <degree> bachelor of engineering </degree>
        ...
      </college>
      ...
    </education>
    <income> 120,000 </income>
    ...
  <user_parameter>
```

In another implementation, the user 220 may optionally submit user annuity expectation parameters 207 to the DIA-PT server 210. An example listing of a user annuity expectation message 207, substantially in the form of a HTTP(S) message including XML-formatted data, is provided below:

```
POST /annuity_expectation.php HTTP/1.1
Host: 192.168.23.126
Content-Type: Application/XML
Content-Length: 867
<?XML version = ″1.0″ encoding = ″UTF-8″?>
<annuity_expectation>
  <session_id> HUUUSDWE </session_id>
  <timestamp> 2014-02-22 15:22:43</timestamp>
  <user_id> JS001 </user_id>
  <client_details>
    <client_IP>192.168.23.126</client_Ip>
    <client_type>smartphone</client_type>
    <client_model>HTC Hero</client_model>
    <device_id> HTC_JS_001 </device_id>
    ...
  <client_details>
  <user>
    <name> John Smith </name>
    <DOB> 1970-10-21 </DOB>
    <gender> m </gender>
    <address>
      <street> 111 Palm Street </street>
      <city> Palm Beach </city>
      <state> CA </state>
      <zipcode> 00000 </zipcode>
      ...
    </address>
    ...
  <essential_exp> 1,500 </essential_exp>
  <discretionary_exp> 500 <discretionary_exp>
  <income_needed> 2,500 </income_needed>
  <number_years> 30 </number_years>
  <retirement_income> 0 </retirement_income>
  ...
</annuity_expectation>
```

In one implementation, as further discussed in FIGS. 4A-4B, the DIA-PT server may determine a DIA purchasing strategy 208 based on the user parameters, and may receive income contribution 209a-b from the user 220 and/or the sponsor 230 (e.g., user's employer, etc.) to the user's retirement portfolio. In one implementation, the DIA-PT server may generate a DIA purchasing record including an asset allocation information 212 for storage at the DIA-PT database 219.

For example, in one implementation, an exemplary listing, written substantially in the form of PHP/SQL commands, to store the DIA purchasing record data 212 to the DIA-PT database, is provided below:

<?PHP
header(′Content-Type: text/plain′);
...
// store input data in a database
mysql_connect(″201.408.185.132″,$DIA-PT_server,$password); //
access database
server
mysql_select(″DIA-PT_DB.SQL″); // select database to append
mysql_query(″INSERT INTO RecordTable (timestamp,
DIA_purchase_amount,
total_amount, income, income_percent, DIA-percent, short-time-percent, FI-
percent, equity_percent, user_employment, user_gender, user_dob,
user_education, user_industry, user_retirement_age, ...)
VALUES ($timestamp, $DIA_purchase_amount, $total_amount, $income,
$income_percent, $DIA-percent, $short-time-percent, $FI-percent,
$equity_percent, $user_employment, $user_gender, $user_dob,
$user_education,
$user_industry, $user_retirement_age, ...); // add data to
RiskBoundaryTable
table in a CLIENT database
mysql_close(″DIA-PT_DB.SQL″); // close connection to database
?>

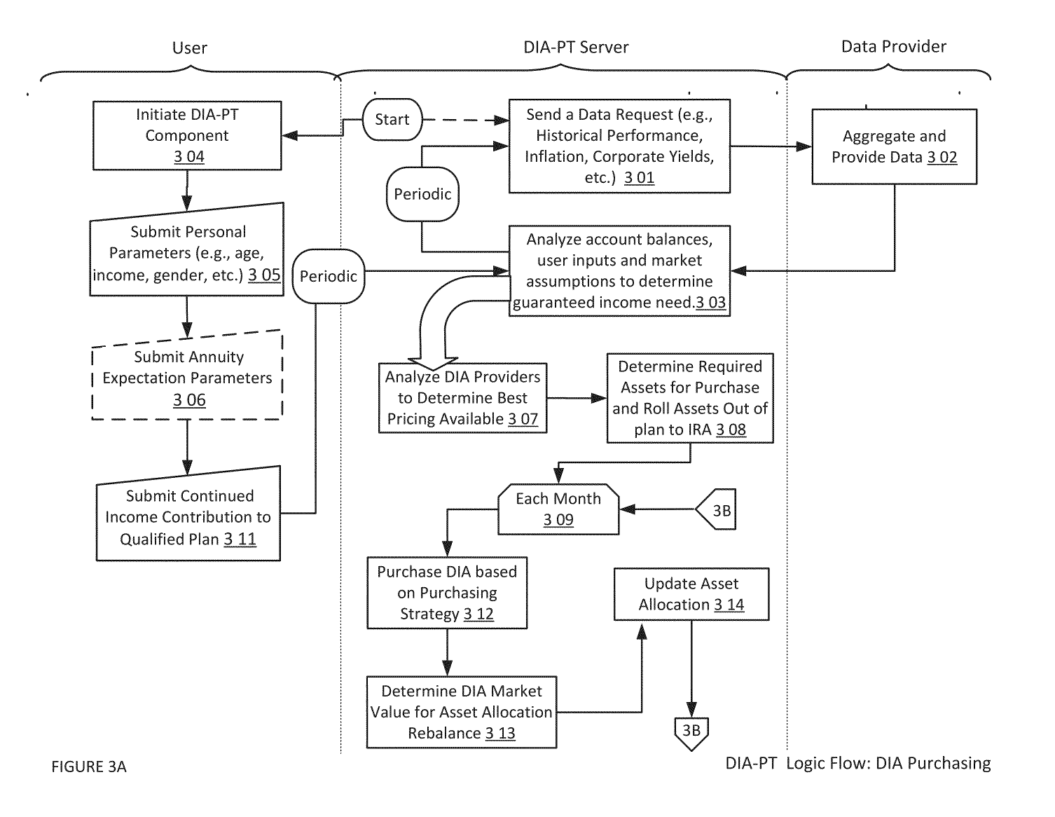

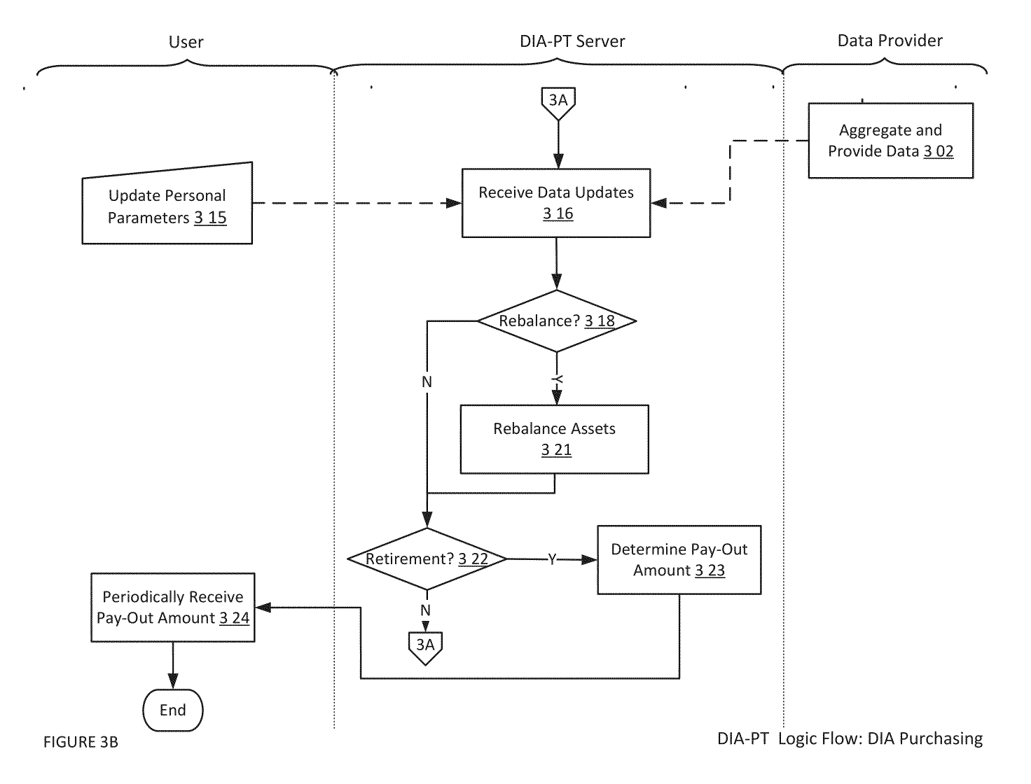

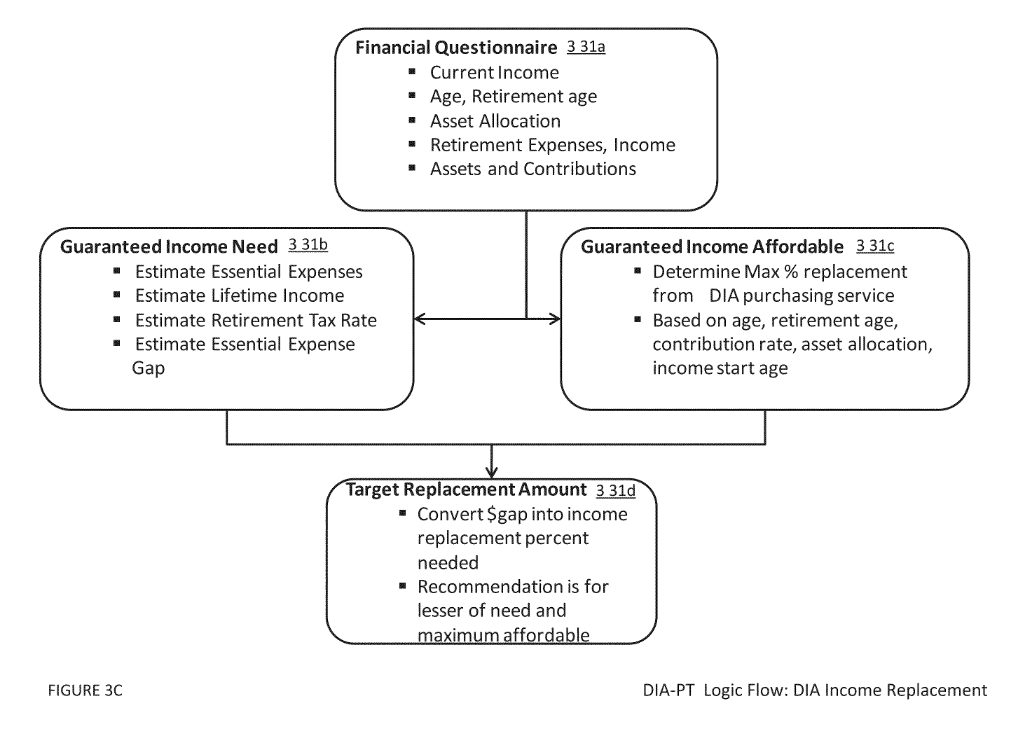

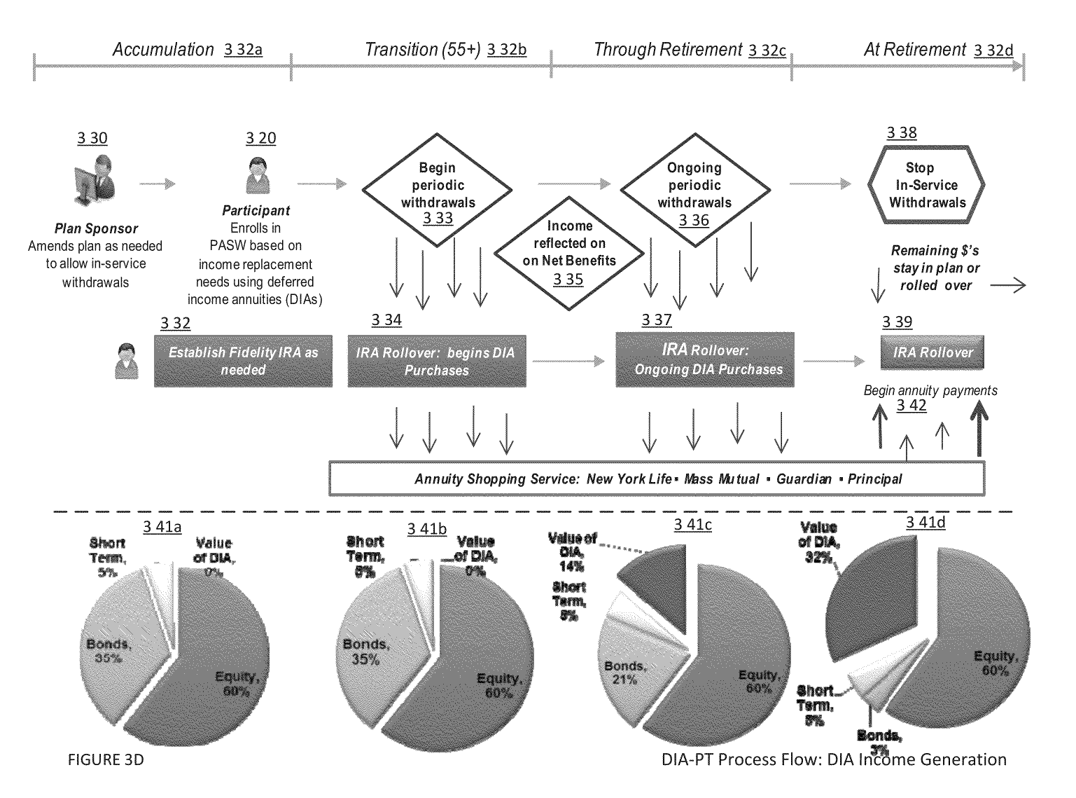

FIGS. 3A-3B provide a logic flow diagram illustrating interactive process flows between a user/participant and the DIA-PT server for DIA planning and purchasing within embodiments of the DIA-PT. Within embodiments, the DIA-PT server may send a data request 301 to a data provider (e.g., Bloomberg, Moody's, Standard Poor, Bank of America, and/or other financial institutions, rating agencies, and/or the like), which may aggregate and provide the requested data 302 to the DIA-PT server. Exemplary data may include corporate spreads, treasury discount curve, inflation, and/or the like.

Upon receiving the aggregated data from the data provider, the DIA-PT may analyze account balances, user inputs (e.g., see 305-306) and market assumptions to determine the guaranteed income need 303. In one implementation, the DIA-PT server may analyze the obtained historical performance data to generate income replacement assessment, e.g., as further illustrated in FIGS. 4A-4B, wherein the assessment may be conducted periodically, and may provide recommended parameters, such as target equity exposure rate, income replacement percentage, and/or the like.

In one implementation, a user/participant may initiate a DIA-PT component 304 (e.g., see exemplary UI diagrams in FIGS. 8A-8E), and submit personal parameters (e.g., age, gender, income, educational background, geo-location, employment industry, employment history, demographics, etc.) 305, and annuity expectation parameters 306 (e.g., expected annuity payout at retirement, target income replacement percentage, etc., see FIG. 8A). In one implementation, the participant may periodically update user inputs 305-306, and may provide continued income contribution (e.g., 10%, 12%, etc.) to a qualified plan 311.

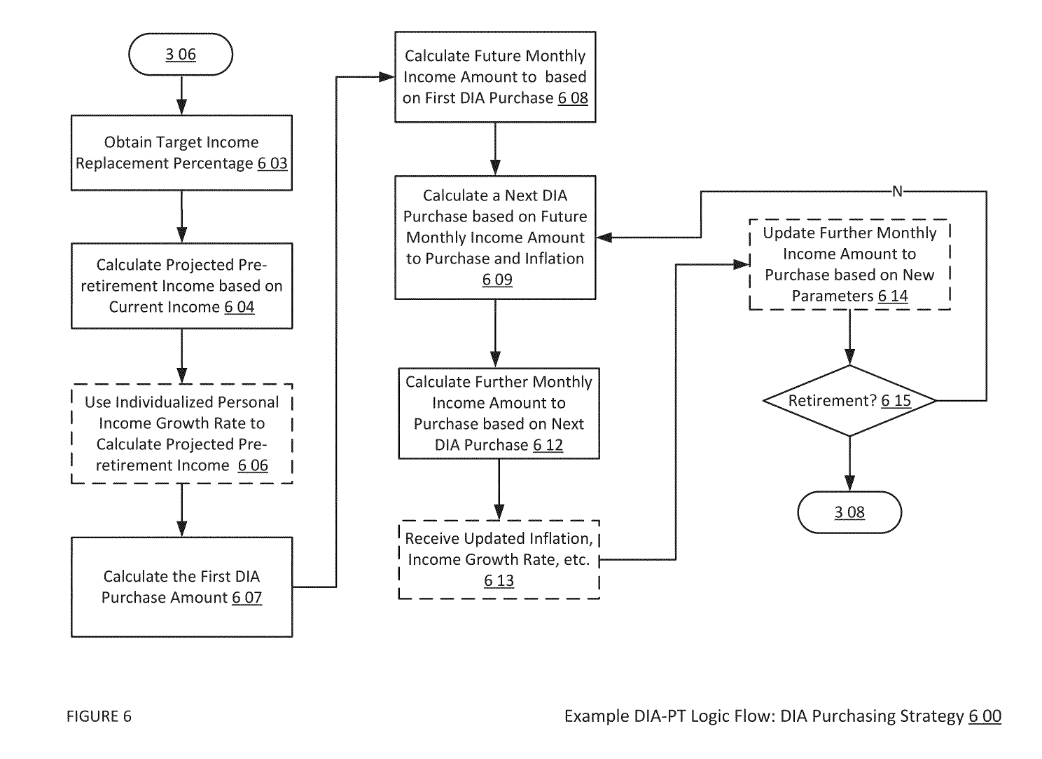

In one implementation, the DIA-PT server may obtain the user input parameters and determine a DIA purchasing strategy including associated parameters (e.g., when to start purchase, income replacement percentage, etc.), which may be further discussed in FIG. 6. In one implementation, the DIA-PT server may then determine the price of the DIA, analyze DIA providers to determine to determine best pricing available 307. For example, in one implementation, the DIA-PT may construct a hypothetical historical corporate yield curve to generate a DIA pricing curve, as further illustrated in FIGS. 7A-7B. In another implementation, the DIA pricing may be conducted individually by the vendors (e.g., each insurance company) and provided to DIA-PT, which may in turn select the best pricing from a pre-approved set of providers 307. In one implementation, the DIA-PT may then determine required assets to purchase and roll assets out of plan to the IRA 308.

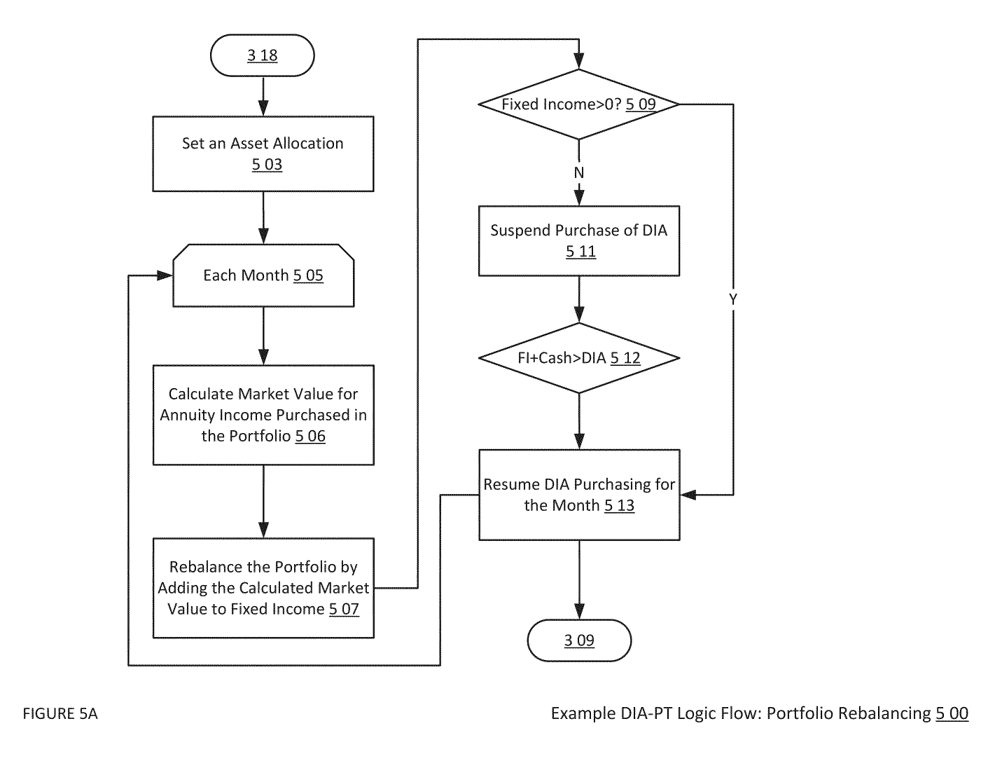

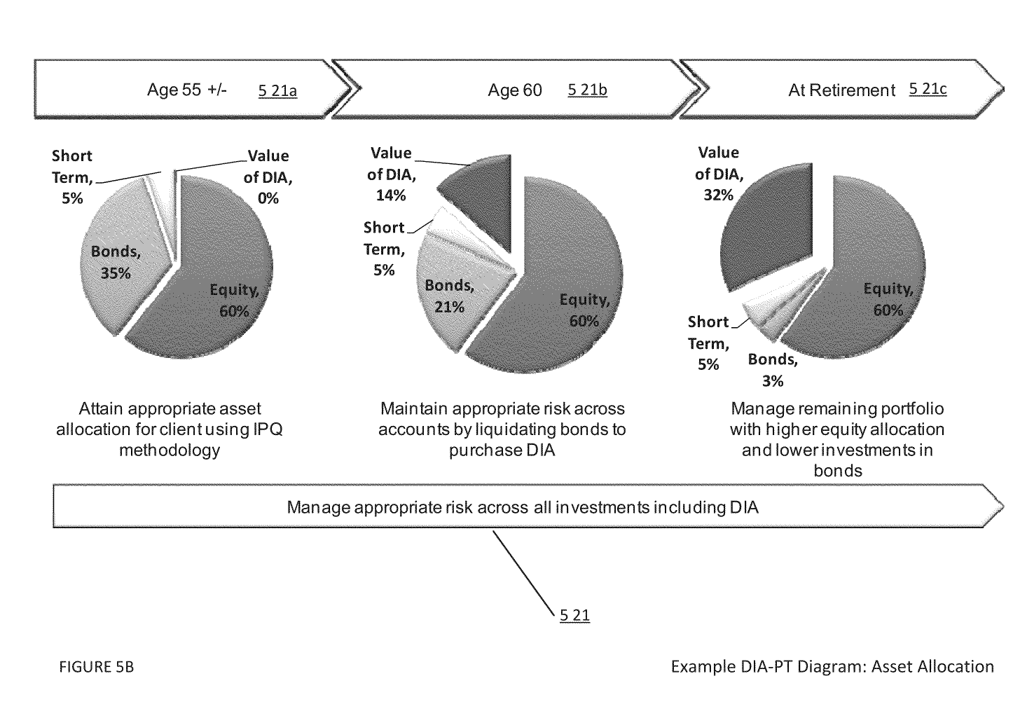

In one implementation, once the DIA purchasing starts, for each month 309 (or bi-monthly, quarterly, etc.), the DIA-PT may receive income contribution 311 from the participant and purchase DIA based on the purchasing strategy 312. In one implementation, the DIA-PT may determine the DIA market value for asset allocation rebalance (e.g., see FIG. 5A) 313, and then update the asset allocation 314 of the participant's portfolio (e.g., see FIGS. 4D and 5B, etc.).

Continuing on with FIG. 3B, the DIA-PT may receive updated parameters 316, e.g., updated personal parameters 315 (e.g., the participant may update income, employment, target income percentage, etc.). For example, the participant may experience personal life change, e.g., start a family, home purchase, employment change, and/or the like, which may likely effect the participant's portfolio investment. In another example, the DIA-PT may receive updates from the data provider 302, e.g., interest rate, inflation, corporate yields updates, etc.

In one implementation, the DIA-PT may determine whether a rebalancing 318 is necessary, and proceed to rebalance the participant's portfolio 321. Such rebalancing may be performed periodically upon DIA purchasing cycle, and/or may be triggered by a particular event (e.g., participant life changing event, market crash, etc.). Further discussion of rebalancing 321 may be discussed in FIG. 5A.

In one implementation, the DIA-PT may determine whether the retirement age has been reached 322. If yes, the DIA-PT may determine a pay-out amount 323, e.g., based on the DIA annuity, etc., and the user may periodically receive a pay-out amount 324.

FIG. 3C provides an exemplary logic flow illustrating DIA income replacement procedure components within embodiments of the DIA-PT. For example, in one implementation, the DIA-PT may comprise a financial questionnaire component 331a to collect an individual investors personalized parameters, such as, but not limited to current income, age, retirement age, asset allocation, retirement expenses, income, assets and contributions, and/or the like.

In one implementation, the DIA-PT may comprise a guaranteed income need estimator component 331b, which may estimate parameters such as essential expenses, lifetime income, retirement tax rate, essential expense gap, and/or the like, to provide an estimate of desired income after retirement. In one implementation, the DIA-PT may comprise a guaranteed income affordability estimator component 331c, which may determine a maximum percentage of replacement from the DIA purchasing, based on age, retirement age, contribution rate, asset allocation, income start age, and/or the like.

In one implementation, the DIA-PT may comprise a target replacement amount estimator component 331d, which may convert the expense gap into income replacement percent needed, and/or the like. In one implementation, such recommendation may apply for the maximum affordable income.

FIG. 3D provides an example DIA process flow diagram illustrating aspects of DIA income generation through different time stages (e.g., accumulation 532a, transition (55+) to retirement 332b, through retirement 332c, at retirement 332d) within embodiments of the DIA-PT. Within embodiments, a plan sponsor (e.g., the employer, insurance, etc.) 330 may provide and/or amend pension policy to allow in-service withdrawals, wherein a participant 320 may enroll in such DIA plan based on income replacement needs. For example, a participant may establish Fidelity IRA as needed 332.

In one implementation, when the participant reaches the age of 55, e.g., at a transition stage to retirement 332b, the participant 320 may begin periodic withdrawal 333 from the plan, e.g., to purchase DIA 334. In one implementation, the income may be reflected on the net benefits 335 of the participant's income statement, who may continue to withdraw funds for income replacement 336 through retirement 332c. For example, the participant may continue DIA purchase 337 as the IRA rollover. In one implementation, at retirement 332d, the participant 320 may stop the withdrawal 338 as there may not be any income; the participant 320 may continue IRA rollover 339, and start to receive annuity payments 342 from prior DIA purchases.

The pie charts 341a-341d provide exemplar asset allocation within the participant's portfolio. For example, at accumulation stage 332a and/or transition 332b, prior to DIA purchase, the portfolio may comprise 30% bonds, 5% short terms, 60% equity, as shown at 341a-b. Upon DIA purchase starting at transition stage, the portfolio may have a growing percentage of DIA, e.g., 14%, while taking the bonds 21% to purchase DIA, as shown in 341c. In one implementation, at 341d, at retirement 332d, the participant 320 may have a total of 32% DIA. As further illustrated in FIGS. 5A-5C, the DIA-PT may maintain the equity exposure via rebalancing.

FIGS. 4A-4B provide a logic flow diagram illustrating aspects of income replacement assessment based on historical back-tests within embodiments of the DIA-PT. In one implementation, the DIA-PT may determine appropriate income replacement targets based on historical back-tests with hypothetical purchases of deferred income annuities so as assess the efficacy of replacing a percentage of pre-retirement income with deferred income annuities, e.g., 403. For example, the DIA-PT may examine purchasing timeframes of 5, 10, and 15 years, with monthly purchase, and set up historical backtests starting in January, 1926 with rolling 5, 10, and 15 year periods, e.g., 404. Thus, the first 10-year purchasing period is from January, 1926 through December, 1935, the second from February, 1926 through January, 1936, and so on.

In one implementation, assuming all annuity purchases are made with pre-tax plan assets and that all annuity income payments are fully taxable, the DIA-PT may load the individualized parameters, such as gender, age, annual income, employment industry, educational background, demographics, geo-location, and/or the like, e.g., 406, and select a type of annuity based on the individual parameters 407. For example, the DIA-PT may select life-only, level-payment (no cost-of-living adjustment) annuities, for a male starting DIA investment in his 30s. In other implementations, achievable income replacement rates may be generated for the specific annuity type, payment form, and gender of the individual.

Within implementations, the DIA-PT may determine the income contribution percentage 408, e.g., assuming contributions are made to the account in the amount of 12% of employment income (e.g., 9% from the employee and 3% from the employer). For example, the contribution rate of 12% is approximately the median contribution rate of individuals 50 to 65 years of age who are participants in plans administered by Fidelity Investments. In one implementation, the DIA-PT may assume that all contributions are pre-tax and that all balances are pre-tax; and that during this period, there are no withdrawals (except to purchase deferred income annuities) and no other complicating activities such as loans or QDROs. Depending on the purchasing timeframe, the DIA-PT may model purchases to start at age 50, 55, or 60 for 15, 10, or 5 years respectively, e.g., 409. For example, retirement age may be modeled as at 65.

In one implementation, the DIA-PT may examine the capacity to replace pre-retirement, pre-tax income at varying levels of existing savings and varying asset allocations, e.g., 410. Existing savings may be modeled as a multiple of earned income from 1 to 10 times income. Thus, if someone makes $50,000, then the existing savings would range from $50,000 to $500,000. Of course, since savings are expressed as a multiple of income and contributions are expressed as a percentage of income, the actual earned income amount may not be relevant.

In one implementation, the DIA-PT may model financial projections under several different participant asset allocation scenarios, e.g., 412. Example asset allocations between several instruments such as but not limited to stock, fixed income, short-term investment vehicles, and/or the like:

TABLE 2
Example Asset Allocation

| | | Fixed Income | Short-term |
|---|---|---|---|
| Portfolio Name | Stock Allocation | Allocation | Allocation |
| Growth | 70% | 25% | 5% |
| Growth with Income | 60% | 35% | 5% |
| Balanced | 50% | 40% | 10% |
| Conservative | 20% | 50% | 30% |

Throughout the purchasing period, the DIA-PT may maintain the exposure to equities by setting a target equity exposure rate, e.g., 413. For example, if the total portfolio value is $250,000 and target equity exposure is 50%, then the DIA-PT may make sure equity exposure is $125,000. Each purchase is made from the fixed-income portion of the portfolio, e.g. bond funds, and if necessary, the cash portion of the portfolio is used as well (only in cases when the fixed income portion is exhausted). For asset allocation purposes, DIAs may be treated as a type of fixed income so that DIA-PT may sell one type of fixed income investment (e.g. bond funds) and buy another (DIAs). Asset allocation is calculated using the market value of the DIA as part of the fixed-income allocation.

In one implementation, the DIA-PT may set a DIA income purchasing target, e.g., a target replacement percentage of the final ending salary 415 and complete the setup process 416. The DIA-PT may then start a periodic process to purchase DIA income units 417. For example, the DIA-PY may start by calculating the current monthly income and assume that monthly income increases with actual inflation plus a real growth rate of 1.5% annually (about 0.124% per month). In one implementation, the DIA-PT may also calculate a projected future income at the point of retirement. For example, the DIA-PT may assume a 2.5% inflation rate and a 1.5% real growth rate. Thus each month in an historical back-test the DIA-PT may update the projected future income amount to reflect the difference between last month's actual inflation and the annual rate assumption of 2.5%. Projected future income at retirement is required to calculate the purchase amount each month since DIA-PT may replace a specified percentage of final ending income, e.g., 415.

In one implementation, the DIA-PT may deposit the contribution (e.g., 12% of monthly income in our model) into the qualified plan, determine a DIA purchase amount for the time period 418 (e.g., month, week, bi-week, etc.), and purchase the specified amount of DIA (purchasing strategy explained below), and sell remaining fixed income funds to pay for the DIA, 421, when the fixed income funds are greater than zero 419.

Continuing on with FIG. 4B, as already stated, cash investments may be used, e.g., 422 if fixed-income funds are exhausted. Equity exposure is maintained 423, and DIA-PT may not purchase DIA 425 if it would force the sale of equities or the target equity exposure is not met 424. DIA-PT may then rebalance the portfolio based on the total capitalized value of the portfolio, e.g., an “Informed Asset Allocation” procedure 426, which is further illustrated in FIGS. 5A-5B. The total capitalized value of the portfolio equals the market value of equities, bonds, short-term, and DIA. The market value of DIA is the current (at the evaluation month) cost to purchase all existing DIA income streams. The DIA-PT may then apply the applicable historical monthly return to each of the stock, bond, and short-term asset classes 427. Index returns are used for historical performance, without the inclusion of potential fees or expenses, i.e. raw index returns. The process continues each month until retirement 428.

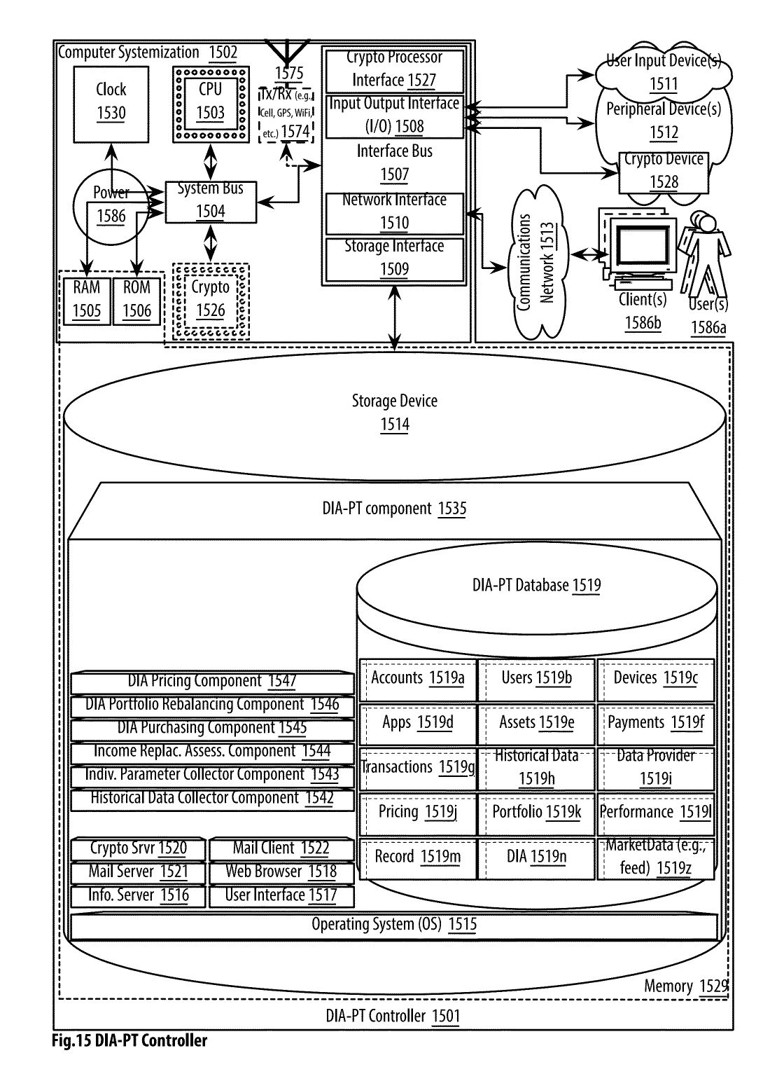

In one implementation, at the point of retirement, DIA income may start to pay out and the income amount may equal the target percentage of pre-retirement income, e.g., 431—assuming sufficient DIA income could be purchased. The DIA-PT may store the assessment record portfolio 433, e.g., see Portfolio table 1519f in FIG. 15.

FIG. 4C provides a diagram illustrating DIA configuration within embodiments of the DIA-PT. Within implementations, the DIA-PT may configure timeframes 435 for DIA purchase, e.g., years before retirement to start DIA purchase, such as but not limited to 5, 10, 15 years, etc; long-term asset allocations 436, e.g., a target equity exposure percentage such as but not limited to 20%, 50%, 70%, etc.; Portfolio Risk Maintenance 437, e.g., total portfolio analysis using DIA market value to maintain a constant equity percentage of total portfolio, and/or the like.

FIG. 4D provides example charts illustrating aspects of target equity exposure within embodiments of the DIA-PT. Within embodiments, as shown at 441a, the DIA-PT may maintain a target equity percentage of total portfolio, wherein the total portfolio includes the traditional portfolio and the value of DIA 442. In one implementation, the constant equity percentage of the total portfolio means rising equity percentage of the traditional portfolio 441b, and DIA purchases may come from bonds and cash of the traditional portfolio.

In another implementation, the DIA-PT may maintain a target equity percentage 441b of traditional portfolio. For example, the constant equity percentage in the traditional portfolio 441b means a declining equity percentage 441c in the total portfolio.

For example, when the DIA-PT starts with $200 total and 50% in equity ($100); the DIA-PT may then use $40 to purchase DIA (e.g., out of bonds or cash, etc.); equity is 50% of remaining portfolio (excluding) of $160 or $80 of value, and equity is worth $80/$200=40% of total portfolio including DIA.

FIG. 5A provides a logic flow diagram illustrating aspects of portfolio rebalancing of DIA within embodiments of the DIA-PT. Within embodiments, since both Deferred Income Annuities and pension plans offer the same life-time income they have the same composition. In one implementation, pension plans may immunize their liabilities by purchasing fixed income instruments that match the duration exposure of their underlying liabilities. Insurance companies, offering DIAs, may also invest underlying portfolios into fixed income instruments to hedge their risks. As such, one's lifetime income may be assessed and treated equally to holding a portfolio of fixed income instruments. Additionally, insurance companies and pension plans may obtain risk reduction benefits to offer life-long income rather than period certain income, which investors cannot obtain individually.

In one implementation, if the investor simply purchases DIA and rebalances the remaining portfolio to the original asset allocation the overall risk exposure of the household would fall. For example, for a participant starts with a portfolio of 60% equity and 40% fixed income (e.g., bonds, etc.), at the age of 55 the participant may begin to purchase guaranteed income; and after each purchase the participant rebalances the portfolio to the original 60% equity and 40% fixed income. If the guaranteed income is included as a portfolio of fixed income, the participant would no longer be invested in a 60/40 portfolio, rather he may have part of the portfolio in 60/40 and the other part 100% fixed income. Thus this participant may continuously reduce the overall equity exposure of their total portfolio and increase his fixed income exposure. As such, this unintentional reduction in risk may cause the investor to move away from the optimal allocation and potentially reduce his chances of success in retirement.

In one implementation, the DIA-PT may evaluate the guaranteed income similar to a fixed income portfolio. For example, the DIA-PT may set an asset allocation 503, and for each month 505, the DIA-PT may use the prevailing interest rate environment, mortality assumptions and the associated cash-flows to calculate a market value for the annuity income purchased at anytime, e.g., 506. When rebalancing the DIA-PT may consider this market value treat the portfolio as a fixed income asset so that the allocation to DIA and other fixed income is equal to the original allocation to fixed income, e.g., 507. In the example above, the participant would have accumulated 14% allocation to DIA by the time the participant reaches the age of 60, meaning that the market value of the income at retirement was equal to 14% of the total portfolio market value (equity, fixed income, cash and DIA). In one implementation, the DIA-PT may then reduce the allocation to fixed income to compensate for that 14%. As such, through this rebalancing process the overall risk of the portfolio may be maintained at the optimal level at all times.

In one implementation, when the remaining traditional fixed income exposure is completely gone, e.g., 509, and the participant is over exposed to DIA, (e.g., the DIA income may not be sold to rebalance), the DIA-PT may suspend any future DIA purchases 511 until/if the target allocation to fixed income plus cash is greater than the market value of the DIA 512. In this way, the DIA-PT may not reduce the equity exposure.

In one implementation, the DIA-PT may assess the effect on asset allocation by looking at snapshots of the total portfolio at the beginning, middle, and end of the process. For example, a numeric example of the rebalancing process may be illustrated in FIG. 5B, illustrating how total equity exposure remains constant, while the fixed income allocation moves from bonds to mostly DIA; and the DIA-PT may manage appropriate risk across investments including DIA 521.

As shown in FIG. 5B, at age 55 521a, when the participant may just start to purchase CIA, the portfolio may comprise 30% bonds, 5% short terms, 60% equity, with zero value of DIA. At this stage, the DIA-PT may attain appropriate asset allocation for the participant. In one implementation, at age 60 521b, when the participant has been purchasing DIA for 5 years, the portfolio may have a growing percentage of DIA, e.g., 14%, while 21% bonds (bonds have been taken to purchase DIA). The DIA-PT may maintain appropriate risk across accounts by liquidating bonds to purchase DIA, so as to maintain the equity exposure to be 60%.

In one implementation, at 521c retirement, the participant 320 may have a total of 32% DIA, and the bonds have been reduced to 3% due to DIA purchases. As such, the DIA-PT may manage the remaining portfolio with higher equity allocation and lower investments in bonds.

For example, Table 3 provides an example portfolio of asset allocation maintaining an equity exposure percentage of total portfolio.

TABLE 3
Example Portfolio Maintaining a Constant Equity Exposure

| | Purchasing Period | | |
|---|---|---|---|
| | 5 Years | 10 Years | 15 Years |
| Starting Age | 60 | 55 | 50 |

Conservative Asset Allocation: 20% Equity*

| | | | | | | |
|---|---|---|---|---|---|---|
| Max DIA Advantage | 8.3% | $65,000 [symbol] | 13.1% | $135,00 [symbol] | 23.4% | $296,00 [symbol] |
| Average DIA Advantage | 0.7% | $4,000 [symbol] | 2.1% | $16,00 [symbol] | 3.4% | $33,000 [symbol] |
| Min DIA Advantage | −6.7% | ($42,000 [symbol] | −8.2% | ($57,000 [symbol] | −10.1% | ($87,000 [symbol] |

Balanced Asset Allocation: 50% Equity*

| | | | | | | |
|---|---|---|---|---|---|---|
| Max DIA Advantage | 14.3% | $72,000 [symbol] | 12.9% | $165,00 [symbol] | 22.7% | $393,00 [symbol] |
| Average DIA Advantage | 0.6% | $5,000 [symbol] | 2.2% | $21,00 [symbol] | 3.5% | $47,000 [symbol] |
| Min DIA Advantage | −6.5% | ($41,000 [symbol] | −8.0% | ($56,000 [symbol] | −10.0% | ($90,000 [symbol] |

Growth Asset Allocation: 70% Equity*

| | | | | | | |
|---|---|---|---|---|---|---|
| Max DIA Advantage | 48.9% | $119,000 [symbol] | 24.2% | $135,00 [symbol] | 27.0% | $355,00 [symbol] |
| Average DIA Advantage | 0.5% | $2,000 [symbol] | 1.1% | $14,00 [symbol] | 2.7% | $46,000 [symbol] |
| Min DIA Advantage | −7.7% | ($51,000 [symbol] | −11.5% | ($84,000 [symbol] | −10.7% | ($88,000 [symbol] |

[symbol]

indicates data missing or illegible when filed

For another example, Table 4 provides an example portfolio of asset allocation maintaining an equity exposure percentage of the remaining traditional portfolio.

TABLE 4
Example Portfolio of Constant Equity Exposure

| | Purchasing Period | | |
|---|---|---|---|
| | 5 Years | 10 Years | 15 Years |
| Starting Age | 60 | 55 | 50 |

Conservative Asset Allocation: 20% Equity*

| | | | | | | |
|---|---|---|---|---|---|---|
| Mm DIA Advantage | 15.8% | $80,000 [symbol] | 16.1% | $1225,00 [symbol] | 22.9% | $290,00 [symbol] |
| Average DIA Advantage | 0.2% | $1,000 [symbol] | 0.7% | $8,000 [symbol] | 1.2% | $19,00 [symbol] |
| Min DIA Advantage | −9.8% | ($59,000) | −10.4% | ($72,000) | −11.8% | ($96,000) |

Balanced Asset Allocation: 50% Equity*

| | | | | | | |
|---|---|---|---|---|---|---|
| Max DIA Advantage | 43.9% | $135,00 [symbol] | 26.8% | $108,00 [symbol] | 28.2% | $198,00 [symbol] |
| Average DIA Advantage | −1.3% | ($12,000) | −3.0% | ($26,000) | −4.2% | ($39,000) |
| Min DIA Advantage | −12.3% | ($99,000) | −17.0% | ($151,000 [symbol] | −18.7% | ($212,000 [symbol] |

Growth Asset Allocation: 70% Equity*

| | | | | | | |
|---|---|---|---|---|---|---|
| Max DIA Advantage | 73.1% | $178,00 [symbol] | 37.5% | $126,,00 [symbol] | 37.8% | $225,00 [symbol] |
| Average DIA Advantage | −1.6% | ($21,000) | −4.4% | ($49,000) | −6.3% | ($85,000) |
| Min DIA Advantage | −16.1% | ($171,000 [symbol] | −21.5% | ($265,000 [symbol] | −23.9% | ($413,000 [symbol] |

[symbol]

indicates data missing or illegible when filed

FIG. 6 provides a logic flow diagram illustrating aspects of generating DIA purchasing strategy within embodiments of the DIA-PT. Within embodiments, the DIA-PT may develop DIA purchasing strategy to purchase deferred income annuities each month (other periods would certainly be viable, such as quarterly) to replace a target percentage of income. The DIA-PT may create a defined benefit like income by implementing the created purchasing strategy. In one implementation, the target percentage may be a percentage of final pre-retirement income, before taxes. In another implementation, the target income replacement rate of final ending income may be obtained from another entity 603, e.g., by request from the participant, a third party entity that assesses income need and income generating capacity of plan assets, and/or the like.

In one implementation, the DIA-PT may calculate projected pre-retirement income based on current income 604, assumed inflation rate and assumed real income growth rate. For example, in one implementation, the pre-retirement income may be calculated according to the following:

Pre-retirement income=current income×((1+a%)×(1+b%))^{T}

wherein a % represents the expected monthly inflation rate; b % represents the monthly real income growth rate; and T represents the number of months to the target retirement age. For example, if current salary is $50,000, expected inflation is 2.5% per year, real income growth rate is 1.5% per year, and there are 10 years to retirement, projected pre-retirement salary may be calculated as $74,279. In one implementation, the DIA-PT may use an assumption of 1.5% annual real income growth and an assumption of 2.5% annual inflation for all 5-, 10-, and 15-year purchasing periods. In another implementation, the DIA-PT may adopt real or individualized personal income growth rates that reflects the participant's personal income prospects (e.g., individual employment industry, individual employment history, individual educational background, individual income history, and/or the like) 606; and the DIA-PT may further employ an inflation rate that reflects the asset manager's expectation for inflation for the applicable purchasing period.

In one implementation, the DIA-PT may calculate the first DIA purchase according to the following 607:

First DIA purchase=Future monthly income amount to purchase×cost today of $1 income per month starting at retirement.

In one implementation, the DIA-PT may then calculate further monthly income amount to purchase according to 608:

Future monthly income amount to purchase=(estimated pre-retirement monthly income×(income replacement rate)/(number of months until retirement).

For example, if a $1 of income per month costs $140, projected pre-retirement income=$80,000 per year, the number of months to retirement=120, and target income replacement is 40%, the DIA-PT may calculate the DIA purchase as following:

$$\begin{matrix}First DIA purchase = ( 80 \text{,} 000 / 12 \times 0.4 ) / 120 \\ = \$22 .22 of monthly income \\ = \$22 .222 * 140 \\ = \$3 \text{,} 111.11\end{matrix}$$

The DIA-PT may then calculated a next (e.g., the second) DIA purchase as 609:

Second DIA purchase=Future monthly income amount to purchase*cost 1 in 1 month from now of $1 income per month starting at retirement.

wherein the future monthly income amount to purchase is calculated 612 as

((estimated pre-retirement monthly income)>(income replacement rate)−DIA income already purchased)/(number of months remaining until retirement)

As such, assuming the cost of $1 of income in 119 months is $140.45, then the second DIA purchase=((80,000/12×0.4)−$22.22)/119=$22.22 of monthly income which costs $22.222×140.45=$3,121.11.

In one implementation, the DIA-PT may determine whether to calculate a next DIA purchase 613. If yes, for example, the DIA-PT may calculate the third DIA purchase in a similar manner, e.g.,

third DIA purchase=Future monthly income amount to purchase*cost 1 in 2 months from now of $1 income per month starting at retirement.

The DIA-PT may then calculate the future monthly income amount to purchase as:

((estimated pre-retirement monthly income)×(income replacement rate)−DIA income already purchased)/(number of months remaining until retirement)

If assuming the cost of $1 of income in 118 months is now $117.00 due to a change in interest rates, then the projected pre-retirement income is updated to $84,000 due to a change in salary. As such,

$$\begin{matrix}The third DIA purchase = ( ( 84 \text{,} 000 / 12 * 0.4 ) - \$44 .44 ) / 118 \\ = ( \$2 \text{,} 800 - \$44 .44 ) / 118 \\ = \$23 .35 of monthly income which \\ costs \$23 .35 * \$117 .00 \\ = \$2 , 732.21\end{matrix}$$

In one implementation, the DIA-PT may repeat the calculation of DIA purchase each month until retirement 616. In any given month the projected pre-retirement income may potentially be updated 614. An update may occur if there are expected inflation changes, expected compensation growth rate modifications, or if current compensation changes, e.g., 613. As such, the DIA-PT may recalculate the DIA purchasing each month based on any new or updated information.

FIGS. 7A-7B provide a logic flow diagram illustrating aspects of DIA pricing within embodiments of the DIA-PT. Within implementations, the DIA-PT may determine a price based on historical data for the DIA instrument for an individual to purchase. For example, in one implementation, the DIA-PT may create a hypothetical interest rate curve to price DIAs throughout history. Within implementations, insurance companies, and/or the DIA-PT may obtain and employ an investment grade corporate bond curve as the base of their pricing curve 703, such as but not limited to BBB corporate bond yield curve, and/or the like.

FIG. 7C provides an exemplary pricing curve within embodiments of the DIA-PT. For example, as shown in FIG. 7C, for period I 751 which starts at December 1996, the DIA-PT may adopt Bank of America Merrill Lynch BBB1-BBB3 corporate yield curve 754 (e.g., box 704 in FIG. 7A), which was available monthly for each annual maturity between 1 year and 30 years and provides the base rate for pricing DIAs during this time period. For the period from January 1985 to November 1996, Period II 752, the DIA-PT may construct the corporate curve from two separate indices such as but not limited to the Bank of America Merrill Lynch US Government yield curve and a hypothetical corporate curve that the DIA-PT created (e.g., box 706 in FIG. 7A), e.g., 755 in FIG. 7C. For example, the Merrill Lynch data may provide annual US Treasury yields from January 1985 to November 1996, and the DIA-PT may obtain corporate spreads to build the full curve, as further illustrated in FIG. 7B.

Continuing on with FIG. 7B, in one implementation, the DIA-PT may obtain Moody's Seasoned Baa Corporate Bond Yields 723 from the St. Louis Fed., which may date back to early 1900s and reflect corporate yields for long term Baa corporate bonds. To estimate the Baa 30 year spread, the DIA-PT may use the LT treasury rates from Ibbotson and subtract the Moody's Baa corporate yield for each period to obtain an interest rate 724.

In one implementation, the DIA-PT may then create a term structure for the estimated corporate spread based on the one point on the interest rate curve 726. For example, the DIA-PT may obtain the corporate spread data from our Bank of America Merrill Lynch Baa1-Baa3 to define the corporate spread term structure at each maturity as a percent of the 30 year spread 727. For example, if the 30 year spread on Sep. 30, 1999 was 178 bps and the 5 year spread was 156 bps, then the term structure may define the 5 year spread as 88% of the 30 year spread. In one implementation, the DIA-PT may define the entire data set from December 1996 onward in this manner and then average each annual point to define an average term structure of spreads as a percentage of the 30 year spread, e.g., 728. The DIA-PT may then apply this term structure to the historic 30 year spread data to calculate the spread for all maturities from 1 to 30 years for historical months 729, e.g., from January 1926 to November 1996.

In one implementation, as described at 706 in FIG. 7A, the DIA-PT may employ treasury curve data from January 1985 to November 1996 to which DIA-PT may apply the newly calculated corporate spread data 731, which may generate approximations for BBB corporate yields dating from January 1985 to November 1996, or period II.

Returning to FIG. 7A, in one implementation, for the period starting January 1926 to December 1984, period III, the DIA-PT may generate an interpolated treasury curve based on treasury yields and then apply the hypothetical spreads obtained from Period II to generate the pricing curve 707 (e.g., see 756 in FIG. 7C). For example, the DIA-PT may adopt Ibboston treasury yield data from indices such as, but not limited to 30 Day T-Bill yield, Intermediate Gvt. Bond Yield, and Long Term Gvt. Bond Yield, and/or the like. In one implementation, the DIA-PT may apply the yields to the appropriate maturities on the yield curve of 1, 5 and 20 years, respectively, and apply a linear interpolation procedure to calculate the remaining points on the curve. Then the DIA-PT may apply the previously estimated spread to this new interpolated curve.

In one implementation, the DIA-PT may obtain a full pricing curve connecting periods I-III 708 (e.g., as shown in FIG. 7C). When the annuity prices require a long term yield curve which spanned much more than 20 years 709, given the liquidity constraints and data issues for longer securities, the DIA-PT may maintain a flat yield curve for any time period after 20 years, e.g., 710.

Within implementations, when insurance companies use a similar curve as a base to price their products, they may need to incorporate a safety margin for default risk, profit, etc. The DIA-PT may analyze a history of annuity prices, both deferred income annuities and single premium immediate annuities to make pricing adjustments 712, e.g., DIA-PT may approximate actual prices by subtracting 150 bps from the corporate curve. In one implementation, the DIA-PT may re-evaluate DIA prices based on time period economic phase 714. For example, during periods of perceived low default risk 716, when the calculation underestimates annuity payouts, the DIA-PT may put a lower limit on the final curve of the maximum of (Estimated BBB curve—150 bps or Treasury Curve), e.g., 717. On the high end 718, e.g., in times of crisis, if bond spreads becomes very wide and the calculation may overestimates the payouts from income annuities, the DIA-PT may bound on the high end of 75 bps above treasuries 719, which provides relatively stable estimates that closely matched historic pricing.

In one implementation, once the base rate is obtained, as described above, the DIA-PT may translate the base rate into an annuity price 721. In one implementation, assuming that any expenses are negligible, then the valuation of annuities essentially follows the same principle that is used to find the present value a stream of future cash flows. For example, the DIA-PT may multiply the future cash flows with appropriate discount factors according to the following:

PV=Σₜ₌₀ⁿ(CashFlowₜ)(DiscountFactorₜ)

For annuities, the numbers of future payments may not be known in advance because in the most common form of annuities the payment will stop as soon as the annuity holder dies. As such, in the case of annuities, each future cash flow may have a certain probability of occurrence, e.g., the probability of an annuity holder surviving until the date when the annuity payment is made. For example, the DIA-PT may calculate the expected present value of a series of annuity payments based on the mortality probability of the annuity holder 722 as:

Expected PV=Σₜ₌₀^{∞}(AnnuityPaymentₜ)(DiscountFactorₜ)(ₜPₓ)

Where, ₜPₓ=Probability an ‘x’ year old person will survive for at least t more years

Table II illustrates an example DIA pricing listing. In one implementation, the DIA may price an annuity for a 20-year payout, or alternatively, the annuity price may also include a certain probability of the holder living each year until a limit of 120 years of age. As shown in Table II, the DIA-PT may assume a nominal payment of $1000 a year, shown in the forth row. In the third row the DIA-PT may input the yield curve for the time period. For each payment the DIA-PT may calculate the present value of that payment using the appropriate yield, which may be similar to pricing a bond. As shown in row five, the present value of each payment is illustrated. For example: A $1,000 payment in year five is worth $722 today given a yield of 6.75%. The insurance company may need to pay that $722 if the holder survives until year five. If assuming the holder has a 95% chance of receiving that payment, the probability weighted value of that single payment will be $722×0.95%=$685. This process is repeated for each year and the probability weighted present values are added together to get a price of that payment stream. In this example as shown in Table II, the sum of the first 20 years is $9,401.

TABLE 5
Example DIA Pricing

| | Maturity | | | | | | | | | | |
|---|---|---|---|---|---|---|---|---|---|---|---|
| | 1 | 2 | 3 | 4 | 5 | 6 | 7 | 8 | 9 | 10 | 11 |
| | Age | | | | | | | | | | |
| | 65 | 66 | 67 | 68 | 69 | 70 | 71 | 72 | 73 | 74 | 75 |
| Interest | 6.46% | 6.53% | 6.61% | 6.69% | 6.75% | 6.80% | 6.84% | 6.87% | 6.90% | 6.89% | 6.89% |
| Rate | | | | | | | | | | | |
| Payment | $1,000 | $1,000 | $1,000 | $1,000 | $1,000 | $1,000 | $1,000 | $1,000 | $1,000 | $1,000 | $1,000 |
| Present | $939 | $881 | $825 | $772 | $722 | $674 | $629 | $588 | $548 | $513 | $481 |
| Value | | | | | | | | | | | |
| Probability | 99% | 98% | 97% | 96% | 95% | 94% | 92% | 90% | 89% | 87% | 85% |
| of Survival | | | | | | | | | | | |
| Prob. | $932 | $866 | $803 | $742 | $685 | $631 | $580 | $532 | $486 | $445 | $407 |
| Weighted | | | | | | | | | | | |
| PV | | | | | | | | | | | |
| | | | Maturity | | | | | | | | |
| | | | 12 | 13 | 14 | 15 | 16 | 17 | 18 | 19 | 20 |
| | | | Age | | | | | | | | |
| | | | 76 | 77 | 78 | 79 | 80 | 81 | 82 | 83 | 84 |
| | | Interest | 6.88% | 6.87% | 6.87% | 6.86% | 6.86% | 6.85% | 6.84% | 6.84% | 6.82% |
| | | Rate | | | | | | | | | |
| | | Payment | $1,000 | $1,000 | $1,000 | $1,000 | $1,000 | $1,000 | $1,000 | $1,000 | $1,000 |
| | | Present | $450 | $421 | $395 | $370 | $346 | $324 | $304 | $285 | $267 |
| | | Value | | | | | | | | | |
| | | Probability | 82% | 80% | 77% | 75% | 72% | 69% | 65% | 62% | 58% |
| | | of Survival | | | | | | | | | |
| | | Prob. | $371 | $337 | $305 | $276 | $248 | $222 | $199 | $177 | $156 |
| | | Weighted | | | | | | | | | |
| | | PV | | | | | | | | | |

Annuity Price $9,401

In one implementation, the DIA-PT may further obtain an estimate of the probability of survival at the date of annuity payment for 722. For example, the DIA-PT may employ the IAM mortality table for all historical periods dating back to 1926. The DIA-PT may use adjustment scale G for all mortality adjustments. In each historical period the DIA-PT may start with the IAM 2000 table adjusted for a current year and include future expected mortality improvements. For example, in large populations, mortality may improve with time, e.g., medical advancements may enable people to survive illness and generally may increase living standards to provide healthier environments on average. In one implementation, the DIA-PT may evaluate annuity purchasing strategies across different market regimes; and the DIA-PT may use historic market performance with the latest mortality assumptions so as not to affect generated annuity prices that are based on historic mortality assumptions.

FIGS. 8A-8E provide exemplary UI diagrams illustrating aspects of individual participant's configuration of DIA portfolio within embodiments of the DIA-PT. As shown in FIG. 8A, the DIA-PT may prompt a user to enter the expenses in retirement, e.g., essential expenses and discretionary expenses 801, monthly income needed 802, retirement income 803, and/or the like. As shown in FIG. 8B, the DIA-PT may provide an expense retirement budget worksheet 804 for the participant to provide expense data. As shown in FIG. 8C, the DIA-PT may prompt a participant to provide tax information 805. As shown in FIG. 8D, the DIA-PT may generate estimated analytics results, such as but not limited to monthly expenses in retirement, generating income in retirement 806, investment portfolio asset allocation review 807, and/or the like. As shown in FIG. 8E, the DIA-PT may provide analytics 808 for users such as but not limited to yearly asset projections, monthly income projection, and/or the like.

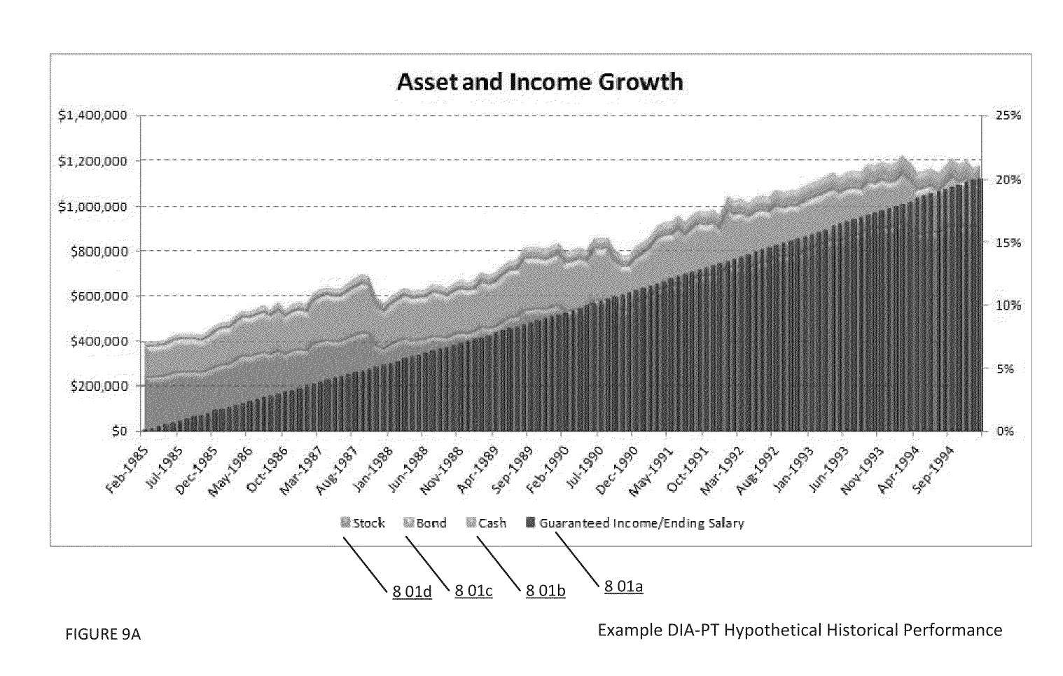

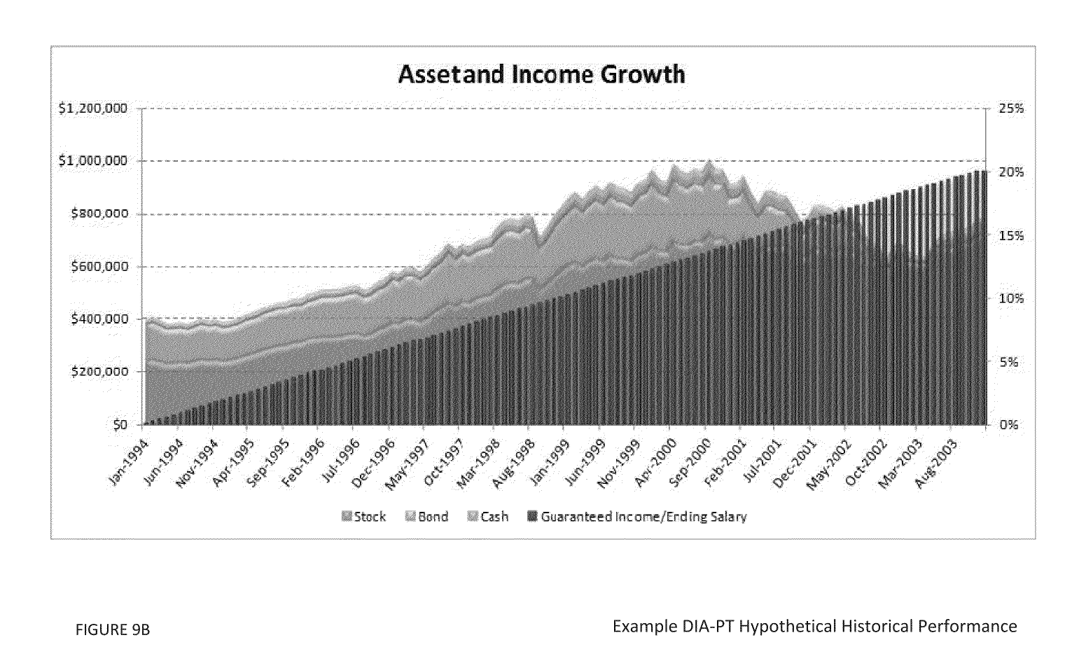

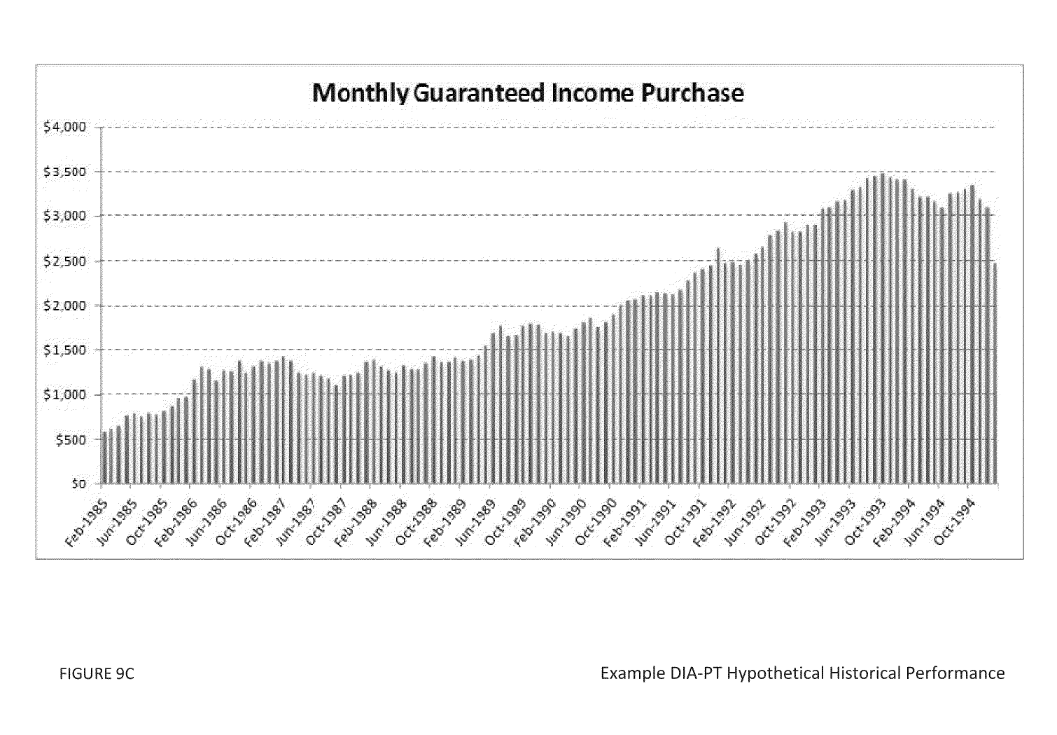

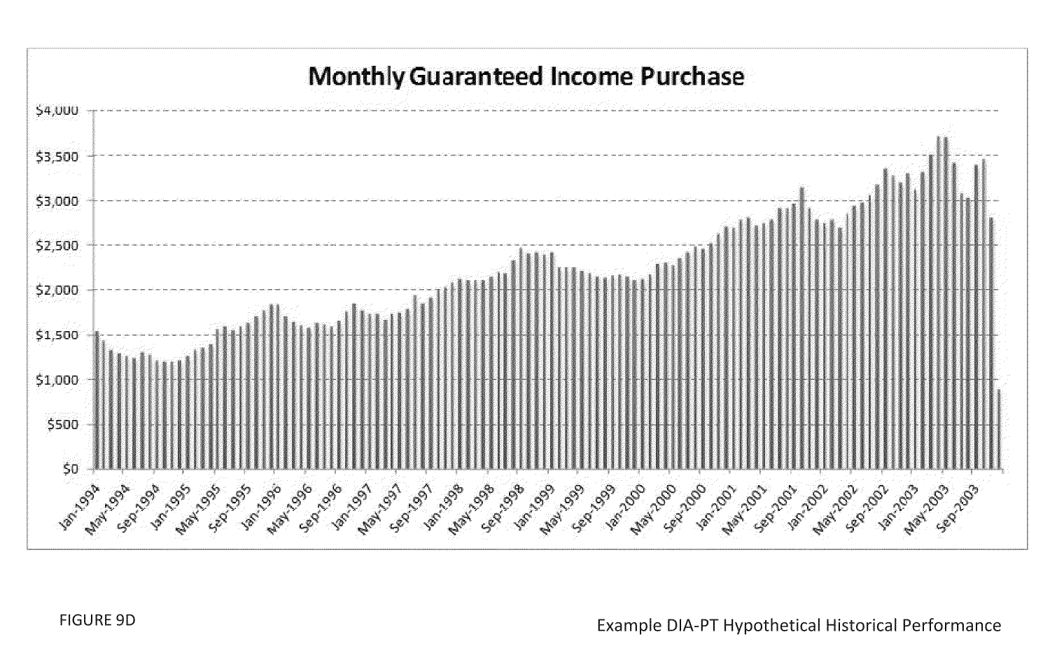

FIGS. 9A-9B illustrate hypothetical historical performance including an example 55-year old entering a DIA purchasing program in February of 1985 or starting in January, 1994, respectively, and investing over a 10-year period. For example, the participant may be a 55 year old client begins strategy February 1985, with a salary of $100,000 and $400,000 saved in current plan; contributions are 12% of salary and portfolio has a growth with income (e.g., 60% equity, 35% fixed income, 5% cash); target income replacement is 20% of ending salary; purchases are made from fixed income to maintain appropriate equity exposure as governed by the DIA-PT.

In one implementation, the participant may have an asset allocation of 60% stocks, 35% bonds and 5% short term. The blue bars 801a represent the steady growth of income replacement the participant is purchasing throughout this period while targeting a 20% replacement rate at retirement. The strategy solves for the appropriate monthly purchases of income to achieve this goal. Income replacement rate is reflected on the right side scale. In the background, it is illustrated the effects of market returns and ongoing contributions on the portfolio balance and how DIA purchases change the asset allocation of the remaining portfolio. Portfolio values are in nominal (actual) dollars. While the plan assets start with a 60% stock 801d/35% bond 801c/5% short-term 801b asset allocation, over time, the chart illustrates that the bond allocation, the light blue area in the graph, decreases relative to the other two asset classes. In January of 1990, after five years of purchases, the portion of the plan assets allocated to equity is 67% instead of 60% and the portion allocated to fixed income is down to 28% from 35%. By the end of the purchasing period in January 1995, the portion of the plan assets allocated to equity is 78% and the portion to fixed income is 16%. Throughout the purchasing period total portfolio (plan assets+value of DIAs purchased) asset allocation remains consistent with the target asset mix. Specifically, total equity exposure remains at 60% even though within the plan equity exposure rises to 78%.

FIG. 9B provides an example income growth illustration for a portfolio starting in January, 1994. In both FIGS. 9A and 9B, the target income replacement of 20% is achieved despite that the market experiences are quite different.

FIGS. 9C-9D illustrate hypothetical historical performance including the actual DIA investment amounts and the monthly income purchased for these same examples. As illustrated in the charts, the investment amounts will generally have an upward slope. There are a number of factors that affect the cost of purchasing guaranteed income including changes in interest rates, unexpected changes in inflation, reduction in deferral period and unexpected changes in income. In one implementation, if interest rates are held as constant and it is presumed that the estimate of pre-retirement income is accurate, monthly purchases may rise over time. This may be caused by the reduction in the deferral period from 120 months to 119 months, and so on. As the deferral period decreases each month the price per unit of income approaches the price of an immediate income annuity.

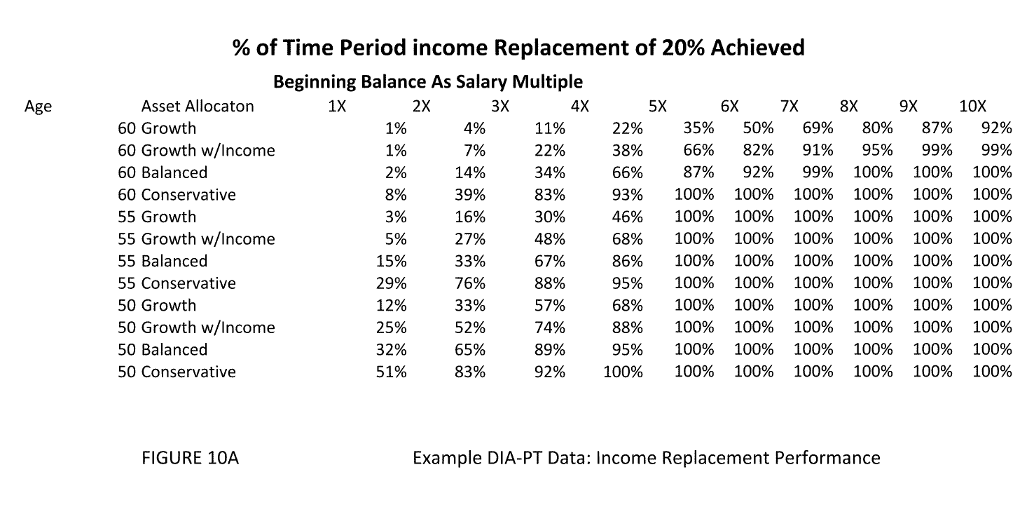

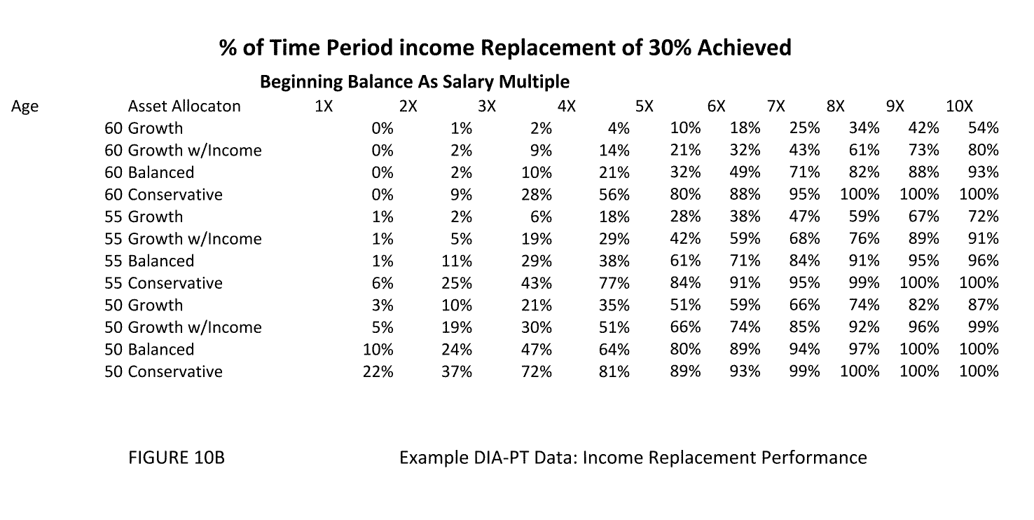

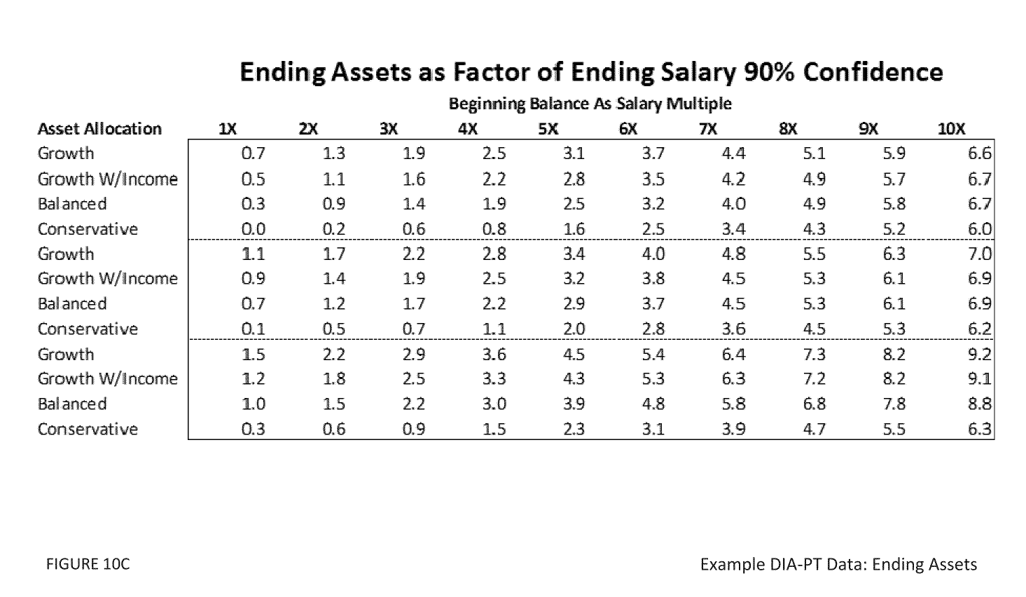

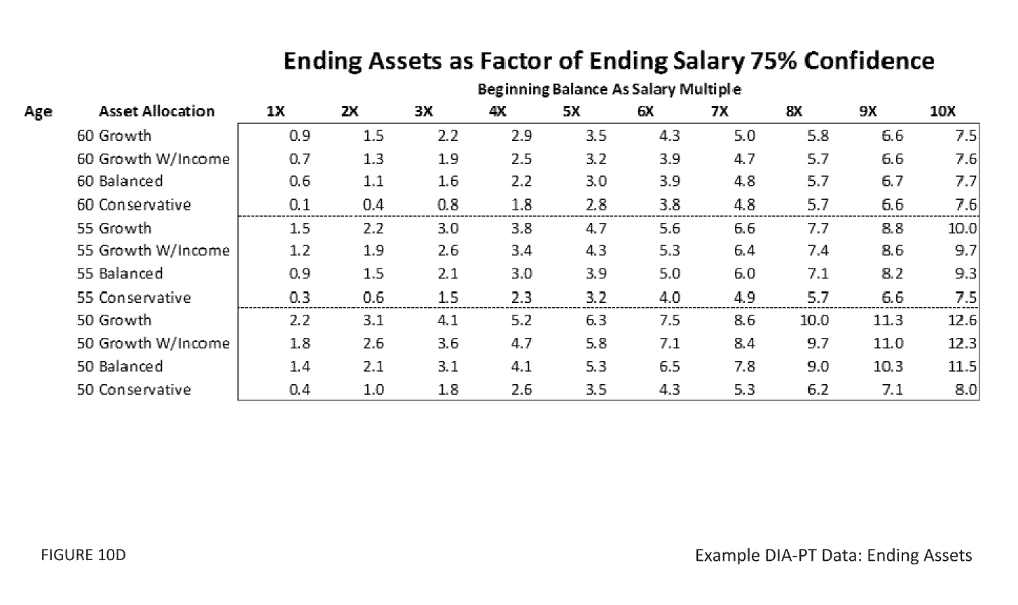

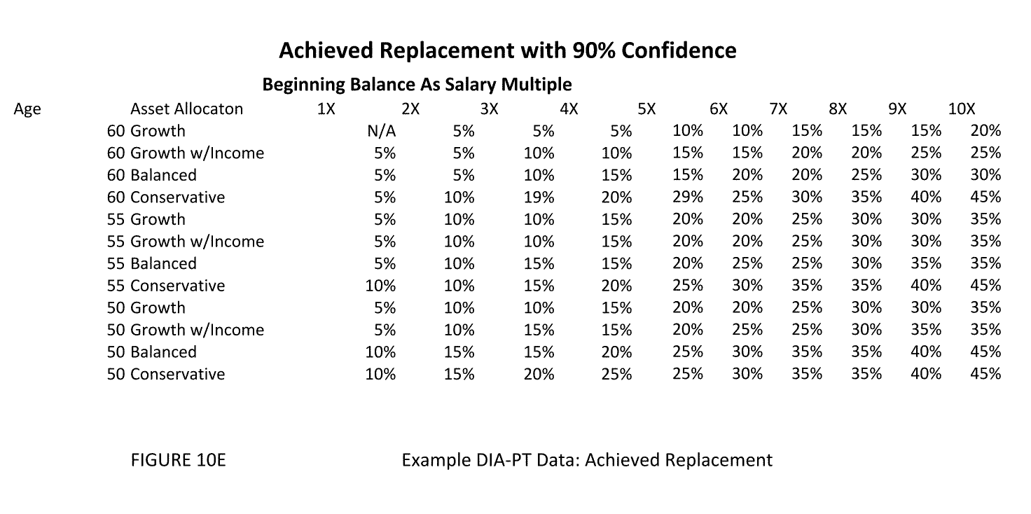

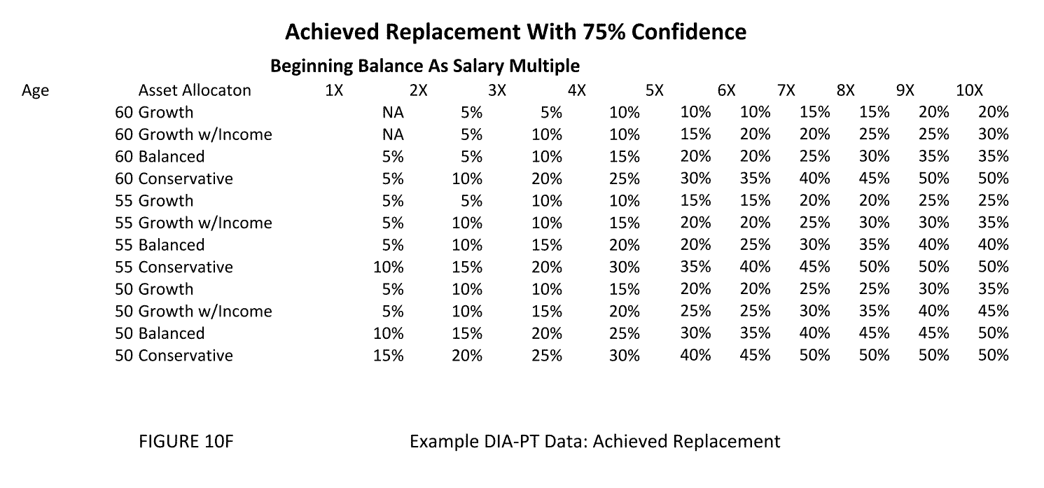

Within implementations, the charts shown in FIGS. 10C-10D indicate how much income replacement an investor may be able to attain given certain starting points of age, asset allocation, and multiple of salary saved in the plan, e.g. 401(k) plan, if assuming a retirement age of 65 and a total contribution rate (employee+employer) of 12% of salary. Historical time periods start in January, 1926 and are through January, 1998, January, 2003, and January 2008 for starting ages of 50, 55, and 60 respectively.

FIGS. 10A-10B show hypothetical historical performance including the percentage of rolling historical periods (rolling each month) in which the specified income replacement rate could be attained. The first table in FIG. 10A is a 20% income replacement and the second is a 30% income replacement. In our analysis we examined income replacement up to 50%, in 5% increments. As expected, the higher the savings multiple (savings divided by salary), the greater the percentage of historical successes. Also, as expected the percentage of historical successes declines when the target replacement is 30% instead of 20%. What may not be as expected is that more conservative asset allocations have higher success rates. The reason for this is simply that more conservative asset allocations have a greater percentage of assets to use to purchase income (fixed income and short-term may be used but not equity)

Along with the income replacement achieved for a given participant, the remaining assets for a participant after the purchasing program is complete is examined. FIGS. 10C-10D illustrate the remaining assets, as a multiple of ending salary, for a participant attempting to replace 20% of his or her pre-retirement income. FIG. 10C looks at the minimum assets remaining in 90% of the historic simulations (90% of the time remaining assets were at least this high or higher), while FIG. 10D contains values for the minimum in 75% of the simulations. As mentioned above, given that the more conservative portfolios have greater allocations to fixed income, they are able to achieve higher replacement rates. Coupled with FIGS. 10E-10F, FIGS. 1-C-10D show that, although higher replacement rates are achieved, the more conservatively allocated participants end with much lower asset balances in general.

FIGS. 10E and 10F show hypothetical historical performance including the percentage income replacement that historically could be attained. In one implementation, FIG. 10A shows attainable income replacement at a 90% confidence and the second at a 75% confidence. For example, the greater the savings multiple the higher the attainable income replacement, all else being equal. Again, since more conservative asset allocations have a greater percentage of assets to use to purchase income (fixed income and short-term may be used but not equity), the attainable income replacement rates are higher for more conservative asset allocations. For the 5% increments, at any given confidence level the income replacement value may provide a lower bound instead of an exact number.

In one implementation, the tables in FIGS. 10E-10F may be used directly for planning purposes. For example, if a 90% confidence level is desired and a 60 year-old is invested in a conservative portfolio with 5 times his salary saved, then the historical attainable income replacement through purchasing DIA over time is 25%. Likewise, if a 75% confidence level is desired and a 55 year-old is invested in a balanced portfolio with 4 times her salary saved, the then the historical attainable income replacement through purchasing DIA over time is 20%.

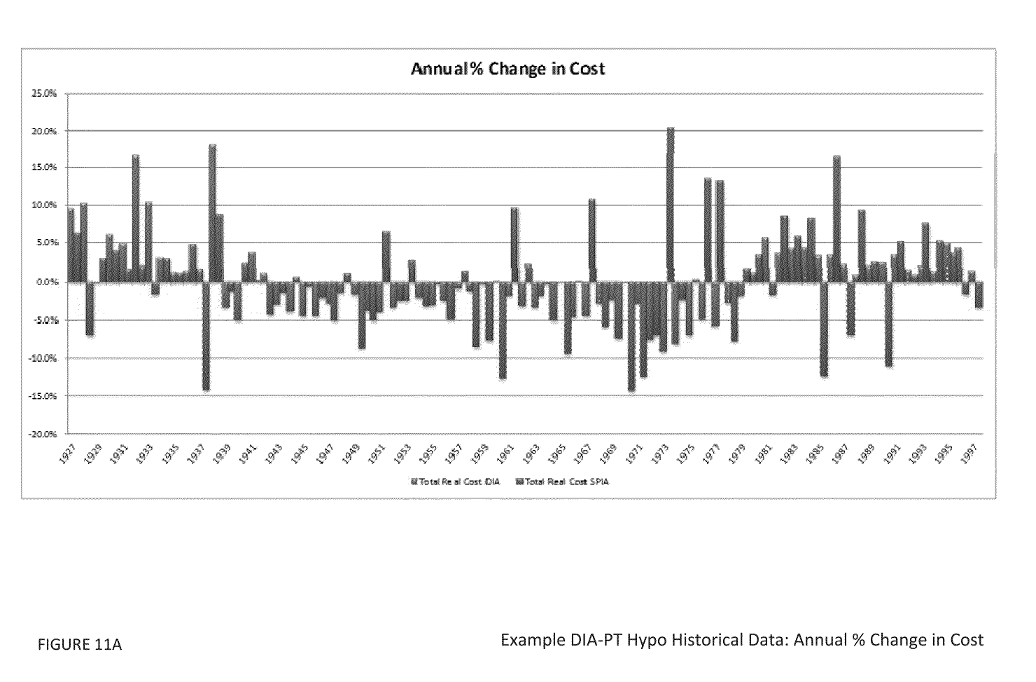

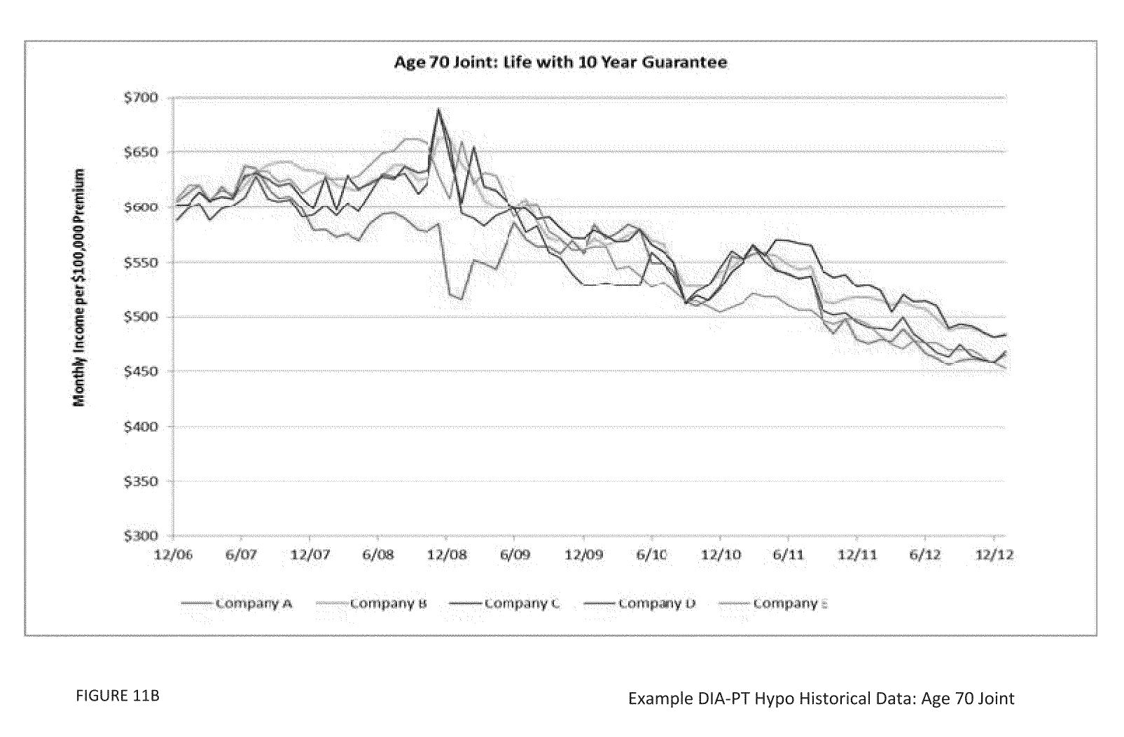

FIG. 11A provides example data charts illustrating reducing volatility of purchasing cost within embodiments of the DIA-PT. Periodic DIA purchases reduce volatility of cost to purchase income relative to a lump-sum purchase. Periodic DIA purchases address point-in-time income purchase risk. For example, for the individual participants having the same individual parameters with that in FIG. 8A, the DIA may analyze the historic cost volatility of replacing income for a plan participant (an investor). The systematic purchase strategy involves making monthly purchases using a deferred income annuity. Each payment is then discounted by inflation to the starting date, the sum of these real payments is the total real cost. The lump-sum purchase strategy involves making one purchase at retirement. That one lump sum cost is discounted to the starting date and logged as the total real cost. Due to the effect of deferral, the average cost across the time period using the deferred income annuity strategy is much lower than the lump sum. The average real cost using the DIA strategy is 8.5% lower than using the lump sum strategy. More importantly, the volatility of the year over year change is reduced with a DIA strategy. Over the entire period, the volatility of the year over year change for the lump sum strategy is 7.2%, and the volatility of the DIA strategy is 5.0%. In the post WWII period the volatility is reduced from 7.9% for the lump sum strategy to 3.5% for the DIA strategy.

In further implementations, creating a kind of personalized pension plan may be effected with either an in-plan structure or an out-of-plan structure. The DIA-PT may develop a program of converting defined contribution balances into defined benefit income must meet two preconditions: ongoing competitive annuity pricing and practical fiduciary responsibilities.

In order for participants (investors) to get the most out of their savings, insurance companies may compete to provide the highest level of income. Even among the most highly rated insurance carriers annuity income payout rates can vary substantially at any point in time. FIG. 11B shows how annuity payout rates have varied across carriers from the period December, 2006 through December 2012. At different points in time, carriers A, B, C, D, and E were the highest paying carrier for a joint-life annuity with a 10-year guarantee starting at age 70. Data plot in FIG. 11B may imply that all insurance carriers are created alike, even among similarly rated carriers. Nevertheless, among any group of insurance carriers deemed eligible for investment there may be differences in prices over time. As such, locking into a single carrier for purchases made over many years may be sub-optimal.

Within implementations, in an in-plan structure purchases of income products are made from within the qualified plan while the participant is actively working. Assets main remain inside the plan. For an in-plan structure to be viable, multiple insurance carriers may be offered in the plan and also be supported by the plan's record-keeper and administrator. Thus competitive pricing and protects both the participant and plan sponsor from getting locked into a single carrier. In another implementation, the plan sponsor may select the universe of annuities available to the participant, similar to how the universe of mutual funds is selected. In another implementation, the plan sponsor must be comfortable with the fiduciary responsibility of selecting the insurance carrier(s) and in selecting annuity products offered to participants. In another implementation, the plan sponsor may ensure that no accrued benefits from annuities purchased are lost when carriers are replaced or removed and no accrued benefits are lost when participants terminate from the plan. Further, the plan sponsor may ensure the portability of benefits such that assets may be transferred outside of the plan without loss. In one implementation, participants may either be provided with sufficient education and tools to select the annuity product and the investment amount at each point in time, as well as the education and tools to manage their remaining plan portfolio, or have access to an automated investment program.

In alternative implementations, in an out-of plan structure withdrawals are made from the qualified plan while the participant is actively working (termed an in-service withdrawal) with the proceeds being moved to a rollover IRA. Purchases of deferred income annuity products may then be made from those rollover IRA assets. For an out-of-plan structure to be viable, multiple insurance carriers should be offered on the same platform as the rollover IRA. As such, competitive pricing and protects the participant from getting locked into a single carrier. While participants may invest rollover IRA assets across multiple brokerage platforms or directly with insurance carriers, the level of effort is substantially greater, making it very likely participants would limit themselves to a single carrier. In one implementation, participants may be comfortable with the responsibility of selecting the insurance carrier(s) and in selecting annuity products, or have access to a service do this for them. In one implementation, participants may either be provided with sufficient education and tools to select the annuity product and the investment amount at each point in time, as well as the education and tools to manage their remaining plan portfolio, or have access to an automated investment program.

Within implementations, since purchased annuities are the property of the participant and accrued benefits cannot be forfeited by any employment action, the only other needed item is that the participant must receive regular reporting on the income purchased as well as on the remaining plan assets. Participants may either be provided with sufficient education and tools to select the annuity product and the investment amount at each point in time, as well as the education and tools to manage their remaining plan portfolio, or have access to an automated investment program.

Since purchased annuities are the property of the participant and accrued benefits cannot be forfeited by any employment action, the participant may receive regular reporting on the income purchased as well as on the remaining plan assets.

In further implementations, the DIA-PT may apply gender-specific pricing. In one implementation, annuity purchases made inside a qualified plan may provide the same value to both males and females, which may be accomplished by using unisex mortality tables. In an alternative implementation, the actuarial values may be equal across genders, rather than the payments. Annuities purchased outside of a retirement plan generally have gender specific pricing (each state has its own requirements), thereby creating a conflicting set of requirements between in-plan and out-of-plan annuities.

In one implementation, parity in annuity rate calculation rules between in-plan and out-of-plan annuities may be provided. DIA-PT may allow in-plan annuities to be priced using gender as an underwriting factor (as is the case with out-of-plan annuities), especially since gender is a generally accepted underwriting factor for insurance products utilizing mortality tables.

FIG. 11B provides hypothetical historical performance including an example data plot illustrating aspects of regulatory changes and the impact on viability of annuities within embodiments of the DIA-PT. The viability of in-plan annuities would be substantially increased if a clear and practical safe-harbor were developed that would address plan sponsor, administrator, and advisor fiduciary issues.

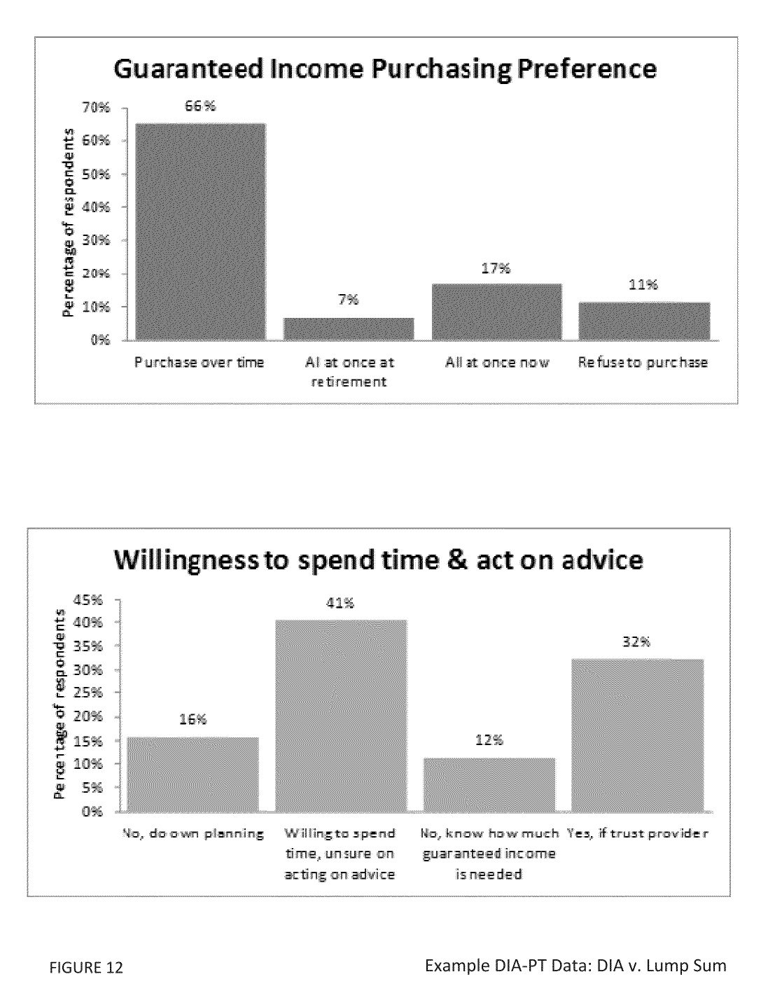

FIG. 12 provides exemplary data charts illustrating participants elections of DIA versus lump-sum payment within embodiments of the DIA-PT. For example, the DIA-PT may conduct behavioral research on willingness to purchase DIA, and on pre-retirees on their preferences for purchasing guaranteed income and measured their interest in deferred income annuities (DIAs), single premium income annuities (SPIAs), and systematic withdrawal plans (SWPs). For example, the DIA-PT may survey 400 active workers aged 50 to 59 (pre-retirees), making between $40,000 and $100,000 per year, and actively participating in a 401(k) or IRA.

In one implementation, in order to gauge interest in purchasing DIAs to create a DB-like benefit as compared to several alternative strategies for creating retirement income, DIA-PT may obtain survey responses to purchase a certain amount of income that is guaranteed to be available at retirement. In this scenario, respondents were told to imagine they are age 55, will retire in 10 years at age 65, and have a retirement income gap (essential expenses less Social Security and pensions) of 30% of pre-retirement salary. Respondents were given three (exclusive) investment choices with their assets: invest in mutual funds until retirement and purchase a SPIA until retirement; purchase units of DIA each month from now until retirement; invest in mutual funds from now until end-of-life, and take income through a SWP.

Then respondents were presented chances of success for each strategy as follows:

TABLE 6
DIA-PT Investment Survey Response

| | Chance of | | |
|---|---|---|---|
| | 30% Income | | |
| Investment Choice | Replacement | Upside | Downside |
| SPIA at retirement | 80% | 50% income | 20% income |
| | | replacement | replacement |
| DIA over time | 95% | 40% income | 25% income |
| | | replacement | replacement |
| SWP to end of | 70% | 5X salary to heirs | Exhaust assets 10 |
| retirement | | | years before EOL |

In one implementation, after obtaining respondent's preference, the DIA-PT may present respondents with two variations and asked to indicate their preference in each variation. The first variation may provide advantage to DIAs and the second may provide disadvantage to DIAs:

TABLE 7
DIA Investment Scenarios

| | Chance of | | |
|---|---|---|---|
| | 30% Income | | |
| | Replacement | Upside | Downside |
| Investment Choice | | | |
| Variation 1 | | | |
| SPIA at retirement | 75% | 50% income | 15% income |
| | | replacement | replacement |
| DIA over time | 98% | 50% income | 25% income |
| | | replacement | replacement |
| SWP to end of | 70% | 5X salary | Exhaust assets 15 |
| retirement | | to heirs | years before EOL |
| Investment Choice | | | |
| Variation 2 | | | |
| SPIA at retirement | 85% | 55% income | 25% income |
| | | replacement | replacement |
| DIA over time | 90% | 35% income | 25% income |
| | | replacement | replacement |
| SWP to end of | 80% | 5X salary | Exhaust assets 5 |
| retirement | | to heirs | years before EOL |
| | Investment | Investment | |
| | Choice | Choice | Investment Choice |
| Investment Choice | Base Case | DIA Enhanced | DIA Decreased |
| SPIA Preferred | 15% | 8% | 33% |
| DIA Preferred | 62% | 77% | 43% |
| SWP Preferred | 23% | 15% | 25% |

In one implementation, respondents may indicate their preference for the retirement security provided through periodic purchases of DIA even though both SPIA and SWP offered more upside potential. Even when the SWP strategy had just a 10% lower chance of success than the DIA strategy and meaningful upside potential, 43% of people still preferred the DIA strategy. While a single survey is certainly not definitive, results for this survey indicate strong investor interest among pre-retirees in purchasing DIA over time to replicate a DB-like benefit.

In another implementation, the DIA-PT may prompt respondents to assume that they needed additional income at retirement (on top of Social Security and pensions) and inquire how they would prefer to purchase this income. Respondents may have the choice of purchasing income over time, purchasing all income at retirement, purchasing all income now (a lump-sum DIA purchase), or refusing to purchase income. Almost ⅔ of respondents preferred to purchase income units over time, and interestingly enough, 17% would opt for purchasing income now with a lump-sum DIA.

In further implementations, the DIA-PT may investigate whether investors would spend 20 minutes to get advice on guaranteed income and their willingness to act on that advice. Seventy-three percent of respondents indicated they would spend the time, 32% indicated they would act on the advice if it came from a trusted provider, and the other 41% were unsure. Only 28% were not interested.

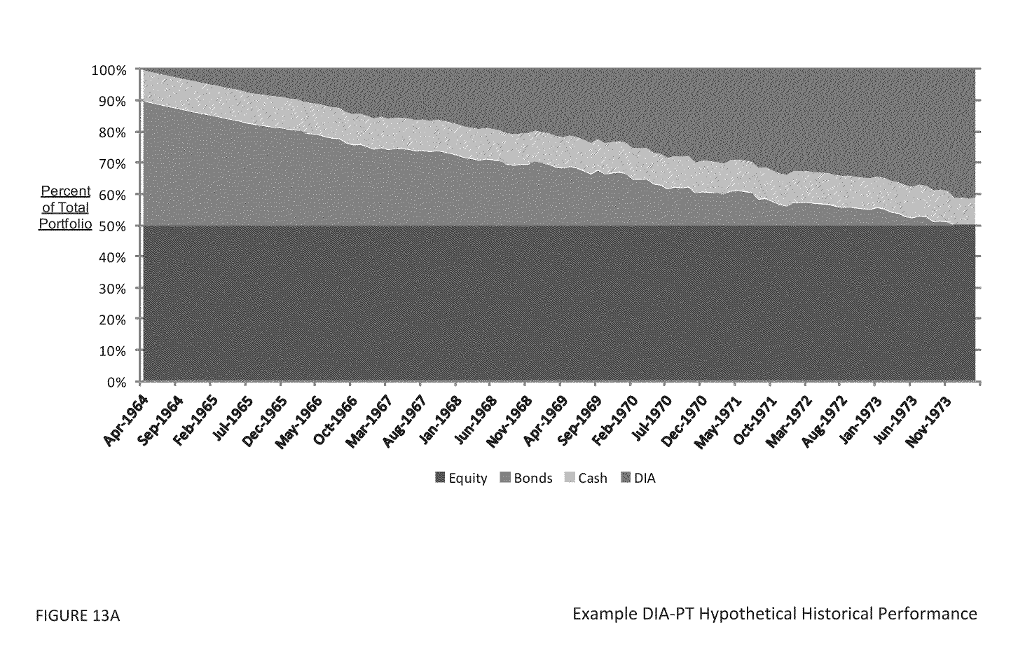

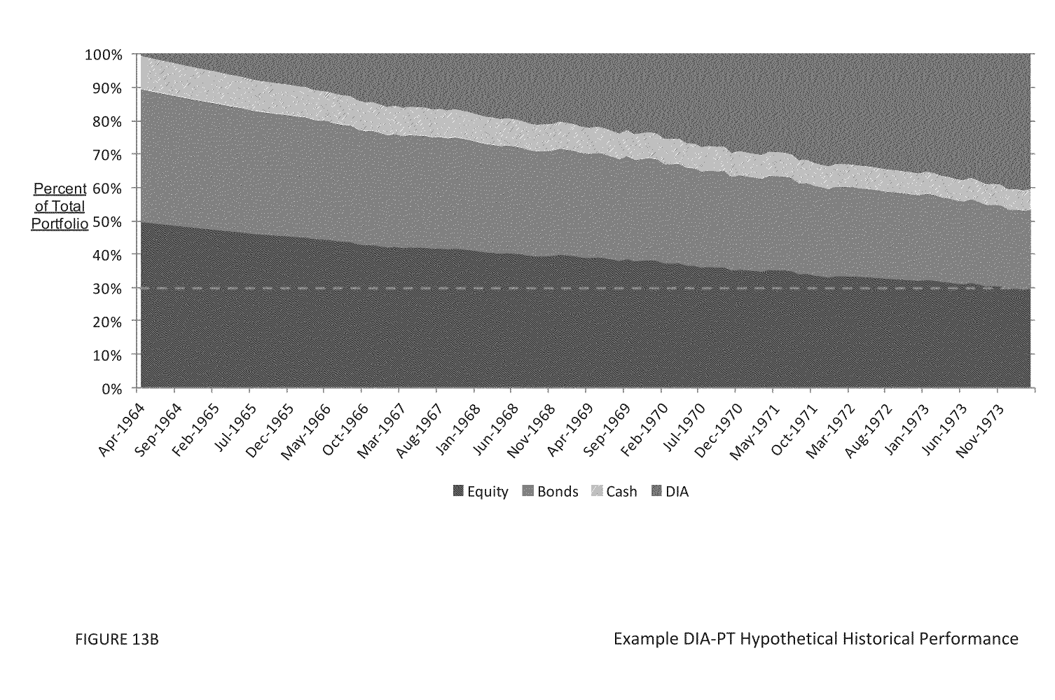

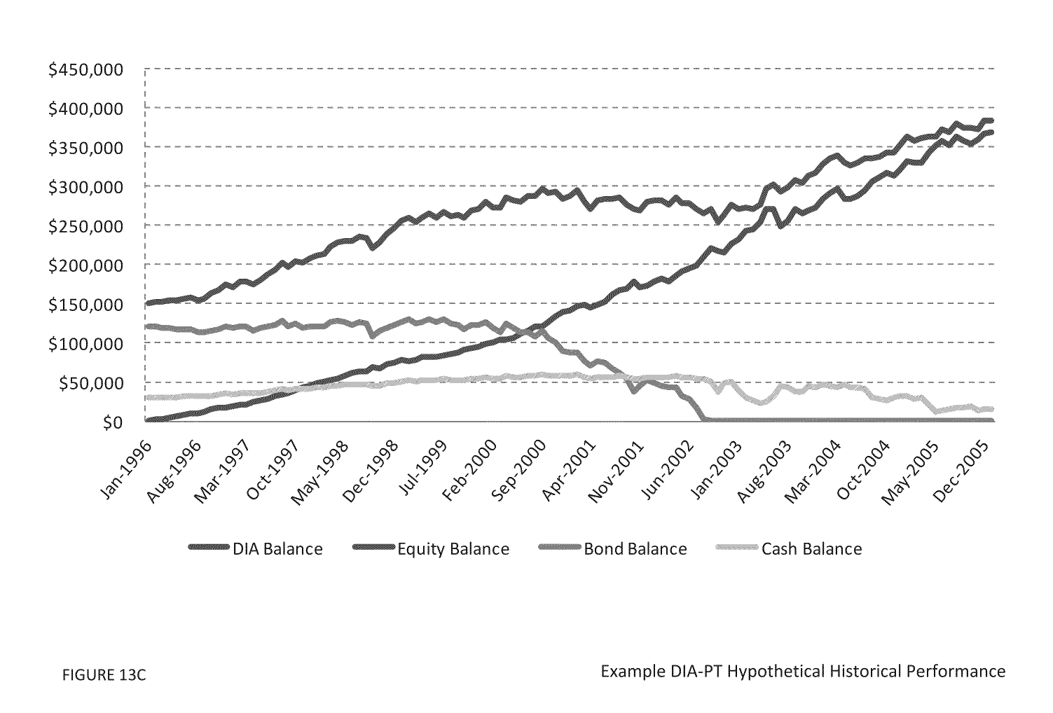

FIGS. 13A-13B provide hypothetical historical performance including an example data plot illustrating percent of total portfolio of each asset class within embodiments of the DIA-PT. As shown in FIG. 13A, the DIA-PT may maintain an asset allocation, e.g., of balanced 50% equity. Total portfolio equity may stay the same over DIA purchasing period; and DIA may be paid for from bonds and then cash as needed.

As shown in FIG. 13B, total portfolio equity declines from 50% to less than 30%; DIA is paid for from remaining traditional portfolio.

FIG. 13C provides hypothetical historical performance including an example data plot illustrating value by asset class over time within embodiments of the DIA-PT. For example, the asset allocation: may comprise a balanced 50% equity of total portfolio during a time period of 10 years. In one implementation, the DIA-PT may purchase DIA each month for ½% of remaining portfolio.

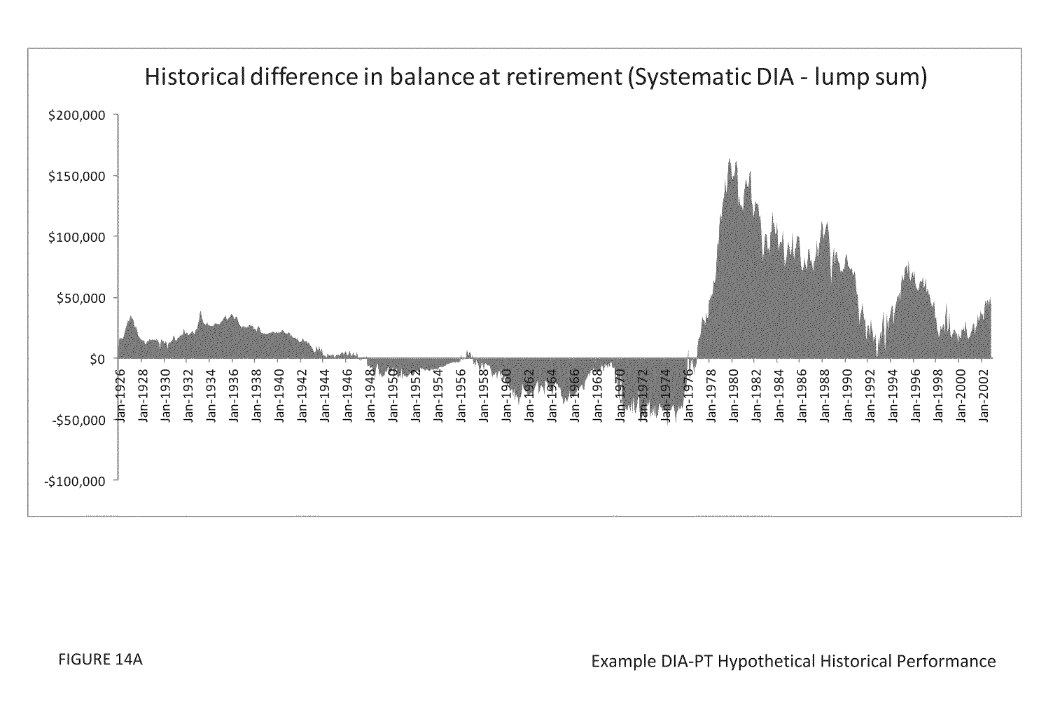

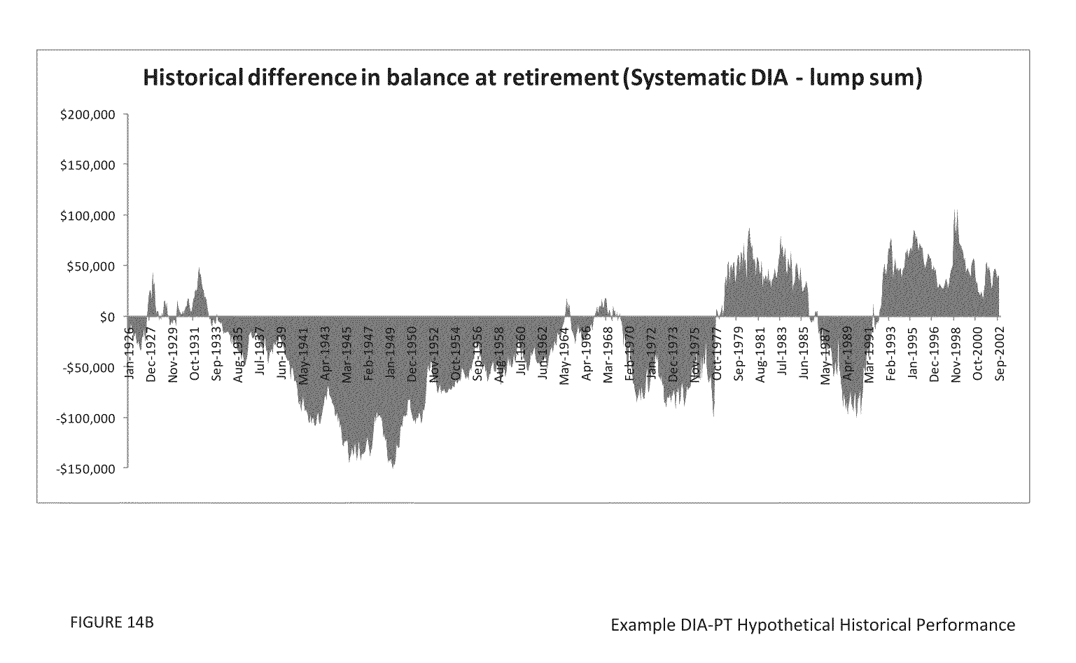

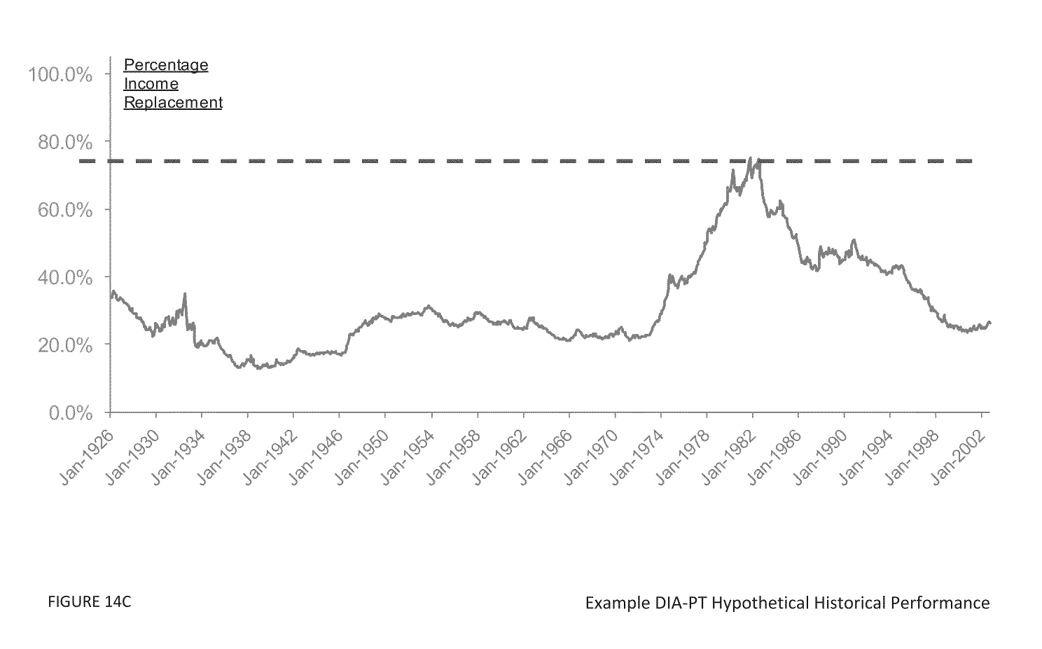

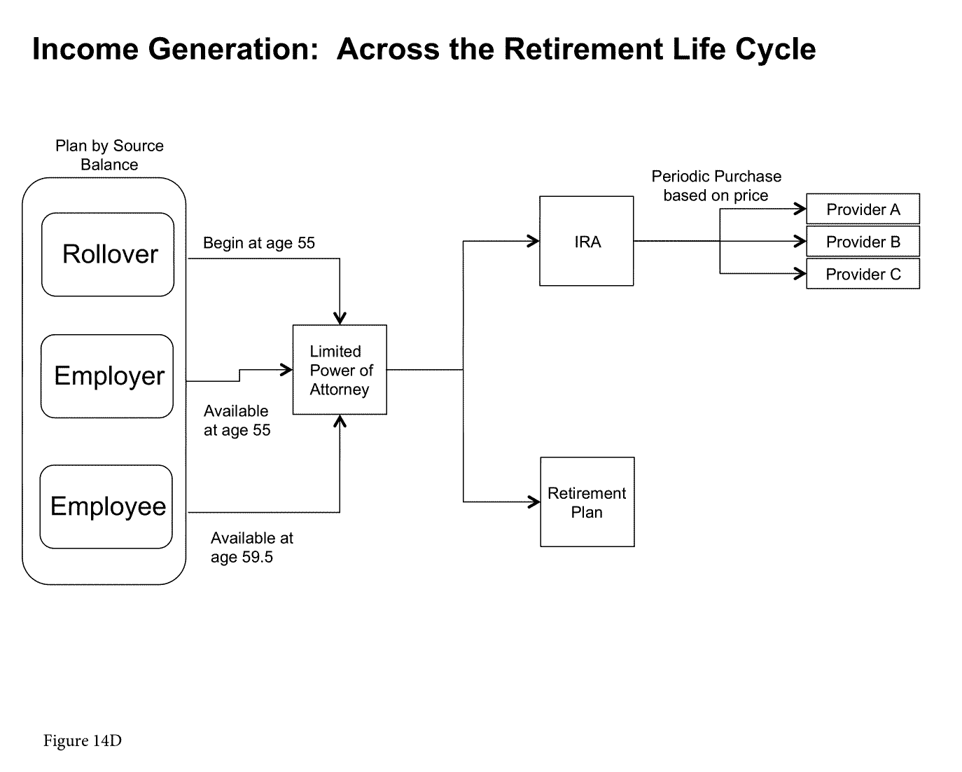

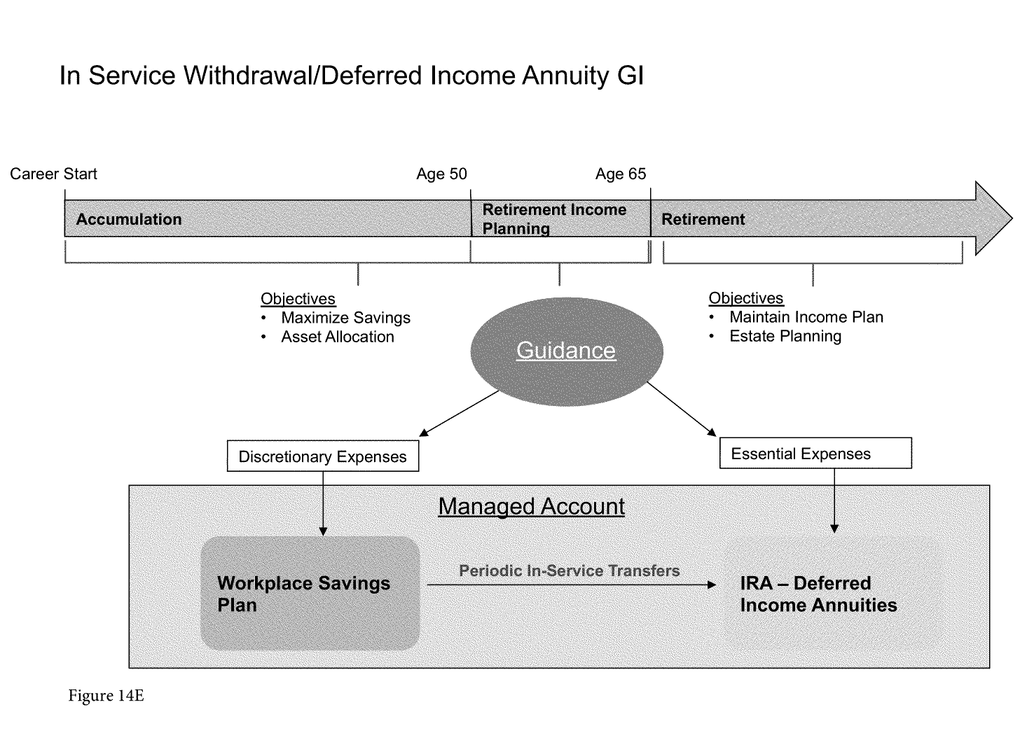

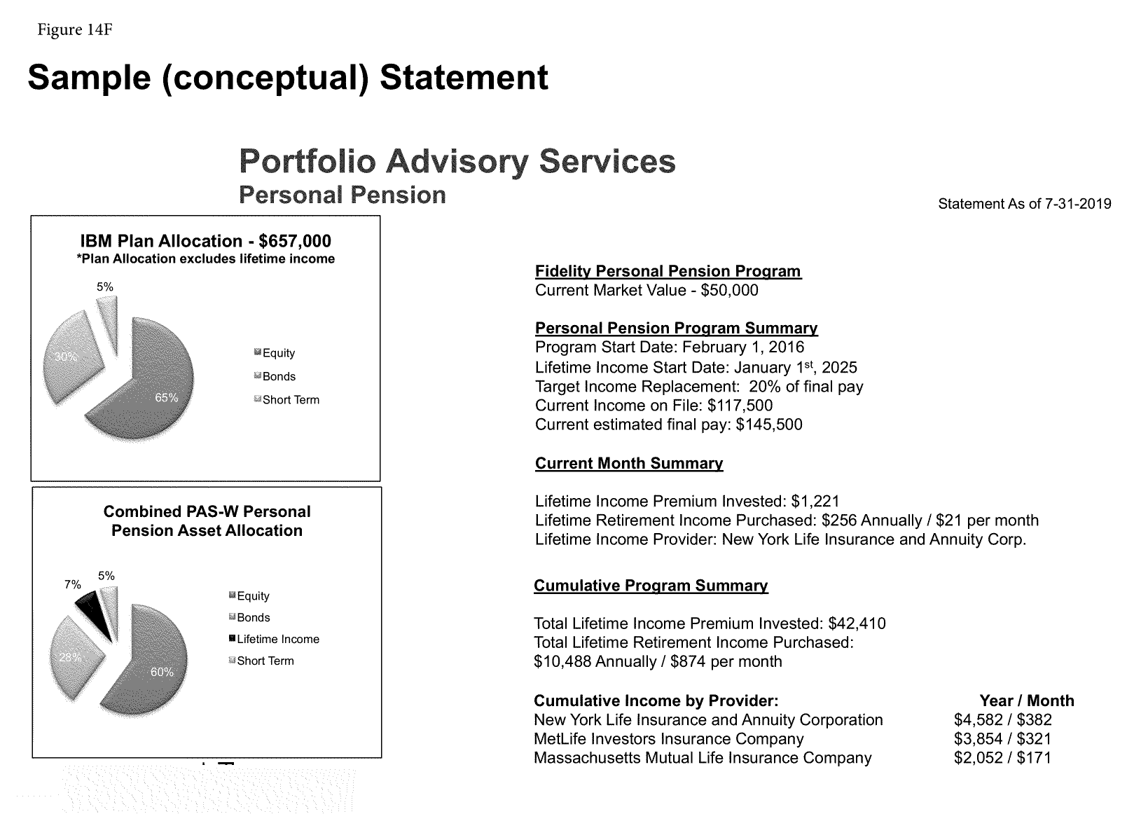

FIGS. 14A-14C show hypothetical historical performance including an example data plot illustrating DIA strategy advantage by wealth at retirement within embodiments of the DIA-PT. For example, the asset allocation may comprise a balanced 50% equity of total portfolio, constant net equity, e.g., the participant may start at age 55, and a retirement age of 65; the DIA-PT may purchase DIA each month ½% of remaining portfolio; and significant variation in historical outcomes but a net advantage for DIA strategy.

As further shown in FIG. 14B, if the DIA-PT purchases DIA each month: 1/2 of remaining portfolio; overall, the reduction in equity exposure may not be advantageous.

FIG. 14C shows hypothetical historical performance including an example data plot illustrating value by asset class over time income replacement by DIA/matching lump sum within embodiments of the DIA-PT. For example, the DIA-PT may maintain a balanced asset allocation; DIA may purchase from age 55 to 6 every month with ½% of remaining portfolio. DIA/matching lump-sum purchase may have replaced an average of 31% of pre-retirement income, with a high and low of 75% and 13%.

In further implementations, the DIA-PT may allow withdrawals from DIA purchase, and allow participants access to account balances prior to normal retirement age. In one implementation, the DIA-PT may plan design feature based on money types and age. Assets may be rolled over to purchase deferred income annuities in an IRA.

For example, Table 8 illustrates ages at which in-service withdrawals can be allowed by money type:

TABLE 8
Roll Over Example

| | In-Plan | Elective | | Employer | Profit | Money | |
|---|---|---|---|---|---|---|---|
| Age | Rollover | Deferral | After Tax | Match | Sharing | Purchase | Cash Balance |
| 55 | Y | N | Y | Y | Y | N | N |
| 59.5 | Y | Y | Y | Y | Y | N | N |
| Normal | Y | Y | Y | Y | Y | Y | Y |
| Retirement | | | | | | | |

In further implementations, the DIA-PT may allow diversification of participant's portfolio. For example, DIA-PT may automatically select a carrier with the highest payout rate/lowest cost per dollar of future income among eligible carriers on the platform. For example, if there are five carriers on the platform with rates varying between $136.93 and $149.86 for an income stream of $1 per month for life starting in 10 years for a 55 year-old man today, the carrier with the lowest price of $136.93 would generally be selected. An eligible carrier may be an insurance company that has been vetted for credit quality, claims paying ability, integrity, and other factors.

In one implementation, the purchased guaranteed income from an insurance carrier may be subject to the claims paying ability of the carrier. If the insurance carrier is unable to pay in full any annuity contract, state guarantee funds may help pay the annuity, up to state-dependent limits. State guarantees are expressed as a maximum liability for the present value of an annuity contract. Example state guarantee amount is $250,000, but may range from $100,000 to $500,000. The guarantee coverage may be the total guarantee provided to an individual policyholder and may not be increased by spreading the investment across multiple contracts.

As part of the enrollment process for the DIA automated purchasing service, the participant may be asked whether he/she wants to diversify insurance company risk if the annuity value for any single carrier gets “very high”. The participant may be instructed that the guarantee is subject to the claims paying ability of the individual carrier. The recommended threshold for diversification is the state guarantee amount for state of residence of the participant. The recommended threshold amount is simply presented as a prudent threshold developed from years of financial planning experience. No reference to state guarantees or to state guarantee associations may be permitted, so the participant may not be provided such information.

In one implementation, the participant may agree to the DIA-PT recommended diversification threshold amount, request a different amount, or opt out of insurance carrier diversification altogether. The DIA-PT may impose minimum a maximum limits on the diversification threshold amount. If insurance carrier diversification is selected then the DIA-PT may determine the current market values of annuities purchased for each carrier for the participant; determine the cost to purchase the needed increment of income, e.g. $23 per month starting in 9 years 4 months, with the lowest priced carrier; if the cost of the present income purchase plus the market value of the existing annuity income from the applicable carrier is less than or equal to the diversification threshold amount, the full purchase may be effected through such lowest priced carrier.

In another implementation, if the present income purchase plus the market value of the existing annuity income from the applicable carrier is greater than the diversification threshold amount, the income purchase may be effected through such lowest priced carrier up to the diversification threshold amount (no income would be purchased if the limit is already reached), and the remainder of the income should be purchased from the next lowest priced carrier. If purchases from this carrier are limited as well then the process continues with each successive insurance carrier.

If the present income purchase cannot be fully executed, having exhausted all available insurance carriers, then either the diversification threshold amount must be raised or the automated purchasing program may be terminated.

In a further implementation, participants may change the diversification threshold amount in the future and opt-in or opt-out of insurance carrier diversification in the future.

### DIA-PT Controller

FIGURE Error! Reference source not found. shows a block diagram illustrating embodiments of a DIA-PT controller. In this embodiment, the DIA-PT controller Error! Reference source not found.01 may serve to aggregate, process, store, search, serve, identify, instruct, generate, match, and/or facilitate interactions with a computer through investment information technology management technologies, and/or other related data.

Typically, users, which may be people and/or other systems, may engage information technology systems (e.g., computers) to facilitate information processing. In turn, computers employ processors to process information; such processors Error! Reference source not found.03 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory Error! Reference source not found.29 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the DIA-PT controller Error! Reference source not found.01 may be connected to and/or communicate with entities such as, but not limited to: one or more users from user input devices Error! Reference source not found.11; peripheral devices Error! Reference source not found.12; an optional cryptographic processor device Error! Reference source not found.28; and/or a communications network Error! Reference source not found.13.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The DIA-PT controller Error! Reference source not found.01 may be based on computer systems that may comprise, but are not limited to, components such as: a computer systemization Error! Reference source not found.02 connected to memory Error! Reference source not found.29.

### Computer Systemization

A computer systemization Error! Reference source not found.02 may comprise a clock Error! Reference source not found.30, central processing unit (“CPU(s)” and/or “processor(s)” (these terms are used interchangeable throughout the disclosure unless noted to the contrary)) Error! Reference source not found.03, a memory Error! Reference source not found.29 (e.g., a read only memory (ROM) Error! Reference source not found.06, a random access memory (RAM) Error! Reference source not found.05, etc.), and/or an interface bus Error! Reference source not found.07, and most frequently, although not necessarily, are all interconnected and/or communicating through a system bus Error! Reference source not found.04 on one or more (mother)board(s) Error! Reference source not found.02 having conductive and/or otherwise transportive circuit pathways through which instructions (e.g., binary encoded signals) may travel to effectuate communications, operations, storage, etc. The computer systemization may be connected to a power source Error! Reference source not found.86; e.g., optionally the power source may be internal. Optionally, a cryptographic processor Error! Reference source not found.26 may be connected to the system bus. In another embodiment, the cryptographic processor and/or transceivers (e.g., ICs) Error! Reference source not found.74 may be connected as either internal and/or external peripheral devices Error! Reference source not found.12 via the interface bus I/O Error! Reference source not found.08 (not pictured) and/or directly via the interface bus Error! Reference source not found.07. In turn, the transceivers may be connected to antenna(s) Error! Reference source not found.75, thereby effectuating wireless transmission and reception of various communication and/or sensor protocols; for example the antenna(s) may connect to various transceiver chipsets (depending on deployment needs), including: Broadcom BCM4329FKUBG transceiver chip (e.g., providing 802.11n, Bluetooth 2.1+EDR, FM, etc.); a Broadcom BCM4750IUB8 receiver chip (e.g., GPS); a Broadcom BCM4335 transceiver chip (e.g., providing 2G, 3G, and 4G long-term evolution (LTE) cellular communications; 802.11ac, Bluetooth 4.0 low energy (LE) (e.g., beacon features)); an Infineon Technologies X-Gold 618-PMB9800 transceiver chip (e.g., providing 2G/3G HSDPA/HSUPA communications); a MediaTek MT6620 transceiver chip (e.g., providing 802.11a/b/g/n, Bluetooth 4.0 LE, FM, global positioning system (GPS) (thereby allowing DIA-PT controller to determine its location); a Texas Instruments WiLink WL1283 transceiver chip (e.g., providing 802.11n, Bluetooth 3.0, FM, GPS); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large mainframe computers, down to mini computers, servers, desktop computers, laptops, netbooks, tablets (e.g., iPads, Android and Windows tablets, etc.), mobile smartphones (e.g., iPhones, Android and Windows phones, etc.), wearable devise (e.g., watches, glasses, goggles (e.g., Google Glass), etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory Error! Reference source not found.29 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; Apple's A series of processors (e.g., A5, A6, A7, etc.); ARM's application, embedded and secure processors; IBM and/or Motorola's DragonBall and PowerPC; IBM's and Sony's Cell processor; Intel's 80X86 series (e.g., 80386, 80486), Pentium, Celeron, Core (2) Duo, i series (e.g., i3, i5, i7, etc.), Itanium, Xeon, and/or XScale; Motorola's 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the DIA-PT controller and beyond through various interfaces. Should processing requirements dictate a greater amount speed and/or capacity, distributed processors (e.g., Distributed DIA-PT), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the DIA-PT may be achieved by implementing a microcontroller such as CAST's R8051XC2 microcontroller; Intel's MCS 51 (i.e., 8051 microcontroller); and/or the like. Also, to implement certain features of the DIA-PT, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the DIA-PT component collection (distributed or otherwise) and/or features may be implemented via the microprocessor and/or via embedded components; e.g., via ASIC, coprocessor, DSP, FPGA, and/or the like. Alternately, some implementations of the DIA-PT may be implemented with embedded components that are configured and used to achieve a variety of features or signal processing.

Depending on the particular implementation, the embedded components may include software solutions, hardware solutions, and/or some combination of both hardware/software solutions. For example, DIA-PT features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the DIA-PT features. A hierarchy of programmable interconnects allow logic blocks to be interconnected as needed by the DIA-PT system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the DIA-PT may be developed on regular FPGAs and then migrated into a fixed version that more resembles ASIC implementations. Alternate or coordinating implementations may migrate DIA-PT controller features to a final ASIC instead of or in addition to FPGAs. Depending on the implementation all of the aforementioned embedded components and microprocessors may be considered the “CPU” and/or “processor” for the DIA-PT.

### Power Source

The power source Error! Reference source not found.86 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell Error! Reference source not found.86 is connected to at least one of the interconnected subsequent components of the DIA-PT thereby providing an electric current to all subsequent components. In one example, the power source Error! Reference source not found.86 is connected to the system bus component Error! Reference source not found.04. In an alternative embodiment, an outside power source Error! Reference source not found.86 is provided through a connection across the I/O Error! Reference source not found.08 interface. For example, a USB and/or IEEE 1394 connection carries both data and power across the connection and is therefore a suitable source of power.

### Interface Adapters

Interface bus(ses) Error! Reference source not found.07 may accept, connect, and/or communicate to a number of interface adapters, conventionally although not necessarily in the form of adapter cards, such as but not limited to: input output interfaces (I/O) Error! Reference source not found.08, storage interfaces Error! Reference source not found.09, network interfaces Error! Reference source not found.10, and/or the like. Optionally, cryptographic processor interfaces Error! Reference source not found.27 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X), PCI Express, Personal Computer Memory Card International Association (PCMCIA), and/or the like.

Storage interfaces Error! Reference source not found.09 may accept, communicate, and/or connect to a number of storage devices such as, but not limited to: storage devices Error! Reference source not found.14, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces Error! Reference source not found.10 may accept, communicate, and/or connect to a communications network Error! Reference source not found.13. Through a communications network Error! Reference source not found.13, the DIA-PT controller is accessible through remote clients Error! Reference source not found.33b (e.g., computers with web browsers) by users Error! Reference source not found.33a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., Distributed DIA-PT), architectures may similarly be employed to pool, load balance, and/or otherwise decrease/increase the communicative bandwidth required by the DIA-PT controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces Error! Reference source not found.10 may be used to engage with various communications network types Error! Reference source not found.13. For example, multiple network interfaces may be employed to allow for the communication over broadcast, multicast, and/or unicast networks.

Input Output interfaces (I/O) Error! Reference source not found.08 may accept, communicate, and/or connect to user input devices Error! Reference source not found.11, peripheral devices Error! Reference source not found.12, cryptographic processor devices Error! Reference source not found.28, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices Error! Reference source not found.11 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices Error! Reference source not found.12 may be connected and/or communicate to I/O and/or other facilities of the like such as network interfaces, storage interfaces, directly to the interface bus, system bus, the CPU, and/or the like. Peripheral devices may be external, internal and/or part of the DIA-PT controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the DIA-PT controller may be embodied as an embedded, dedicated, and/or monitor-less (i.e., headless) device, wherein access would be provided over a network interface connection.

Cryptographic units such as, but not limited to, microcontrollers, processors Error! Reference source not found.26, interfaces Error! Reference source not found.27, and/or devices Error! Reference source not found.28 may be attached, and/or communicate with the DIA-PT controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory Error! Reference source not found.29. However, memory is a fungible technology and resource, thus, any number of memory embodiments may be employed in lieu of or in concert with one another. It is to be understood that the DIA-PT controller and/or a computer systemization may employ various forms of memory Error! Reference source not found.29. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory Error! Reference source not found.29 will include ROM Error! Reference source not found.06, RANI Error! Reference source not found.05, and a storage device Error! Reference source not found.14. A storage device Error! Reference source not found.14 may be any conventional computer system storage. Storage devices may include: an array of devices (e.g., Redundant Array of Independent Disks (RAID)); a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; solid state memory devices (USB memory, solid state drives (SSD), etc.); other processor-readable storage mediums; and/or other devices of the like. Thus, a computer systemization generally requires and makes use of memory.

### Component Collection

The memory Error! Reference source not found.29 may contain a collection of program and/or database components and/or data such as, but not limited to: operating system component(s) Error! Reference source not found.15 (operating system); information server component(s) Error! Reference source not found.16 (information server); user interface component(s) Error! Reference source not found.17 (user interface); Web browser component(s) Error! Reference source not found.18 (Web browser); database(s) Error! Reference source not found.19; mail server component(s) Error! Reference source not found.21; mail client component(s) Error! Reference source not found.22; cryptographic server component(s) Error! Reference source not found.20 (cryptographic server); the DIA-PT component(s) Error! Reference source not found.35; and/or the like (i.e., collectively a component collection). These components may be stored and accessed from the storage devices and/or from storage devices accessible through an interface bus. Although non-conventional program components such as those in the component collection, typically, are stored in a local storage device Error! Reference source not found.14, they may also be loaded and/or stored in memory such as: peripheral devices, RAM, remote storage facilities through a communications network, ROM, various forms of memory, and/or the like.

### Operating System

The operating system component Error! Reference source not found.15 is an executable program component facilitating the operation of the DIA-PT controller. Typically, the operating system facilitates access of I/O, network interfaces, peripheral devices, storage devices, and/or the like. The operating system may be a highly fault tolerant, scalable, and secure system such as: Apple's Macintosh OS X (Server); AT&T Plan 9; Be OS; Google's Chrome; Microsoft's Windows 7/8; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/Mobile/NT/Vista/XP (Server), Palm OS, and/or the like. Additionally, for robust mobile deployment applications, mobile operating systems may be used, such as: Apple's iOS; China Operating System COS; Google's Android; Microsoft Windows RT/Phone; Palm's WebOS; Samsung/Intel's Tizen; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the DIA-PT controller to communicate with other entities through a communications network Error! Reference source not found.13. Various communication protocols may be used by the DIA-PT controller as a subcarrier transport mechanism for interaction, such as, but not limited to: multicast, TCP/IP, UDP, unicast, and/or the like.

### Information Server

An information server component Error! Reference source not found.16 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or.NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the DIA-PT controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the DIA-PT database Error! Reference source not found.19, operating systems, other program components, user interfaces, Web browsers, and/or the like.

Access to the DIA-PT database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the DIA-PT. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the DIA-PT as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple's iOS, Macintosh Operating System's Aqua; IBM's OS/2; Google's Chrome; Microsoft's Windows varied UIs 2000/2003/3.1/95/98/CE/Millenium/Mobile/NT/Vista/XP (Server) (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component Error! Reference source not found.17 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component Error! Reference source not found.18 is a stored program component that is executed by a CPU. The Web browser may be a conventional hypertext viewing application such as Apple's (mobile) Safari, Google's Chrome, Microsoft Internet Explorer, Mozilla's Firefox, Netscape Navigator, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the DIA-PT enabled nodes. The combined application may be nugatory on systems employing standard Web browsers.

### Mail Server

A mail server component Error! Reference source not found.21 is a stored program component that is executed by a CPU Error! Reference source not found.03. The mail server may be a conventional Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the DIA-PT.

Access to the DIA-PT mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component Error! Reference source not found.22 is a stored program component that is executed by a CPU Error! Reference source not found.03. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component Error! Reference source not found.20 is a stored program component that is executed by a CPU Error! Reference source not found.03, cryptographic processor Error! Reference source not found.26, cryptographic processor interface Error! Reference source not found.27, cryptographic processor device Error! Reference source not found.28, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the DIA-PT may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the DIA-PT component to engage in secure transactions if so desired. The cryptographic component facilitates the secure accessing of resources on the DIA-PT and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The DIA-PT Database

The DIA-PT database component Error! Reference source not found.19 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the DIA-PT database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the DIA-PT database is implemented as a data-structure, the use of the DIA-PT database Error! Reference source not found.19 may be integrated into another component such as the DIA-PT component Error! Reference source not found.35. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component Error! Reference source not found.19 includes several tables Error! Reference source not found.19a-z:

An accounts table Error! Reference source not found.19a includes fields such as, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, and/or the like;

A users table Error! Reference source not found.19b includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a DIA-PT);

An devices table Error! Reference source not found.19c includes fields such as, but not limited to: deviceID, accountID, assetIDs, paymentIDs, deviceType, deviceName, deviceModel, deviceVersion, deviceSerialNo, deviceIPaddress, deviceMACaddress, device_ECID, deviceUUID, deviceLocation, deviceCertificate, deviceOS, appIDs, deviceResources, deviceSession, authKey, deviceSecureKey, walletAppinstalledFlag, deviceAccessPrivileges, device Preferences, deviceRestrictions, and/or the like;

An apps table Error! Reference source not found.19d includes fields such as, but not limited to: appID, appName, appType, appDependencies, accountID, deviceIDs, transactionID, userID, appStoreAuthKey, appStoreAccountID, appStoreIPaddress, appStoreURLaccessCode, appStorePortNo, appAccessPrivileges, appPreferences, appRestrictions and/or the like;

An assets table Error! Reference source not found.19e includes fields such as, but not limited to: assetID, distributorAccountID, distributorPaymentID, distributorOnwerID, assetType, assetName, assetCode, assetQuantity, assetCost, assetPrice, assetManufactuer, assetModelNo, assetSerialNo, assetLocation, assetAddress, assetState, assetZIPcode, assetState, assetCountry, assetEmail, assetIPaddress, assetURLaccessCode, assetOwnerAccountID, subscriptionIDs, assetAuthroizationCode, assetAccessPrivileges, assetPreferences, assetRestrictions, and/or the like;

A payments table Error! Reference source not found.19f includes fields such as, but not limited to: paymentID, accountID, userID, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentIPaddress, paymentURLaccessCode, paymentPortNo, paymentAccessPrivileges, paymentPreferences, payementRestrictions, and/or the like;

An transactions table Error! Reference source not found.19g includes fields such as, but not limited to: transactionID, accountID, assetIDs, deviceIDs, paymentIDs, transactionIDs, userID, transactionType, transactionDate, transactionAmount, transactionQuantity, transactionDetails, transactionNo, transactionAccessPrivileges, transactionPreferences, transactionRestrictions, and/or the like;

A History Data table Error! Reference source not found.19h may include fields such as, but not limited to: data_provider_id, data_provider_name, data_type, data_time_range, data_update_timestamp, data_format, data_file_type, data_file_name, data_plot, and/or the like.

A Data Provider table Error! Reference source not found.19i may include fields such as, but not limited to: provide_id, provider_name, provider_type, provider_data_type, provider_data_type, provider_server_ip, provider_server_id, provider_url, and/or the like.

A Pricing table Error! Reference source not found.19j may include fields such as, but not limited to: PricingID, DIA-id, DIA_name, DIA_curve, DIA_years, DIA_terms, pricing_curve, pricing_id, pricing_timestamp, pricing_term, pricing_time_frame, pricing_DIA_amount, and/or the like.

A Portfolio table 1519k may include fields such as, but not limited to portfolio_id, assetID, transactionID, portfolio_name, portfolio_user_id, portfolio_start_date, portfolio_end_date, portfolio_alert, portfolio_rebalance, portfolio_allocation (equity_percent, fixed-income_percent, short_term_percent, DIA-percent), portfolio_return, and/or the like.

A Performance table 1519l may include fields such as, but not limited to: user-id, portfolio-id, DIA-id, start_age, start_year, retirement_age, portfolio-return, annuity_payout, expected-payout, expected-expense, GDP, unemployment, inflation and/or the like.

A Record table 1519m may include fields such as, but not limited to: user-id, portfolio-id, DIA-id, purchase-date, purchase-amount, income-percent, portfolio-allocation, individual-contribution, sponsor-contribution, and/or the like.

A DIA table 1519n may include fields such as, but not limited to: DIA_ID, user-id, portfolio-id, DIA-id, start_age, start_year, retirement_age, expected-payout, expected-expense, income-replacement, income-amount, DIA-price, and/or the like.

A market_data table Error! Reference source not found.19z includes fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi.

In one embodiment, the DIA-PT database may interact with other database systems. For example, employing a distributed database system, queries and data access by search DIA-PT component may treat the combination of the DIA-PT database, an integrated data security layer database as a single database entity.

In one embodiment, user programs may contain various user interface primitives, which may serve to update the DIA-PT. Also, various accounts may require custom database tables depending upon the environments and the types of clients the DIA-PT may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components Error! Reference source not found.19a-z. The DIA-PT may be configured to keep track of various settings, inputs, and parameters via database controllers.

The DIA-PT database may communicate to and/or with other components in a component collection, including itself, and/or facilities of the like. Most frequently, the DIA-PT database communicates with the DIA-PT component, other program components, and/or the like. The database may contain, retain, and provide information regarding other nodes and data.

### The DIA-PTs

The DIA-PT component Error! Reference source not found.35 is a stored program component that is executed by a CPU. In one embodiment, the DIA-PT component incorporates any and/or all combinations of the aspects of the DIA-PT that was discussed in the previous figures. As such, the DIA-PT affects accessing, obtaining and the provision of information, services, transactions, and/or the like across various communications networks. The features and embodiments of the DIA-PT discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the DIA-PT's features and facilities, and in many cases reduce the costs, energy consumption/requirements, and extend the life of DIA-PT's underlying infrastructure; this has the added benefit of making the DIA-PT more reliable. Similarly, many of the features and mechanisms are designed to be easier for users to use and access, thereby broadening the audience that may enjoy/employ and exploit the feature sets of the DIA-PT; such ease of use also helps to increase the reliability of the DIA-PT. In addition, the feature sets include heightened security as noted via the Cryptographic components Error! Reference source not found.20, Error! Reference source not found.26, Error! Reference source not found.28 and throughout, making access to the features and data more reliable and secure

The DIA-PT transforms individual profile input (e.g., see 206 in FIG. 2, etc.) and user annuity expectation input (e.g., see 207 in FIG. 2, etc.) inputs, via DIA-PT components (e.g., Historical Data Collector 1542, Individual Parameter Collector 1543, Income Replacement Assessment 1544, DIA Purchasing 1545, DIA Portfolio rebalancing 1546, DIA pricing 1547,), into DIA purchasing records (e.g., see 212 in FIG. 2, etc.) outputs.

The DIA-PT component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the DIA-PT server employs a cryptographic server to encrypt and decrypt communications. The DIA-PT component may communicate to and/or with other components in a component collection, including itself, and/or facilities of the like. Most frequently, the DIA-PT component communicates with the DIA-PT database, operating systems, other program components, and/or the like. The DIA-PT may contain, communicate, generate, obtain, and/or provide program component, system, user, and/or data communications, requests, and/or responses.

### Distributed DIA-PTs

The structure and/or operation of any of the DIA-PT node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the DIA-PT controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the DIA-PT controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(′Content-Type: text/plain′);
// set ip address and port to listen to for incoming data
$address = ′192.168.0.100′;
$port = 255;
// create a server-side SSL socket, listen for/accept incoming
communication
$sock = socket_create(AF_INET, SOCK_STREAM, 0);
socket_bind($sock, $address, $port) or die(′Could not bind to address′);
socket_listen($sock);
$client = socket_accept($sock);
// read input data from client device in 1024 byte blocks until end
of message
do {
  $input = ″″;
  $input = socket_read($client, 1024);
  $data .= $input;
} while($input != ″″);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(″INSERT INTO UserTable (transmission)
VALUES ($data)″); // add data to UserTable table in a CLIENT database
mysql_close(″CLIENT_DB.SQL″); // close connection to database
?>
```

Also, the following resources may be used to provide example embodiments regarding SOAP parser implementation:
http://www.xay.com/perl/site/lib/SOAP/Parser.html
http://publib.boulder.ibm.com/infocenter/tivihelp/v2r1/index.jsp?topic=/com.ibm. IBMDI.doc/referenceguide295.htm
   and other parser implementations:
http://publib.boulder.ibm.com/infocenter/tivihelp/v2r1/index.jsp?topic=/com.ibm. IBMDI.doc/referenceguide259.htm
   all of which are hereby expressly incorporated by reference.

In order to address various issues and advance the art, the entirety of this application for Deferred Income Annuity Structure Planning Tool Apparatuses, Methods and Systems (including the Cover Page, Tide, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the FIGS. and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached,” “affixed,” “connected,” “coupled,” “interconnected,” and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a DIA-PT individual and/or enterprise user, database configuration and/or relational model, data type, data transmission and/or network framework, syntax structure, and/or the like, various embodiments of the DIA-PT, may be implemented that enable a great deal of flexibility and customization. For example, aspects of the DIA-PT may be adapted for inventory asset management and operations management. While various embodiments and discussions of the DIA-PT have included investment information technology management, however, it is to be understood that the embodiments described herein may be readily configured and/or customized for a wide variety of other applications and/or implementations.

What is claimed is:

1. A deferred income annuity generation and management matching apparatus, comprising:
a memory;
a component collection in the memory, including:
a historical data collector component;
an individual parameter collector component;
an income replacement assessment component;
a deferred income annuity purchasing component;
a deferred income annuity portfolio rebalancing component; and
a deferred income annuity pricing component;
a processor disposed in communication with the memory, and configured to issue a plurality of processing instructions from the component collection stored in the memory,
wherein the processor issues instructions from the historical data collector component, stored in the memory, to:
receive individual profile inputs;
wherein the processor issues instructions from the individual parameter collector component, stored in the memory, to:
receive user expectation inputs from a user;
wherein the processor issues instructions from the income replacement assessment, deferred income purchasing and deferred income annuity pricing components, stored in the memory, to:
determine a target annuity pay-out amount based on the obtained individual parameters;
determine a deferred income annuity purchasing plan based on the obtained individual parameters and the determined target annuity pay-out amount;
determine a purchasing price for the deferred income annuity purchasing plan; and
periodically execute a purchase transaction of deferred income annuity instrument based on the determined deferred income annuity purchasing plan and the determined purchasing price;
wherein the processor issues instructions from the deferred income annuity portfolio rebalancing component, stored in the memory, to:
rebalance an asset allocation of the participant's portfolio upon the purchase transaction of deferred income annuity instrument; and
wherein the processor issues instructions from the component collection, stored in the memory, to:
obtain an indication that the participant has reached a retirement age; and
generate a pay-out amount to the participant based on the deferred income annuity instrument.

2. The apparatus of claim 1, wherein the processor issues instructions from the component collection, stored in the memory, to:
obtain historical and current economic data from a data provider.

3. The apparatus of claim 2, wherein the processor issues instructions from the component collection, stored in the memory, to:
analyze the historical and current economic data including any of: corporate yield data, treasury yields data, inflation data, and market data.

4. The apparatus of claim 3, wherein the processor issues instructions from the component collection, stored in the memory, to:
create a hypothetical deferred income annuity purchasing portfolio to assess performance.

5. The apparatus of claim 1, wherein the individual profile inputs comprise any of: the participant's age, the participant's gender, the participant's family status, the participant's employment industry, the participant's income and the participant's educational background.

6. The apparatus of claim 1, wherein the individual profile inputs further comprise any of: the participant's expense data, the participant's housing condition, and the participant's tax status.

7. The apparatus of claim 1, wherein the processor issues instructions from the component collection, stored in the memory, to:
determine a target annuity pay-out amount based on the obtained individual parameters including determining an amount to fulfill the participant's monthly expenses.

8. The apparatus of claim 1, wherein the processor issues instructions from the component collection, stored in the memory, to:
determine the deferred income annuity purchasing plan including:
a starting age to purchase deferred income annuity instruments; and
an income replacement percentage.

9. The apparatus of claim 1, wherein the processor issues instructions from the component collection, stored in the memory, to:
determine the deferred income annuity purchasing plan including a target equity exposure percentage.

10. The apparatus of claim 1, wherein the processor issues instructions from the component collection, stored in the memory, to:
obtain a target income replacement percentage;
calculate projected pre-retirement income based on current income; and
calculate a first deferred income annuity purchasing amount based on the pre-retirement income.

11. The apparatus of claim 1, wherein the processor issues instructions from the component collection, stored in the memory, to:
calculate a future monthly income amount to purchase based on the first deferred income annuity purchasing amount; and
calculate a subsequent deferred income annuity purchasing amount based on the future monthly income amount to purchase and inflation.

12. The apparatus of claim 1, wherein the processor issues instructions from the component collection, stored in the memory, to:
determine a purchasing price including: obtaining an investment grade corporate bond curve as a base for pricing curve.

13. The apparatus of claim 12, wherein the investment grade corporate bond curve comprises any of:
a BBB1-BBB3 corporate yield curve;
a Seasoned Baa Corporate Bond Yield curve; and
a U.S. treasury yield curve.

14. The apparatus of claim 13, wherein the processor issues instructions from the component collection, stored in the memory, to:
identify a first time period; and
adopt a corporate yield curve as a first pricing curve for the first time period.

15. The apparatus of claim 1, wherein the processor issues instructions from the component collection, stored in the memory, to:
identify a second time period;
generate a hypothetical corporate curve; and
combine the hypothetical corporate curve and a treasury corporate yield curve to generate a second pricing curve for the second time period.

16. The apparatus of claim 1, wherein the processor issues instructions from the component collection, stored in the memory, to:
identify a third time period;
apply hypothetical corporate spreads to a treasury corporate yield curve; and
generate an interpolated curve as a third pricing curve for the third time period.

17. The apparatus of claim 1, wherein the processor issues instructions from the component collection, stored in the memory, to:
determine the purchasing price for the deferred income annuity purchasing plan has a time span more than twenty years; and
maintain a flat yield for any time period beyond twenty years.

18. The apparatus of claim 1, wherein the processor issues instructions from the component collection, stored in the memory, to:
obtain a list of prices of deferred income annuities provided by a set of approved providers; and
select a best price from the list of prices.

19. The apparatus of claim 18, wherein the set of approved providers comprise an insurance company.

20. The apparatus of claim 1, wherein the processor issues instructions from the component collection, stored in the memory, to: execute a periodical execution including any of quarterly purchase, monthly purchase and bi-monthly purchase.

21. The apparatus of claim 1, wherein the processor issues instructions from the component collection, stored in the memory, to: rebalance an asset allocation of the participant's portfolio is triggered by changing data factors.

22. The apparatus of claim 21, wherein the change data factors include any of:
changing individual income growth rate;
individual family life change; and
changing inflation rate.

23. The apparatus of claim 1, wherein the processor issues instructions from the component collection, stored in the memory, to: rebalance so as to maintain a target equity exposure percentage in the asset allocation of the participant's portfolio.

24. The apparatus of claim 1, wherein the processor issues instructions from the component collection, stored in the memory, to:
purchase the deferred income annuity instrument using fixed income from the participant's portfolio.

25. The apparatus of claim 1, wherein the processor issues instructions from the component collection, stored in the memory, to:
calculate market value for the purchased deferred income annuity instrument.

26. The apparatus of claim 1, wherein the processor issues instructions from the component collection, stored in the memory, to:
determine fixed income in the participant's portfolio has been exhausted; and
suspend deferred income annuity purchasing.

27. A deferred income annuity generation and management processor-readable storage non-transitory medium storing processor-executable instructions issuable by a processor to:
obtain a deferred income annuity enrollment request from a participant via a user interface;
provide a participant individual parameter input user interface page to the participant;
obtain individual parameters from the participant individual parameter input user interface page,
said obtained individual parameters being formatted in a data structure having any of the following fields:
the participant's age,
the participant's gender,
the participant's family status,
the participant's educational background,
the participant's employment industry, and
the participant's employment history; and
generate a deferred income annuity recommendation to the participant based on the individual parameters.

28. A deferred income annuity generation and management apparatus, comprising:
a computing processor; and
a memory disposed in communication with the computing processor, and storing computing processor-executable instructions, said processor-executable instructions executable by the computing processor to:
obtain a deferred income annuity enrollment request from a participant via a user interface;
provide a participant individual parameter input user interface page to the participant;
obtain individual parameters from the participant individual parameter input user interface page;
determine a target annuity pay-out amount based on the obtained individual parameters;
determine a deferred income annuity purchasing plan based on the obtained individual parameters and the determined target annuity pay-out amount;
determine a purchasing price for the deferred income annuity purchasing plan;
periodically execute a purchase transaction of deferred income annuity instrument based on the determined deferred income annuity purchasing plan and the determined purchasing price;
rebalance an asset allocation of the participant's portfolio upon the purchase transaction of deferred income annuity instrument;
obtain an indication that the participant has reached a retirement age; and
generate a pay-out amount to the participant based on the deferred income annuity instrument.

29. The apparatus of claim 28, wherein said processor-executable instructions are further executable by the computing processor to:
obtain historical and current economic data from a data provider.

30. The apparatus of claim 29, wherein the historical and current economic data comprises any of: corporate yield data, treasury yields data, inflation data, and market data.

31. The apparatus of claim 29, wherein said processor-executable instructions are further executable by the computing processor to:
create a hypothetical deferred income annuity purchasing portfolio to assess performance.

32. The apparatus of claim 28, wherein the participant comprises an individual investor.

33. The apparatus of claim 28, wherein the individual parameters comprise any of: the participant's age, the participant's gender, the participant's family status, the participant's employment industry, the participant's income and the participant's educational background.

34. The apparatus of claim 28, wherein the individual parameters further comprise any of: the participant's expense data, the participant's housing condition, and the participant's tax status.

35. The apparatus of claim 28, wherein the determining a target annuity pay-out amount based on the obtained individual parameters further comprises:
determining an amount to fulfill the participant's monthly expenses.

36. The apparatus of claim 28, wherein the deferred income annuity purchasing plan further comprises any of:
a starting age to purchase deferred income annuity instruments; and
an income replacement percentage.

37. The apparatus of claim 28, wherein the deferred income annuity purchasing plan further comprises a target equity exposure percentage.

38. The apparatus of claim 28, wherein said processor-executable instructions are further executable by the computing processor to:
obtain a target income replacement percentage;
calculate projected pre-retirement income based on current income; and
calculate a first deferred income annuity purchasing amount based on the pre-retirement income.

39. The apparatus of claim 38, wherein said processor-executable instructions are further executable by the computing processor to:
calculate a future monthly income amount to purchase based on the first deferred income annuity purchasing amount; and
calculate a subsequent deferred income annuity purchasing amount based on the future monthly income amount to purchase and inflation.

40. The apparatus of claim 28, wherein the determining a purchasing price further comprising:
obtaining an investment grade corporate bond curve as a base for pricing curve.

41. The apparatus of claim 40, wherein the investment grade corporate bond curve comprises any of:
a BBB1-BBB3 corporate yield curve;
a Seasoned Baa Corporate Bond Yield curve; and
a U.S. treasury yield curve.

42. The apparatus of claim 41, wherein said processor-executable instructions are further executable by the computing processor to:
identify a first time period; and
adopt a corporate yield curve as a first pricing curve for the first time period.

43. The apparatus of claim 28, wherein said processor-executable instructions are further executable by the computing processor to:
identify a second time period;
generate a hypothetical corporate curve; and
combine the hypothetical corporate curve and a treasury corporate yield curve to generate a second pricing curve for the second time period.

44. The apparatus of claim 28, wherein said processor-executable instructions are further executable by the computing processor to:
identify a third time period;
apply hypothetical corporate spreads to a treasury corporate yield curve; and
generate an interpolated curve as a third pricing curve for the third time period.

45. The apparatus of claim 28, wherein said processor-executable instructions are further executable by the computing processor to:
determine the purchasing price for the deferred income annuity purchasing plan has a time span more than twenty years; and
maintain a flat yield for any time period beyond twenty years.

46. The apparatus of claim 28, wherein the determining a purchasing price further comprising:
obtaining a list of prices of deferred income annuities provided by a set of approved providers; and
selecting a best price from the list of prices.

47. The apparatus of claim 45, wherein the set of approved providers comprise an insurance company.

48. The apparatus of claim 28, wherein the periodical execution comprise any of quarterly purchase, monthly purchase and bi-monthly purchase.

49. The apparatus of claim 28, wherein rebalancing an asset allocation of the participant's portfolio is triggered by changing data factors.

50. The apparatus of claim 49, wherein the change data factors include any of:
changing individual income growth rate;
individual family life change; and
changing inflation rate.

51. The apparatus of claim 28, wherein the rebalancing maintains a target equity exposure percentage in the asset allocation of the participant's portfolio.

52. The apparatus of claim 28, wherein said processor-executable instructions are further executable by the computing processor to:
purchase the deferred income annuity instrument using fixed income from the participant's portfolio.

53. The apparatus of claim 28, wherein said processor-executable instructions are further executable by the computing processor to:
calculate market value for the purchased deferred income annuity instrument.

54. The apparatus of claim 28, wherein said processor-executable instructions are further executable by the computing processor to:
determine fixed income in the participant's portfolio has been exhausted; and
suspend deferred income annuity purchasing.

55. A deferred income annuity generation and management system, comprising:
means to obtain a deferred income annuity enrollment request from a participant via a user interface;
means to provide a participant individual parameter input user interface page to the participant;
means to obtain individual parameters from the participant individual parameter input user interface page;
means to determine a target annuity pay-out amount based on the obtained individual parameters;
means to determine a deferred income annuity purchasing plan based on the obtained individual parameters and the determined target annuity pay-out amount;
means to determine a purchasing price for the deferred income annuity purchasing plan;
means to periodically execute a purchase transaction of deferred income annuity instrument based on the determined deferred income annuity purchasing plan and the determined purchasing price;
means to rebalance an asset allocation of the participant's portfolio upon the purchase transaction of deferred income annuity instrument;
means to obtain an indication that the participant has reached a retirement age; and
means to generate a pay-out amount to the participant based on the deferred income annuity instrument.

56. A deferred income annuity generation and management processor-readable storage non-transitory medium storing processor-executable instructions issuable by a processor to:
obtain a deferred income annuity enrollment request from a participant via a user interface;
provide a participant individual parameter input user interface page to the participant;
obtain individual parameters from the participant individual parameter input user interface page;
determine a target annuity pay-out amount based on the obtained individual parameters;
determine a deferred income annuity purchasing plan based on the obtained individual parameters and the determined target annuity pay-out amount;
determine a purchasing price for the deferred income annuity purchasing plan;
periodically execute a purchase transaction of deferred income annuity instrument based on the determined deferred income annuity purchasing plan and the determined purchasing price;
rebalance an asset allocation of the participant's portfolio upon the purchase transaction of deferred income annuity instrument;
obtain an indication that the participant has reached a retirement age; and
generate a pay-out amount to the participant based on the deferred income annuity instrument.

57. A deferred income annuity generation and management processor-implemented method, comprising:
obtaining a deferred income annuity enrollment request from a participant via a user interface;
providing a participant individual parameter input user interface page to the participant;
obtaining individual parameters from the participant individual parameter input user interface page;
determining a target annuity pay-out amount based on the obtained individual parameters;
determining a deferred income annuity purchasing plan based on the obtained individual parameters and the determined target annuity pay-out amount;
determining a purchasing price for the deferred income annuity purchasing plan;
periodically executing a purchase transaction of deferred income annuity instrument based on the determined deferred income annuity purchasing plan and the determined purchasing price;
rebalancing an asset allocation of the participant's portfolio upon the purchase transaction of deferred income annuity instrument;
obtaining an indication that the participant has reached a retirement age; and
generating a pay-out amount to the participant based on the deferred income annuity instrument.
